(19) United States
(12) Patent Application Publication
(10) Pub. No.: US 2014/0089078 A1
(43) Pub. Date: Mar. 27, 2014

(54) SYSTEM AND METHOD FOR MANAGING CARBON EMISSION CREDITS AT A FUEL DISPENSING STATION USING VEHICLE ON-BOARD DIAGNOSTICS DATA

(71) Applicant: QUALCOMM INCORPORATED, San Diego, CA (US)

(72) Inventors: Robert L. Dessert, Canton, GA (US); Stephen B. Statler, San Diego, CA (US); Jose R. Menendez, San Diego, CA (US)

(73) Assignee: QUALCOMM Incorporated, San Diego, CA (US)

(21) Appl. No.: 13/747,054

(22) Filed: Jan. 22, 2013

Related U.S. Application Data
(60) Provisional application No. 61/704,354, filed on Sep. 21, 2012.
(60) Provisional application No. 61/722,889, filed on Nov. 6, 2012.

(51) Int. Cl. G06Q 30/02

(52) U.S. Cl. CPC G06Q 30/0238
USPC 705/14.38

(57) ABSTRACT

Systems and methods are provided for managing carbon emission credits associated with a vehicle fueling at a fuel dispensing station. An exemplary method comprises: receiving a request via a communications network for a vehicle fueling transaction at a fuel dispensing station; determining a pump identifier associated with the fuel dispensing station; sending a message to a store controller associated with the pump identifier for a fuel amount dispensed by the fuel dispensing station; receiving the fuel amount from the store controller; receiving on-board diagnostics (OBD) data associated with the vehicle; calculating a carbon emission adjustment based on the OBD data; and determining an estimated carbon emissions amount associated with the vehicle fueling transaction by applying the carbon emission adjustment to a predetermined carbon emissions amount for the fuel amount.

### PRIORITY AND RELATED APPLICATIONS STATEMENT

This application claims priority under 35 U.S.C. 119(e) to U.S. Provisional Patent Application filed on Sep. 21, 2012, assigned Provisional Application Ser. No. 61/704,354 (Docket No. 124320P1), and entitled “SYSTEM AND METHOD FOR MANAGING CARBON EMISSION CREDITS AT A FUEL DISPENSING STATION VIA A PORTABLE COMPUTING DEVICE.”

This application also claims priority under 35 U.S.C. 119(e) to U.S. Provisional Patent Application filed on Nov. 6, 2012, assigned Provisional Application Ser. No. 61/722,889 (Docket No. 124587P1), and entitled “SYSTEM AND METHOD FOR MANAGING CARBON EMISSION CREDITS AT A FUEL DISPENSING STATION USING VEHICLE ON-BOARD DIAGNOSTICS DATA.” The entire contents of these two patent applications are hereby incorporated by reference.

### DESCRIPTION OF THE RELATED ART

Portable computing devices (PCDs) are becoming necessities for people on personal and professional levels. These devices may include cellular telephones, portable digital assistants (PDAs), portable game consoles, palmtop computers, and other portable electronic devices.

PCDs are often utilized to conduct financial transactions. For example, PCDs may be used to check bank account balances, transfer funds between bank accounts, and for paying bills. While PCDs are useful for these types of transactions, there is a growing opportunity in the art for utilizing PCDs in other types of transactions, such as those conventionally performed at a fuel dispensing station via an integrated display and point-of-sale system.

### SUMMARY OF THE DISCLOSURE

Systems and methods are provided for managing carbon emission credits associated with a vehicle fueling at a fuel dispensing station. An exemplary method involves receiving a request via a communications network for a vehicle fueling transaction at a fuel dispensing station. A pump identifier is determined, which is associated with the fuel dispensing station. A message is sent to a store controller associated with the pump identifier for a fuel amount dispensed by the fuel dispensing station. The fuel amount is received from the store controller. On-board diagnostics (OBD) data associated with the vehicle is received, and a carbon emission adjustment is calculated based on the OBD data. An estimated carbon emissions amount associated with the vehicle fueling transaction is determined by applying the carbon emission adjustment to a predetermined carbon emissions amount for the fuel amount.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a diagram of a wireless portable computing device (PCD) coupled to a wireless communications network which are integral parts of a system for managing transactions, controlling a display, and managing carbon emission credits at a fuel dispensing station with the portable computing device;

FIG. 2A is a diagram of a screen for entering a user's log-in credentials on the PCD to access the system;

FIG. 2B is a diagram of a screen for entering additional log-in credentials such as a password on the PCD to access the system;

FIG. 2C is a diagram of a screen for the PCD confirming access to system;

FIG. 2D is a diagram of a screen that shows the contents of an image being scanned with a camera of the PCD;

FIG. 2E is a diagram of a screen that shows merchant information relevant to a transaction and a line item listing of products being scanned by a product scanner coupled to an electronic cash register;

FIG. 2F is a diagram of a screen that shows merchant information relevant to a transaction and a coupon option that may be selected by a user;

FIG. 2G is a diagram of a screen that shows merchant information relevant to a transaction and a total bill for a purchase along with a plurality of payment options that may be selected by a user;

FIG. 2H is a diagram of a screen that shows an electronic receipt that may be provided upon completion of a transaction with a merchant;

FIG. 2I is a diagram of an exemplary machine-readable tag that may be coupled to an electronic cash register of a merchant;

FIG. 3A is a diagram of hardware components and software components running on a portable computing device for supporting transactions with the portable computing device;

FIG. 3B is a diagram of several software components for a payment application running on a portable computing device;

FIG. 4 is a diagram illustrating details for the merchant point-of-sale system and the merchant enterprise system of FIG. 1 for completing a sales transaction;

FIG. 5 is a diagram illustrating details of a merchant acquirer and credit card subsystems of FIG. 1 for completing a sales transaction;

FIG. 6 is a diagram illustrating details of a gateway and alternative payment systems illustrated in FIG. 1;

FIG. 7A is diagram illustrating details for the central mobile payment controller illustrated in FIG. 1;

FIG. 7B is a diagram illustrating several on-line portals for managing the transaction management system 101 according to one exemplary embodiment of the invention;

FIG. 8 is a functional block diagram illustrating an exemplary portable computing device;

FIGS. 9A-9D are flowcharts illustrating a method for managing transactions with a PCD;

FIG. 10 is a combined block/flow diagram illustrating a computer system and associated methods for managing transactions at a merchant location between a point-of-sale terminal and a portable computing device.

FIG. 11 is a flowchart illustrating a method for managing transactions at a merchant location between a point-of-sale terminal and a portable computing device.

FIG. 12 is a more detailed diagram of the system of FIG. 1 for managing transactions, controlling a display, and managing carbon emission credits at a fuel dispensing station a via a portable computing device.

FIG. 13 is a diagram of a screen for displaying a map of nearby gas stations which support transactions via a portable computing device.

FIG. 14 is a combined block/flow diagram illustrating a system and method for managing transactions at a fuel dispensing station via a portable computing device.

FIG. 15 is a diagram of a screen for scanning a tag located on the fuel dispensing station.

FIG. 16 is a diagram of a screen for selecting various options for transactions at fuel dispensing station.

FIG. 17 is a diagram of a screen for selecting a car wash option.

FIG. 18 is a diagram of a screen for viewing and redeeming in-store promotional offers at a fuel dispensing station.

FIG. 19 is a flowchart illustrating a method for managing transactions at a fuel dispensing station via a portable computing device.

FIG. 20 is a combined block/flow diagram illustrating a system and method for controlling a display at a fuel dispensing station via a portable computing device.

FIG. 21 is a flowchart illustrating a method for controlling a display at a fuel dispensing station via a portable computing device.

FIG. 22 is a diagram of a pump display controller screen for controlling a display at a fuel dispensing station via a portable computing device.

FIG. 23 is a diagram of the carbon offset/credit management system of FIG. 1.

FIG. 24 is a flowchart illustrating a method for managing carbon emission credits at a fuel dispensing station via a portable computing device.

FIG. 25 is a diagram of a screen for displaying updates to a carbon offset user account after purchasing gas at a fuel dispensing station via a portable computing device.

FIG. 26 is a diagram of a screen for sharing updates to a carbon offset user account via a social networking system.

FIG. 27 is a diagram of a screen for scanning a tag located at a car wash.

FIG. 28 is a diagram of a screen for displaying a car wash code.

FIG. 29 is a diagram of another embodiment of the carbon offset/credit management system of FIG. 1, which incorporates on-board diagnostics data from a vehicle to determine an estimated carbon emissions amount associated with a transaction at a fuel dispensing station.

FIG. 30 is a flowchart illustrating a method for managing carbon emission credits at a fuel dispensing station using on-board diagnostics data from a vehicle.

FIG. 31 is a block/flow diagram of an embodiment of the carbon offset/credit management system of FIG. 29 for estimating carbon emissions for a fueling transaction using on-board diagnostics data from a vehicle.

FIG. 32 is a diagram of an embodiment of a pay-by-car screen for selecting a fuel grade option during a vehicle fueling transaction at a fuel dispensing station.

FIG. 33 is a diagram of a pay-by-car screen for displaying the results of a carbon emission estimate based on vehicle on-board diagnostics data.

FIG. 34 is a diagram of a pay-by-car screen for displaying a transaction receipt.

FIG. 35 is a diagram of a pay-by-car screen for selecting a carbon offset/credit account.

FIG. 36 a flowchart illustrating another method for managing carbon emission credits at a fuel dispensing station using on-board diagnostics data from a vehicle.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

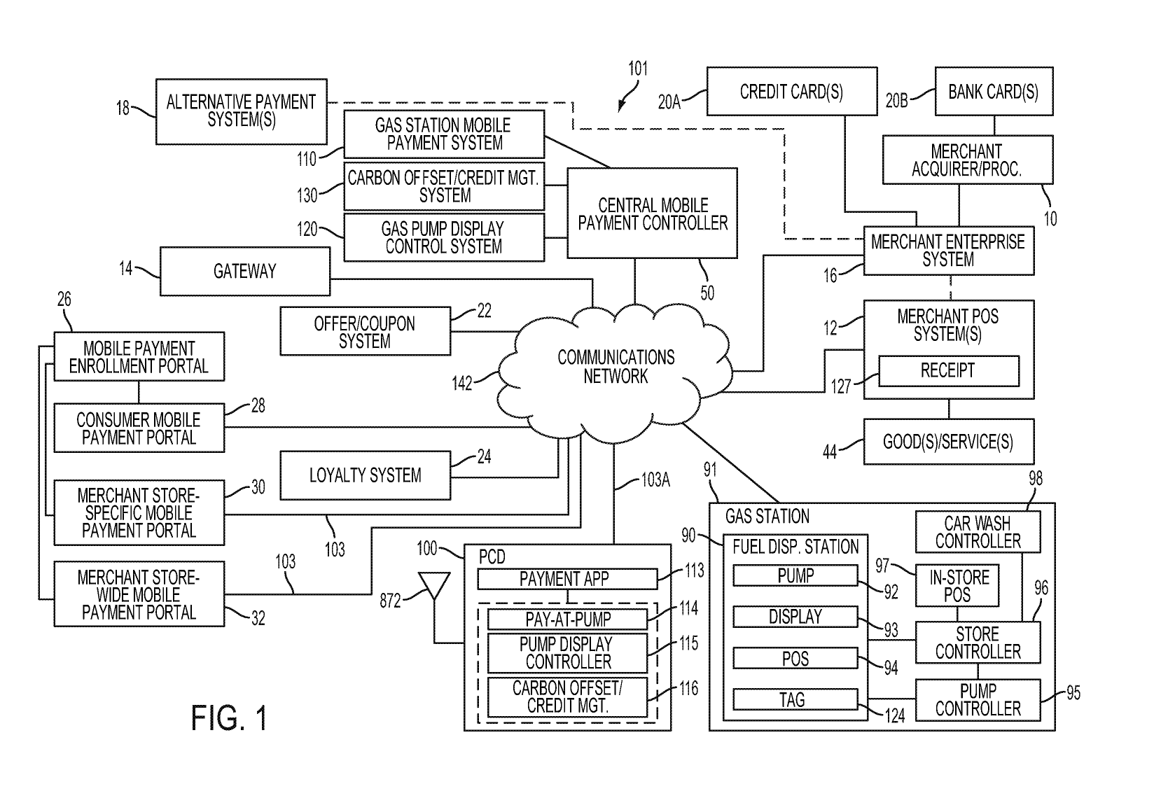

FIG. 1 illustrates a diagram of a wireless portable computing device (PCD) 100 coupled to a communications network 142 via a wireless communication link 103A, which are integral parts of a system 101 (also referred to herein as a transaction management system 101) for managing transactions at a fuel dispensing station 90 located at a gas station 91 via the PCD 100. As described below in more detail, the fuel dispensing station 90 comprises a pump 92 for dispensing one or more grades of fuel, an integrated display 93 for displaying menus, video, advertising messages, and/or promotional offers, a pay-at-the-pump point-of-sale (POS) system 94 for making credit card payments, and a tag 124 that uniquely identifies the fuel dispensing station 90. The gas pump 92 is controlled by a pump controller 95, which may communicate with the central mobile payment controller 50 either directly or through the store controller 96. The store controller 96 and the pump controller 95 comprise the hardware and associated software components for implementing certain transactional and other functionality associated with the operation of the gas station 91. The pump controller 95 is responsible for making changes to the pump 92, including, for example, activating/disabling the pump 92, changing fuel grade prices, changing and displaying advertisements on the display 93 during fueling, and controlling available options, such as, car wash options. The store controller 96 is responsible for the financial aspects of the transactions at the fuel dispensing station 90, the car wash controller 98, and/or the in-store POS 97. For example, the store controller 96 may collect various types of transactional information (e.g., amount due, tender types, etc.) and sends them from one central system to the merchant acquirer/processor 10 or directly to the endpoint for authorizations. The store controller 96 may also handle upfront pre-authorization of credit cards for fuel purchases made via POS 94 located at the fuel dispensing station 90 and pass a request to the pump controller 95 to activate the pump 92 if authorization is approved.

The system elements illustrated in FIG. 1 are coupled via communication links 103 to the communications network 142. The communication links 103 illustrated in FIG. 1 may comprise wired or wireless links. Wireless links include, but are not limited to, radio-frequency (“RF”) links, infrared links, acoustic links, and other wireless mediums. The communications network 142 may comprise a wide area network (“WAN”), a local area network (“LAN”), the Internet, a Public Switched Telephony Network (“PSTN”), a paging network, or a combination thereof. The communications network 142 may be established by broadcast RF transceiver towers (not illustrated). However, one of ordinary skill in the art recognizes that other types of communication devices besides broadcast RF transceiver towers are included within the scope of this disclosure for establishing the communications network 142, including wireless access devices located at a merchant location, other portable computing device, or any other communication devices and/or networks.

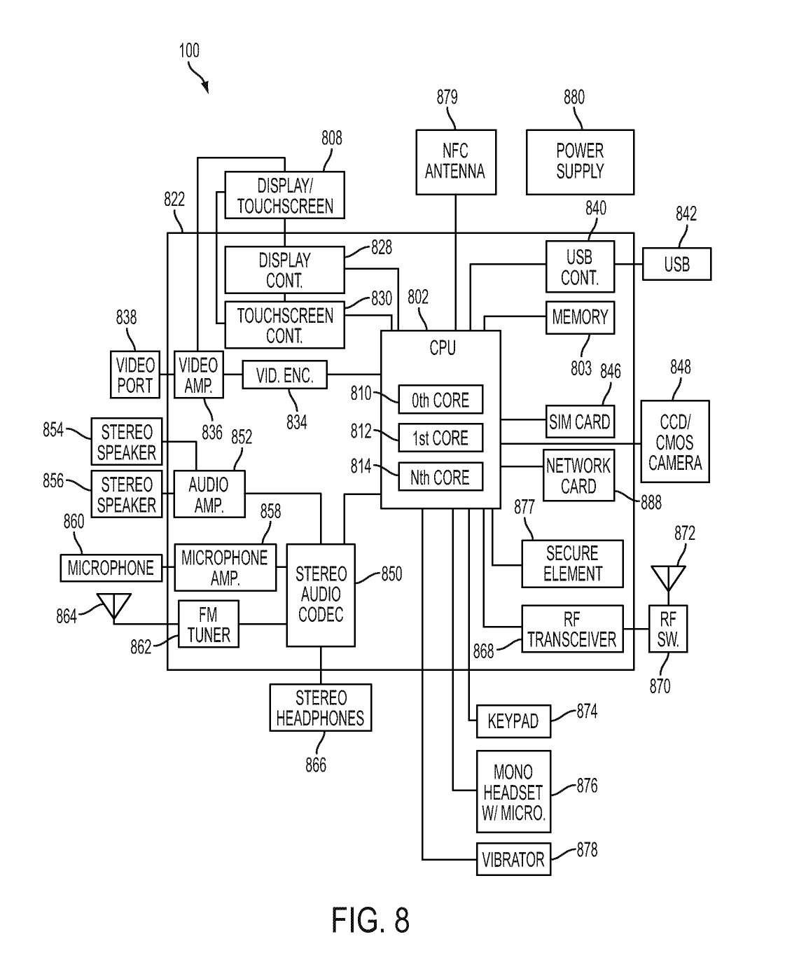

The PCD 100 is shown to have a RF antenna 872 (see FIG. 8) so that a respective PCD 100 may establish a wireless communication link 103A with the communications network 142 via RF transceiver towers (not illustrated). The portable computing device (PCD) 100 may support a payment application 113 for managing mobile transactions, as well as one or more software modules (e.g., a pay-at-pump module 114, a pump display controller module 115, and a carbon offset/credit management module 116) for managing transactions at the fuel dispensing station 90.

The payment application 113 may allow the PCD 100 to communicate with the central mobile payment controller 50 over the communications network 142 and/or communicate with other devices and systems for providing various aspects of the systems and methods for managing transactions via the systems illustrated in FIG. 1. For example, the payment application 113 may enable the PCD 100 to initiate a transaction at a fuel dispensing station 90. The pay-at-pump module 114 may enable the PCD 100 to control the pump 92 and make payments via communications with the gas station mobile payment system 110. The pump display controller module 115 may enable the PCD 100 to control the display 93 located at the fuel dispensing station 90 via communications with the gas pump display control system 120. The carbon offset/credit management application 116 may enable the PCD 100 to interface with a carbon offset/credit management system 130 that manages a consumer carbon offset initiative program. The gas station mobile payment system 110, the gas pump display control system 120, and the carbon offset/credit management system 130 may communicate with the central mobile payment controller 50 or be integrated with the central mobile payment controller 50 or other components of the transaction management system 101.

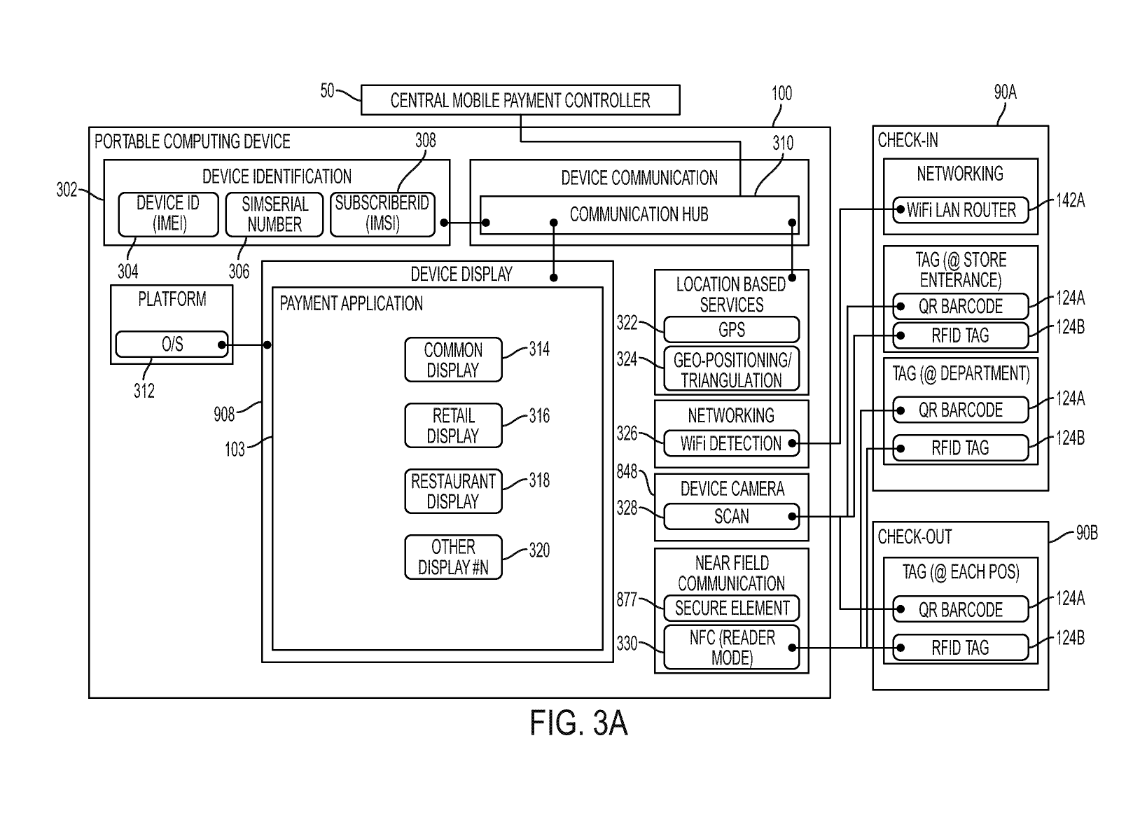

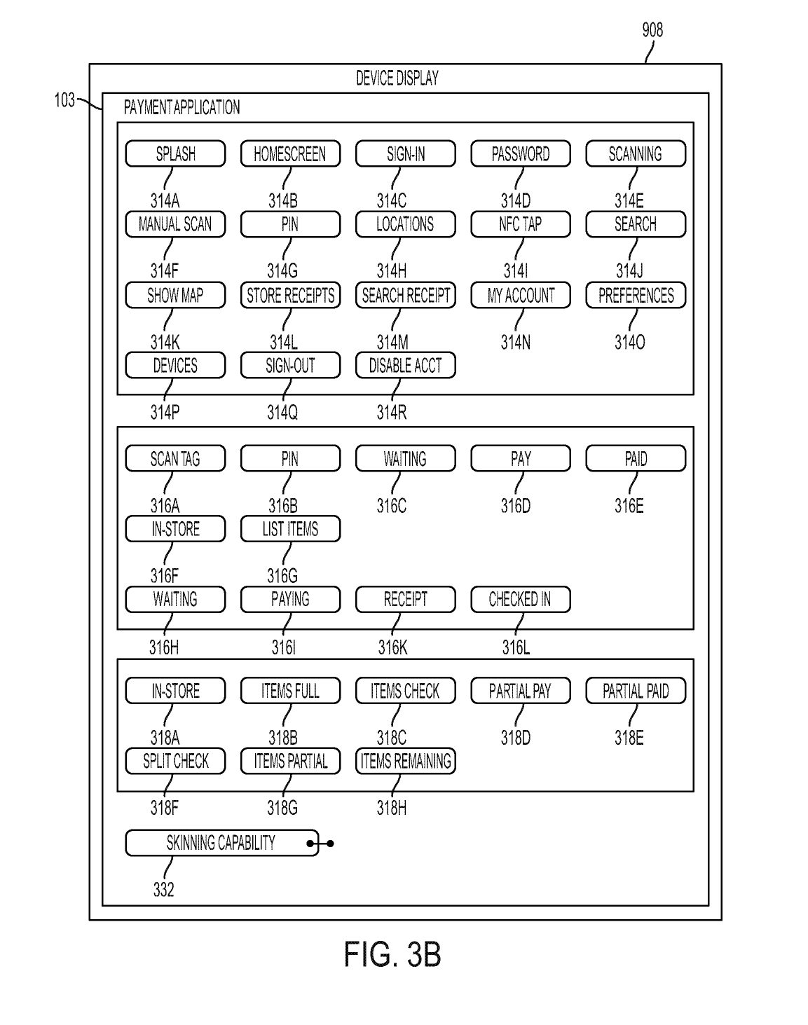

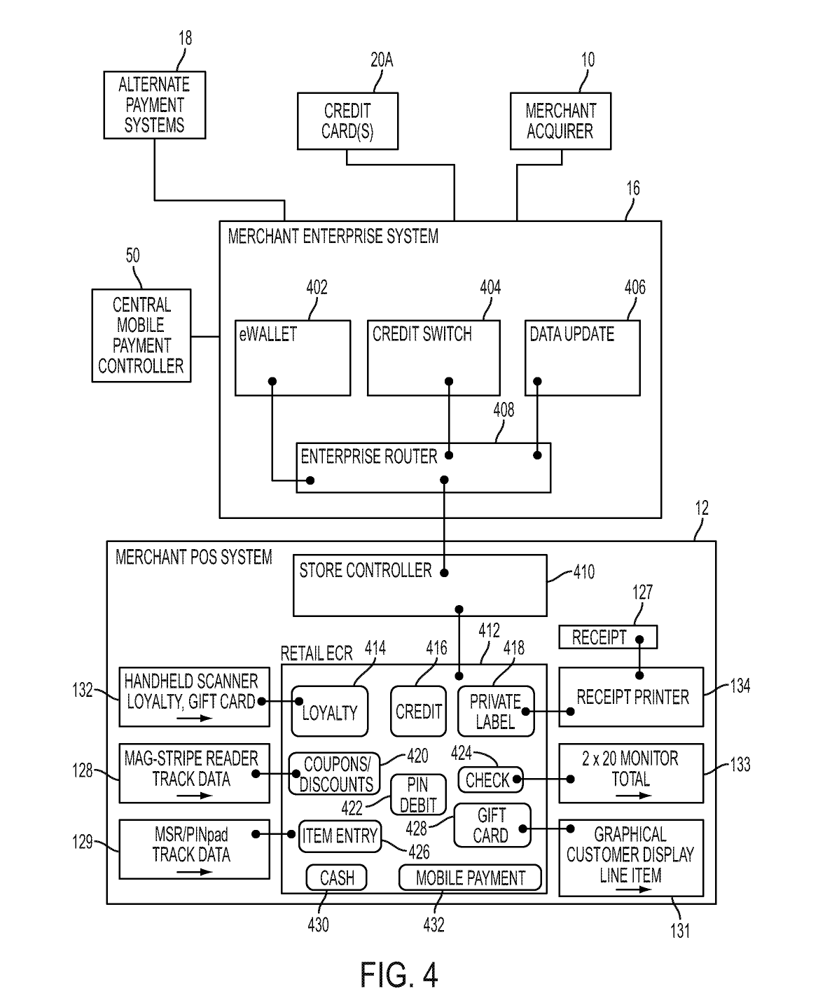

As illustrated in FIG. 1, the fuel dispensing station(s) 90 may include a machine-readable tag 124 (also referred to herein as tag 124) that may be coupled to the POS 94, the in-store POS 97, or an electronic cash register (“ECR”) 412 associated with the store controller 96 (see FIG. 4). The payment application 113 and/or the pay-at-pump module 114 may enable the customer to collect information from the tags 124. Further details about the tags 124 will be described below in connection with FIG. 3A.

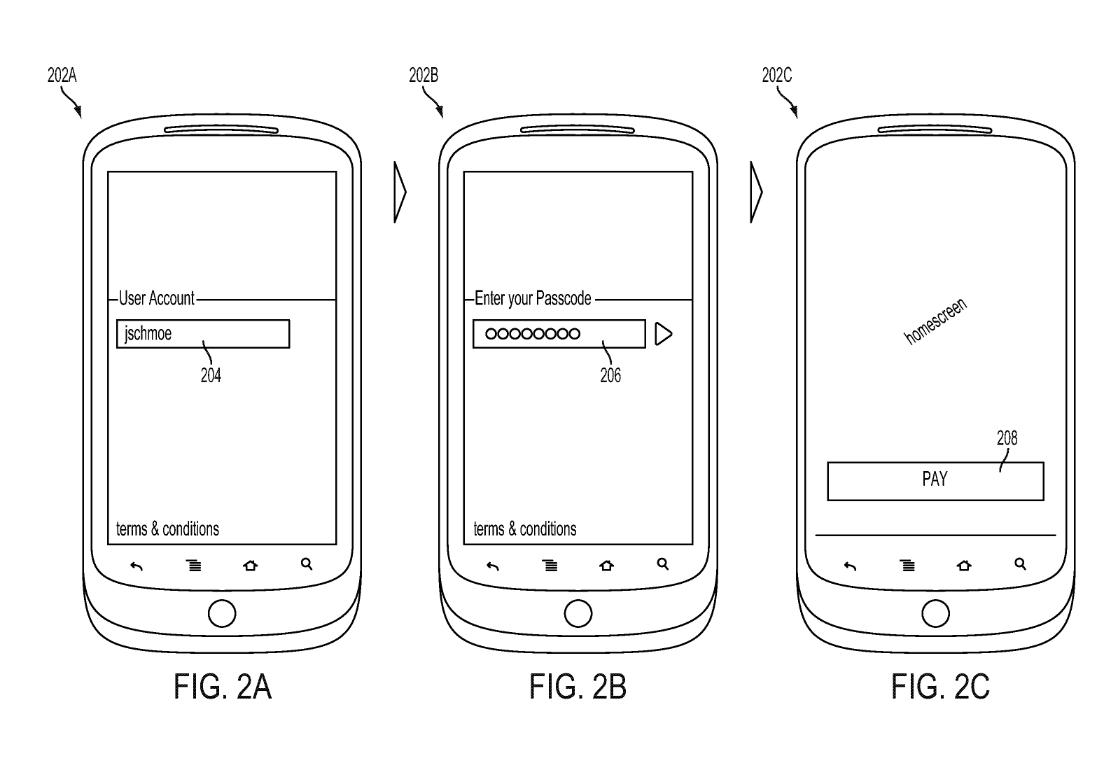

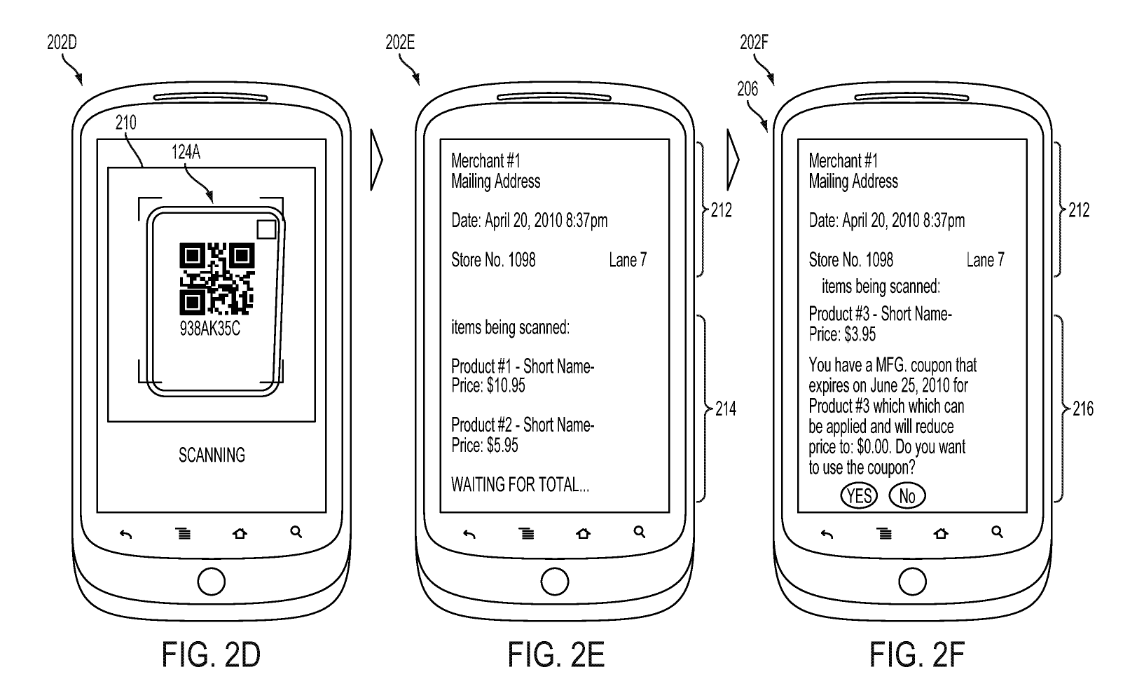

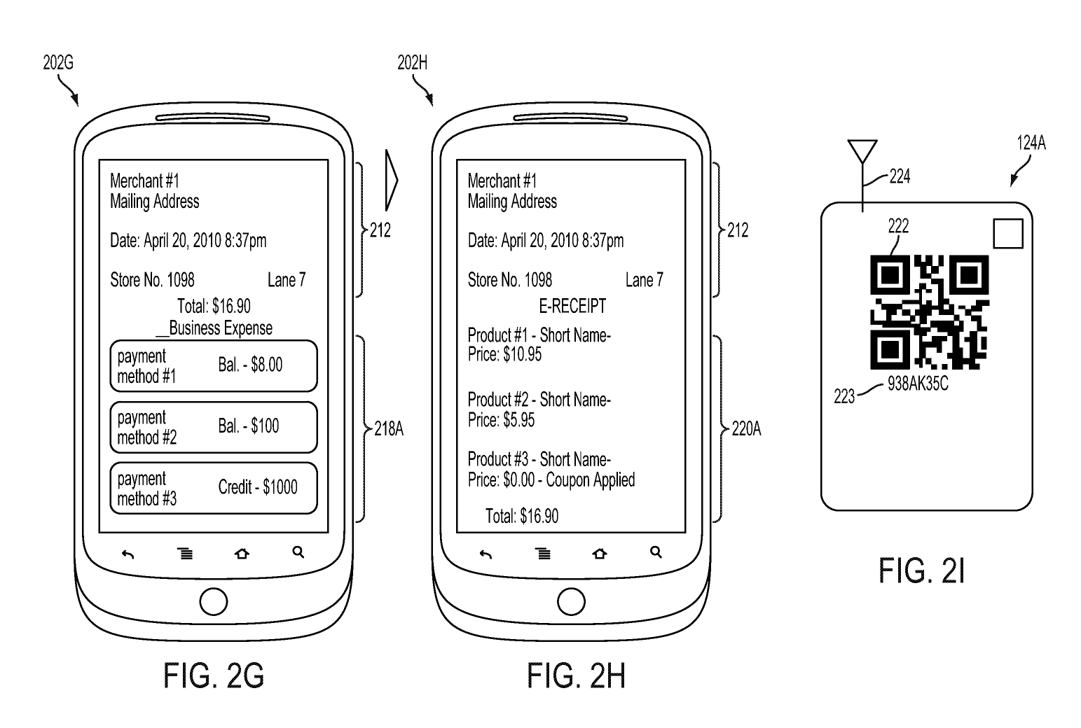

The machine-readable tag 124 may comprise a unique pump identifier and/or a unique merchant identifier associated with the gas station 91. Further details about the machine-readable tag 124 will be described below in connection with FIG. 2I. The ECR 412 (not illustrated in FIG. 1, but see FIG. 4) of the Merchant POS system 12 may comprise a mechanical or electronic device or combination thereof for calculating and recording sales transactions. The ECR 412 of the merchant POS system 12 may produce a physical receipt 127 at the end of a transaction that lists goods and/or services purchased with the portable computing device 100. Further details about the merchant POS system 12 will be described below in connection with FIG. 4.

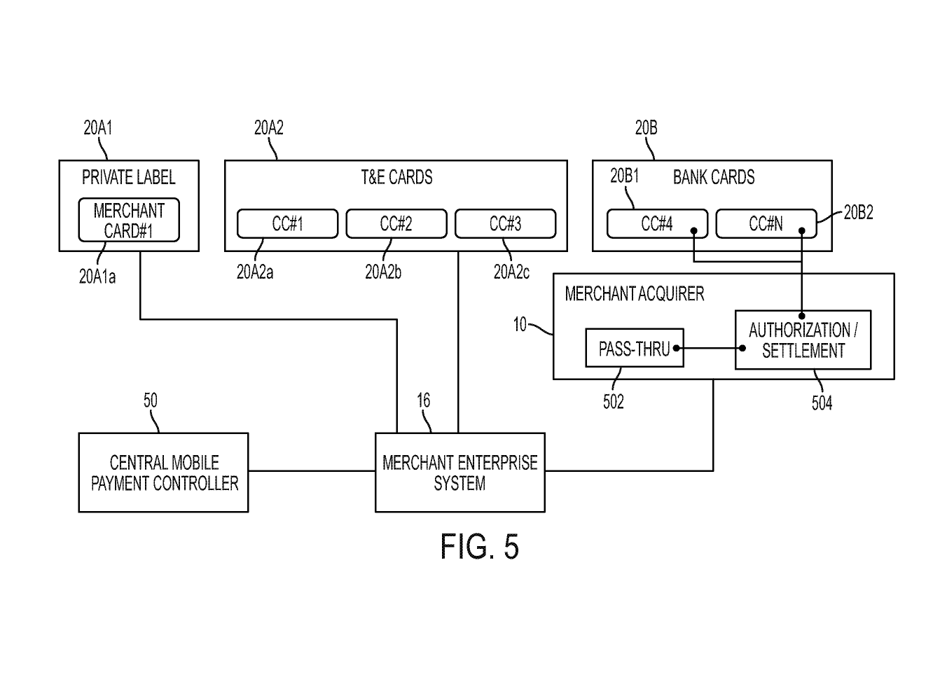

The merchant POS system 12 may be coupled to the merchant enterprise system 16 via the communications network 142. The merchant enterprise system 16 may support the completion of transactions when credit cards or when bank cards have been selected as a form of payment for a particular transaction. Further details about the merchant enterprise system 16 will be described below in connection with FIG. 4. The merchant enterprise system 16 may be coupled to a merchant acquirer/processor 10 and one or more credit card systems 20A. The merchant acquirer/processor 10 may be coupled to one or more bank card systems 20B supported by financial institutions like banks. Further details about the merchant acquirer 10, the credit card systems 20A, and bank card systems 20B will be described below in connection with FIG. 5.

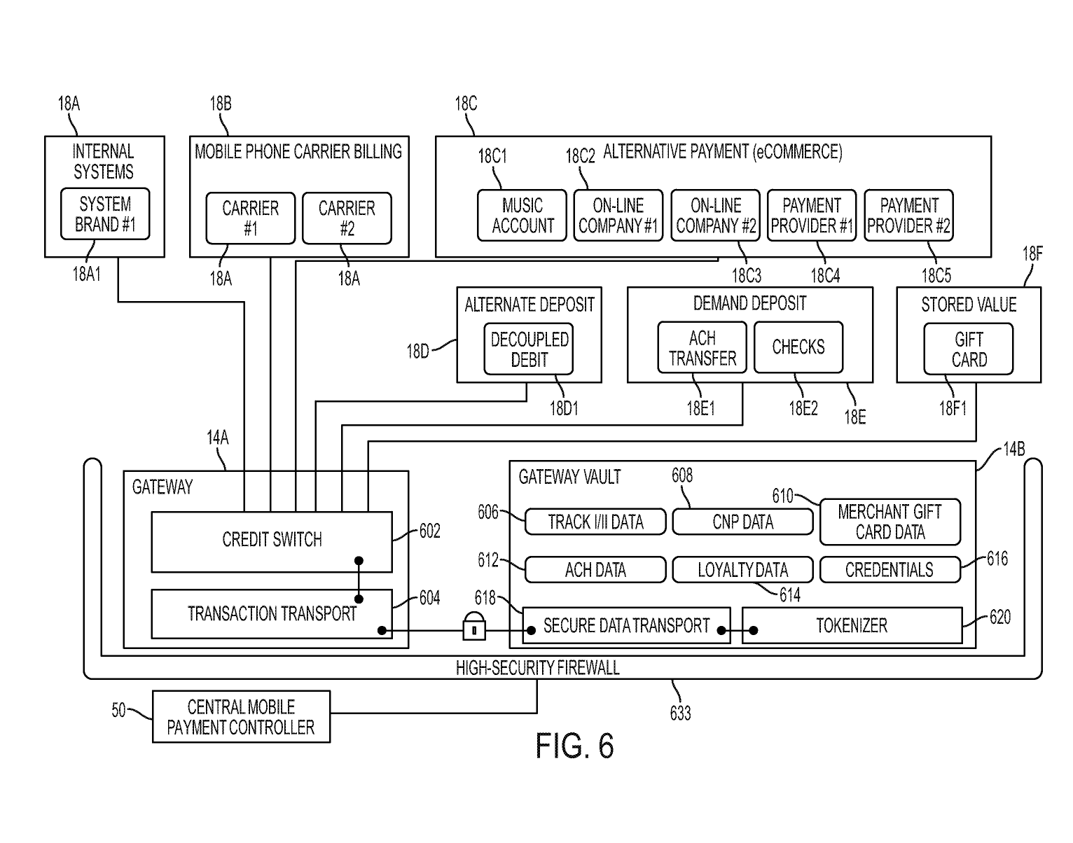

The merchant enterprise system 16 may also be coupled to alternative payment systems 18. Alternative payment systems 18 may include, but are not limited to, such systems like PayPal™, Google payments, etc. that currently exist as of this writing. The alternative payment systems 18 may be coupled to a gateway 14. Further details about the alternative payment systems 18 and gateway 14 will be described below in connection with FIG. 6.

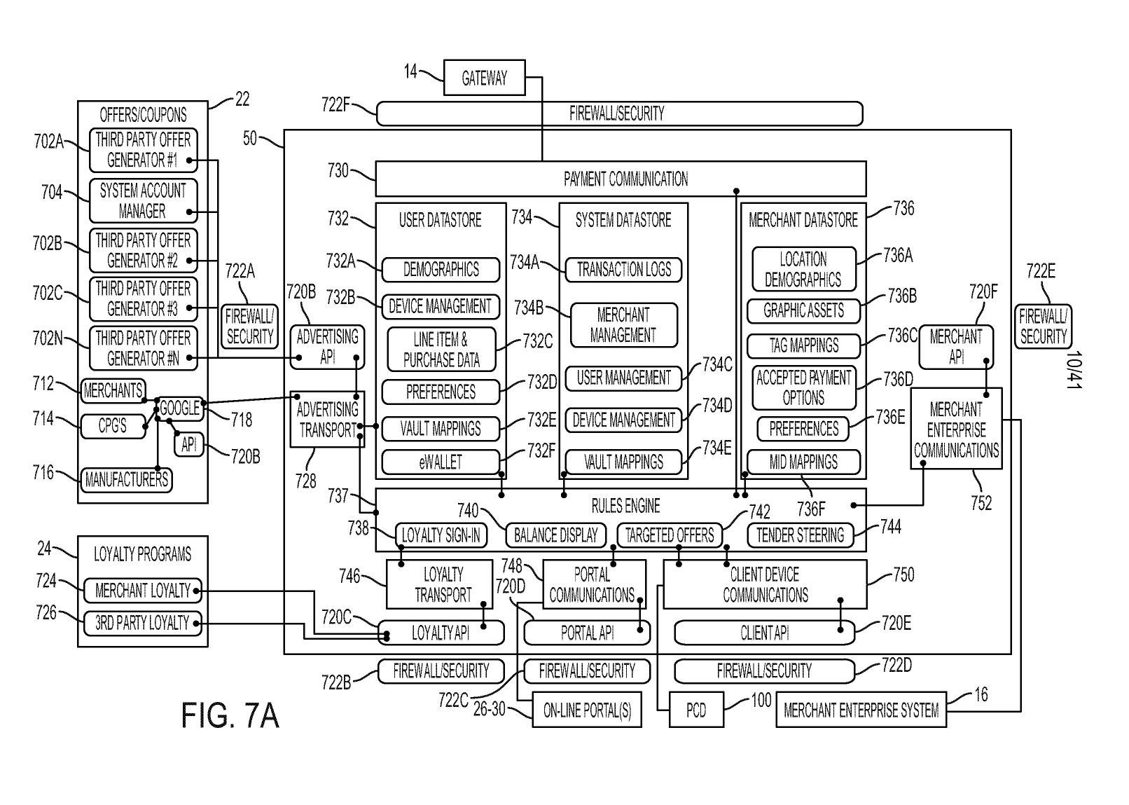

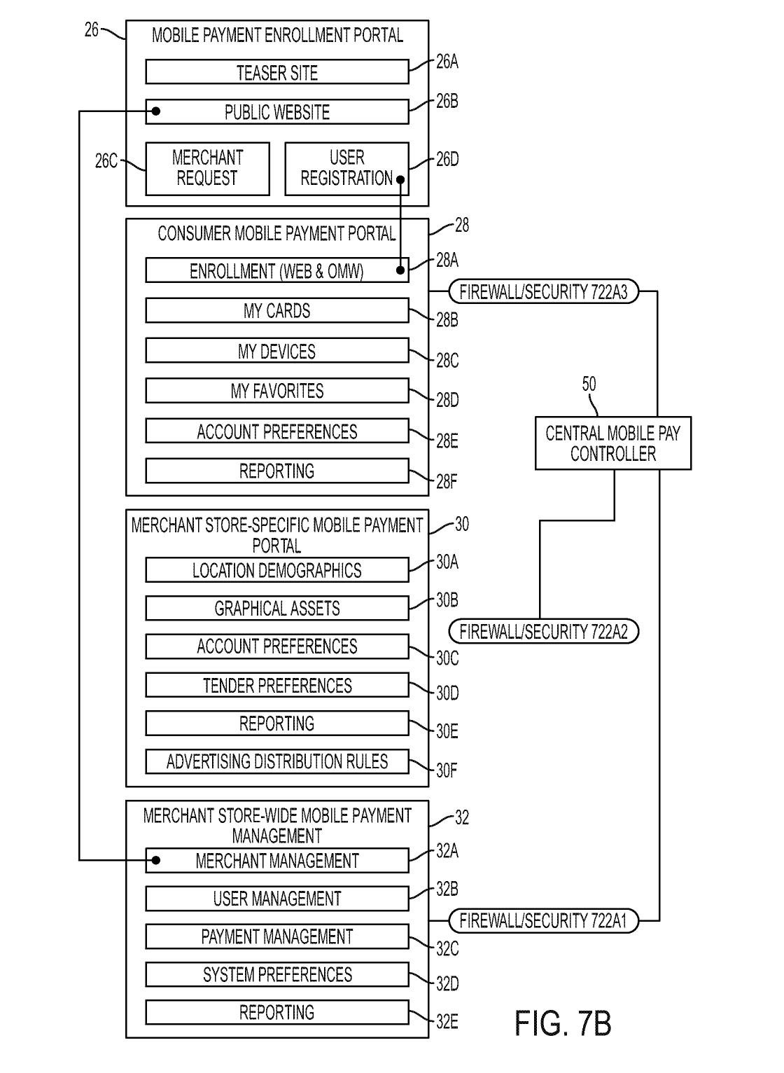

A central mobile payment controller 50 is coupled to the portable computing device 100 via the communications network 142. The central mobile payment controller 50 is responsible for connecting or linking the portable computing device 100 to various components of system 101, such as, for example, the merchant POS system 12, the merchant enterprise system 16, the store controller 96, the gas station mobile payment system 110, the carbon offset/credit management system 130, and the gas pump display control system 120. The central mobile payment controller 50 is also responsible for coupling the offer/coupon system 22 and loyalty system 24 to the portable computing device 100. The central mobile payment controller 50 is also responsible for managing several online portals 26-32. Further details about the central mobile payment controller 50 will be described below in connection with FIG. 7A. Meanwhile, further details about be online portals 26-32 will be described below in connection with FIG. 7B.

### Exemplary High-Level Operation of System 101

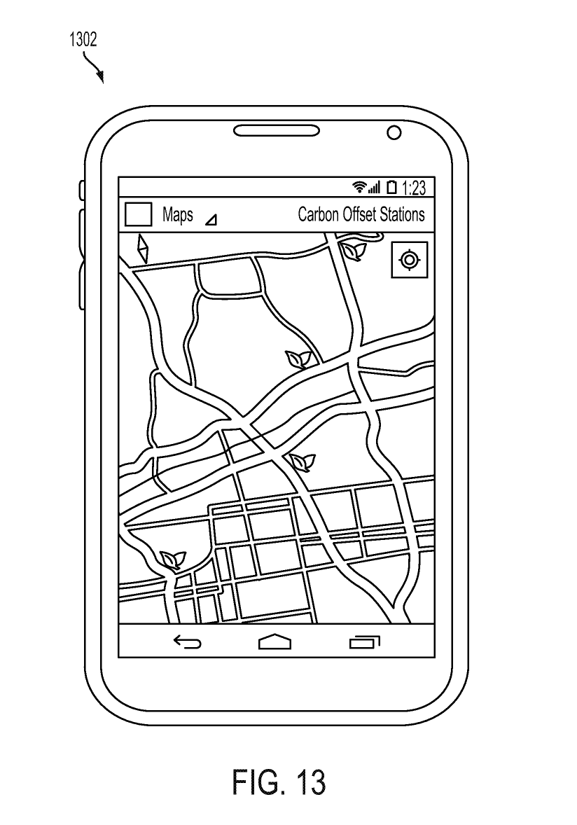

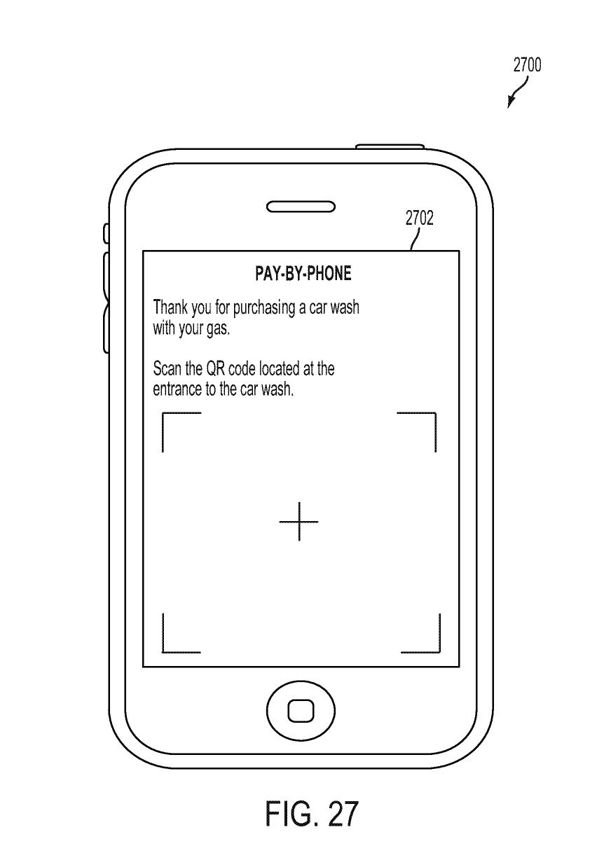

It should be appreciated that the system 101 may provide a payment and/or transactional platform for implementing certain aspects of the features provided by the gas station mobile payment system 110, the carbon offset/credit management system 130, and the gas pump display control system 120. The specific features provided at the gas station 91 are described below in more detail with reference to FIGS. 13-29. However, to introduce the architecture and operation of the enabling payment and/or transactional platform, the high-level operation of the system 101 will be described with respect to a generic merchant or retail system for enabling an operator of the PCD 100 to purchase one or more products/services 44 that may be scanned with a product scanner 132 (See FIG. 4). One of ordinary skill in the petroleum industry will appreciate that the transactions and features described in the context of a retail context may be used or modified for managing transactions at fuel dispensing stations 90. The description of the systems and methods in the retail context (FIGS. 2-11) is intended to describe the general operation of the enabling payment and/or transactional platform.

Prior to or in parallel to the operation of scanning products with the product scanner 132, the operator of the PCD 100 may retrieve the unique terminal identifier and the merchant identifier associated with the tag 124, which is affixed to the ECR 412 of the Merchant POS system 12. Again, in embodiments involving the gas station 91, the tag 124 may be affixed to the fuel dispensing station 90. The operator of the PCD 100 may retrieve the data from the tag 124 by scanning the tag 124 with the camera 848 or with a near-field-communication (“NFC”) antenna 879.

This unique terminal (or ECR) identifier and merchant identifier retrieved by the PCD 100 may be relayed back to the central mobile payment controller 50 along with a personal identification number (“PIN”). In response to receiving the terminal identifier, merchant identifier, and PIN, the central mobile payment controller 50 may send messages to merchant enterprise system 16. The central mobile payment controller 50 may request the merchant enterprise system 16 for the product scan data being generated by the product scanner 132 of the merchant POS system 12.

In response to this request from the central mobile payment controller 50, merchant enterprise system 16 may forward the product scan data to the central mobile payment controller 50. The central mobile payment controller 50, in turn, may relay the product scan data to the PCD 100 so that the product scan data may be displayed on the display device of the PCD 100. The PCD 100 may provide an option that may be selected by an operator to turn off this product scan data from being displayed on the display device of the PCD 100 while the products 130A are being scanned.

While the products/services 44 are being scanned by the product scanner 132 of the merchant POS system 12, the central mobile payment controller 50 may also retrieve loyalty account information from a profile associated with an operator of the PCD 100 which is stored in the loyalty system 24. The central mobile payment controller 50 may communicate this loyalty account information to merchant enterprise system 16. The merchant enterprise system 16 may relay this loyalty account information to the merchant POS system 12. The central mobile payment controller 50 may also retrieve unique and personalized offers tailored to the operator of the PCD 100 from the offer/coupon system 22.

Meanwhile, when the product scanner 132 of the merchant POS system 12 is finished scanning the products/services 44 for purchase, the ECR 412 may generate a final total of money due for payment in connection with the purchase of the products/services 44. This final total data is communicated from the merchant POS system 12 to the merchant enterprise system 16. The merchant enterprise system 16 then relays the final total to the central mobile payment controller 50, which in turn relays this information to the PCD 100. In addition to relaying this final total data to the PCD 100, the central mobile payment controller 50 may also retrieve payment accounts available to the operator and that may have been selected by an operator in a predetermined order for display on the PCD 100.

At this time, or any time during the transaction cycle, an operator of the PCD 100 may select from one of a plurality of payment methods supported by the central mobile payment controller 50. Alternatively, an operator of the PCD 100 may select a plurality of payment methods in order to pay the final total due in connection with the purchased products/services 44. Once a payment method or a combination of methods are selected by an operator of the PCD 100, the PCD 100 relays this selection to the central mobile payment controller 50.

Depending upon the form of payment selected, the central mobile payment controller 50 selects data from a gateway 14 for rendering payment associated with the final total data. If an alternative form of payment is selected by the operator of the PCD 100, then the central mobile payment controller 50 will relay the alternative payment account information through the gateway 14 to the alternative payment systems 18.

If a traditional form of payment is selected by the operator of the PCD 100, such as the selection of a credit card account, then the central mobile payment controller 50 may relay this credit card payment information over a secure channel to the merchant enterprise system 16. The merchant enterprise system 16 may relay the credit card payment information to the merchant acquirer 10 for bank card systems 20B or to credit card networks for credit card systems 20A.

Exemplary credit card networks, may include, but are not limited to, the VISA™ credit card network, the MASTERCARD™ card network, the DISCOVER™ credit card network, the AMERICAN EXPRESS™ credit card network, and other similar charge card proprietary networks. One of ordinary skill in the art recognizes that transactions for merchant gift cards may also follow the same flow with the merchant enterprise system 16 directing the transaction to the merchant's stored value processor that may be part of the credit card systems 20A or alternative payment systems 18.

If payment is approved by one of the traditional payment systems 20, then the merchant enterprise system 16 may relay this approval message to the merchant POS system 12. The merchant POS system 12 relays the approval message to the electronic cash register 126 and to the central mobile payment controller 50. If payment is approved by one of the alternative payment systems 18, the central mobile payment controller 50 may relay this information to the PCD 100 and the merchant enterprise system 16.

The central mobile payment controller 50 may send any payment approval messages to the PCD 100 for display on the display device of the PCD 100. The central mobile payment controller 50 may generate an electronic receipt that can be forwarded and displayed on a display device of the PCD 100. Meanwhile, the ECR 412 may also generate a hard copy receipt 127.

FIG. 2A is a diagram of a screen 202A of the PCD 100 for entering a user's log-in credentials, such as a user name 204 on the PCD 100 to access the system 101. The user's log-in credentials 204 may comprise a unique user name selected by an operator of the PCD 100. When the user name is entered by the operator of the PCD 100, the central mobile payment controller 50 may verify that the user name entered and a unique identifier assigned to the PCD 100 match by checking client profiles which may be stored in the eWallet module 732F (See FIG. 7A). One of ordinary skill in the art recognizes that authentication of the operator of the PCD 100 at this stage may include other security measures beyond just a user name/password. Other security measures which may be used as alternatives or as supplemental security measures to those already described include, but are not limited to, biometrics, secure elements such as integrated-circuit (IC) cards or smart cards, and other like methods in the art of multi-factor authentication.

If the user name and unique identifier assigned to the PCD 100 do not match, then the central mobile payment controller 50 may deny entry to the system 101 and prompt the user for correct credentials for a predetermined number of times. If the user name and unique identifier assigned to the PCD 100 do match, then the central mobile payment controller 50 may prompt the operator of the PCD 100 for a password 206 associated with the user name on the account such as illustrated in FIG. 2B.

FIG. 2B is a diagram of a screen 202B for entering additional log-in credentials such as a password 206 on the PCD 100 to access the system 101. If the correct password 206 is not entered by an operator of the PCD 100 after a predetermined number of times, the central mobile payment controller 50 may lock out the account associated with the user name that was entered in the screen 202A of FIG. 2A. If the correct password 206 is entered by an operator of the PCD 100, then the central mobile payment controller 50 may generate a welcome screen 202C such as illustrated in FIG. 2C.

FIG. 2C is a diagram of a screen 202C for the PCD 100 confirming access to system 101. The welcome screen 202C may also comprise an execution button 208 that may activate the transaction software 501 residing on and supported by the PCD 100. Upon selecting the execution button 208, the PCD 100 may launch the payment application 113 running on the PCD 100 which causes the PCD 100 to generate the next screen 202D as illustrated in FIG. 2D.

FIG. 2D is a diagram of a screen 202D that shows the contents of an image 210 being scanned with a camera 848 of the PCD 100. The image 210 being scanned by the camera 848 (See FIG. 8 for camera) may comprise one of the tags 124 of FIG. 1. As noted previously, the tag 124 of FIG. 1 may comprise machine-readable data such as a two-dimensional barcode that contains a unique identifier associated with a particular electronic cash register 126 and a particular merchant. The 2-D bar code may include, but is not limited to, the following symbologies: Aztec Code, 3-DI, ArrayTag, Small Aztec Code, Chromatic Alphabet, Chromocode, Codablock, Code 1, Code 16K, Code 49, ColorCode, Compact Matrix Code, CP Code, CyberCode, d-touch, DataGlyphs, Datamatrix, Datastrip Code, Dot Code A, EZcode, Grid Matrix Code, High Capacity Color Bar code, HueCode, INTACTA.CODE, InterCode, MaxiCode, mCode, MiniCode, Micro PDF417, MMCC, Nintendo e-Reader#Dot code, Optar, PaperDisk, PDF417, PDMark, QR Code, QuickMark Code, Semacode, SmartCode, Snowflake Code, ShotCode, SuperCode, Trillcode, UltraCode, UnisCode, VeriCode, VSCode, WaterCode, for example.

Instead of a two dimensional bar code, a one dimensional bar code may be employed to provide the unique electronic cash register identifier and the unique identifier associated with the merchant. Exemplary one-dimensional bar codes may include, but are not limited to, U.P.C., Codabar, Code 25—Non-interleaved 2 of 5, Code 25—Interleaved 2 of 5, Code 39, Code 93, Code 128, Code 128A, Code 128B, Code 128C, Code 11, CPC Binary, DUN 14, EAN 2, EAN 5, EAN 8, EAN 13, Facing Identification Mark, GS1-128 (formerly known as UCC/EAN-128), GS1 DataBar formerly Reduced Space Symbology (“RSS”), HIBC (HIBCC Bar Code Standard), ITF-14, Latent image bar code, Pharmacode, Plessey, PLANET, POSTNET, Intelligent Mail Bar code, MSI, PostBar, RM4SCC/KIX, JAN, and Telepen. Other machine readable codes for retrieving the unique identifiers associated with the electronic cash register 126 and merchant are well within the scope of the invention such as contact-less or wireless communication methods such as near-field communications (NFCs) used with smart cards and RF-ID cards as understood by one of ordinary skill in the art. Further, in another exemplary embodiment, the operator of the PCD 100 may key-in a human-readable code 223 associated with the unique identifier of the electronic cash register 126 and the merchant.

As discussed above, once the central mobile payment controller 50 has the unique identifier associated with the electronic cash register 126 and the identifier associated with the merchant from the scanned image 210, then the central mobile payment controller 50 may communicate with the merchant enterprise system 16 for receiving product scan data generated by the product scanner 132.

FIG. 2E is a diagram of a screen 202E that shows merchant information 212 relevant to a transaction and a line item listing 214 of products being scanned by a product scanner 132 coupled to an ECR 412 (See FIG. 4). The merchant information 212 may comprise information such as, but not limited to, a merchant name, a mailing address of the store, date and time data relevant to the transaction, a store number, and a electronic cash register number, and other like information. The line item listing 214 of product scan data may comprise information such as, but not limited to, a product number, a short name for the product, a price and other similar information. According to an exemplary embodiment, an operator of the PCD 100 may shut “off” the line item listing 214 as a user defined preference which may be stored in the second storage device 146B.

While the product scanner 132 (of FIG. 4) is scanning the machine-readable product codes from the products/services 44, the central mobile payment controller 50 may match these machine-readable product codes with coupon data retrieved from the offer/coupon system 22. The offer/coupon system 22 may include one or more client profiles associated with the PCD 100. If the central mobile payment controller 50 determines a match between a coupon retrieved from the offer/coupon system 22 and the products/services 44 being scanned, the central mobile payment controller 50 may prompt the operator of the PCD 100 to take some action, such as illustrated in FIG. 2F as described below.

FIG. 2F is a diagram of a screen 202F that shows merchant information relevant to a transaction and a coupon option 216 that may be selected by an operator of the PCD 100. Screen 202F may be generated in response to the central mobile payment controller 50 determining a match between a coupon retrieved from the offer/coupon system 22 and products/services 44 being scanned. Screen 202F may list merchant information 212 and the coupon option 216 which prompts the operator of the PCD 100 to decide whether or not to use a coupon that matches a product 130 which was scanned by the product scanner 132A. This coupon option 216 may be turned off by an operator of the PCD 100 so that this screen 202F is not generated when a match is found by the central mobile payment controller 50.

An operator of the PCD 100 may allow automatic matching of coupons as they are discovered by the central mobile payment controller 50. In the exemplary screen 202F, the operator of the PCD 100 is asked to decide whether or not to use a manufacturer's coupon that may reduce the price of purchase for a products/services 44 to zero. If the operator of the PCD 100 decides not to use the coupon, then the coupon data may remain in storage accessible by the central mobile payment controller 50 until another match is found by the central mobile payment controller 50.

FIG. 2G is a diagram of a screen 202G that shows merchant information 212 relevant to a transaction and a total bill for a purchase along with a plurality of payment options 218A that may be selected by the operator. In the example illustrated in FIG. 2G, the total amount due for the purchase is $16.90. The payment options 218A allow a user to select the expense as a business expense towards taxes. The payment options 218A also allow an operator of the PCD 100 to select among a plurality of payment methods that may have been previously selected by the operator and stored in a user's profile in the second storage device 146B.

In other words, prior to conducting any transactions, an operator of the PCD 100 may arrange a predetermined listing of the sequence of payment methods which should be displayed to an operator of the PCD 100 whenever the operator employs the PCD 100 for a transaction. The operator of the PCD 100 may also create an association with the predetermined order of payment methods for particular merchants. This means that an operator of a PCD 100 may have a first sequence of payment methods for a first merchant and a second different sequence of payment methods for a second merchant that are stored in a client profile of the central mobile payment controller 50. The central mobile payment controller 50 may also display payment options 218A that provide the operator of the PCD 100 with additional benefits such as credit cards affiliated with a current merchant, which may award more loyalty points if the affiliated credit card is used for a purchase.

In other exemplary embodiments, the central mobile payment controller 50 may allow the merchant to control the payment options 218A that are presented to the operator of the PCD 100. In this way, the merchant may be provided with a form of payment steering—an indirect control of how an operator of a PCD 100 may decide on how to pay for a products/services 44.

The operator of the PCD 100 may also select one or more different payment methods to pay the total final amount due for a particular purchase. So, for example, a operator may select a credit card to pay a portion of the final bill along with payment from a stored value card and payment from a debit card. According to one exemplary aspect of the invention, the current balances of stored value accounts as well as remaining credit on credit card accounts may be displayed in conjunction with the payment options 218A that are available for selection by the operator with the PCD 100 as illustrated in FIG. 2G.

According to another exemplary feature of the system 101, credit card issuers as well as debit card issuers and stored value account issuers do not need to send any physical tokens to an operator of the PCD 100 when new account numbers may be assigned to a particular operator of the PCD 100. Instead of mailing physical tokens bearing the new account numbers, the issuers of the new account numbers may update the data a storage device or a secure vault. A corresponding message may be transmitted from the central mobile payment controller 50 to the operator of the PCD 100 when new account numbers have been stored in the secure vault or a storage device in place of old account numbers.

FIG. 2H is a diagram of a screen 202H that shows an electronic receipt 220A that may be provided upon completion of a transaction with a merchant. The electronic receipt 220A may comprise a product listing as well as the total price paid for the products/services 44 which were purchased. The payment method(s) selected by the operator (though not illustrated) may also be displayed on the electronic receipt 220A.

FIG. 2I is a diagram of an exemplary machine-readable tag 124. The machine-readable tag 124 may comprise a machine-readable code 222 which may be scanned with a camera 848 of the PCD 100. The payment application 113 (or other applications) running on the PCD 100 may be able to process the scanned machine-readable code 222.

As noted above, the machine-readable code 222 may comprise either a one dimensional or two-dimensional barcode. Further, other machine-readable codes are included within the scope of the invention and may include contactless technologies, such as near-field communications (NFC) which may or may not be linked to a secure-element, and RFID cards as understood by one of ordinary skill in the art. For these contactless technologies, the tag 124 may comprise an antenna 224 coupled to an integrated-circuit chip (not illustrated).

As described above, the tag 124 may provide a unique identifier associated with the electronic cash register 126 and a unique identifier associated with a merchant that operates the electronic cash register 126. These unique identifiers may be contained within the machine-readable code and/or associated with the code. The tag 124 may also comprise a human-readable code 223 that may be keyed-in by the operator of the PCD 100 instead of scanning the machine-readable code 222 with the PCD 100.

FIG. 3A is a diagram of hardware components and software components running on a portable computing device 100 for supporting transactions with the portable computing device 100. The components may include a device identification module 302, a communication hub module 310, an operating system platform (“O/S”) module 312, a global positioning satellite (“GPS”) module 322, a geo-positioning/triangulation module 324, a WiFi detector module 326, a scan module 328, a secure element module 877, and a near field communication module 330.

The software components may include the payment application 113 (including the pay-at-pump module 114, the pump display controller module 115, and the carbon offset/credit management module 116). The payment application 113 may further comprise additional modules for rendering visuals on the device display 908. These additional modules may include, but are not limited to, a common display module 314, a retail display module 316, a restaurant display module 31A, and other display modules #N 320. Further details about the additional modules that are part of the payment application 113 will be described below in connection with FIG. 3B.

The device identification module 302 may also comprise submodules such as a device identifier or International Mobile Equipment Identity (“IMEI”) module 304, a subscriber identity module (“SIM”) serial number module 306, and/or a subscriber identifier module or international mobile subscriber identity (“IMSI”) module 308. Usually, a portable computing device 100 would usually have only one of these modules to uniquely identify the portable computing device 100 to the communications network 142 and the central mobile payment controller 50 as understood by one of ordinary skill in the art.

The communication hub module 310 is responsible for relaying information between the device identification module 302 and the central mobile payment controller 50 as well as between the GPS module 322 and the central mobile payment controller 50. The communication hub module 310 may support conventional mobile phone communication protocols as understood by one of ordinary skill in the art.

The GPS module 322 and geo-positioning/triangulation module 324 may assist the central mobile payment controller 50 with determining the physical location of the portable computing device 100. Once the central mobile payment controller 50 is aware of the physical location of the portable computing device 100, the central mobile payment controller 50 may determine in which merchant location the portable computing device 100 is located.

The WiFi detector module 326 may communicate with a WiFi local area network router 142A that is part of a check-in system 90A. The check-in system 90A may allow an operator of the portable computing device 100 to alert the central mobile payment controller 50 when the portable computing device has entered into the location of a merchant. In this way, the central mobile payment controller 50 may be able to provide unique offers to the operator of the portable computing device 100 before the operator decides to complete a transaction for a products/services 44.

The check-in system 90A may further comprise machine-readable tags 124 that include, but are not limited to, a QR barcode tag 124A, and a radiofrequency-identifier (“RF-ID”) tag 124B. These machine-readable tags 124 of the check-in system 90A may be positioned at the entrance of a store and they may be positioned in multiple locations within a store such as in a department store. In a department store example, a machine-readable tag 124 may be positioned within specific different departments such as in hardware and in athletic goods so that the central mobile payment controller 50 may generate unique offers tailored to the department within which the portable computing device 100 is located. In the gas station example described below with reference to FIGS. 13-29, unique tags 124 may be located on the gas station pump(s) 90 or the car wash controller 98.

Referring to the embodiment of FIG. 3A, the check-out system 90B may also comprise machine-readable tags 124 that are positioned at each point-of-sale terminal or electronic cash register (“ECR”) 126. Each machine-readable tag 124 of the check-out system 90B, like the check-in system 90A, may comprise a 2-D QR barcode 124A and/or an RFID tag 124B.

The scan module 328 may work in conjunction with the camera 848 of the portable computing device 100. The scan module 328 may process scans of the 2-D QR barcodes that are present on a respective machine-readable tags 124. Similarly, the secure element module 877 and NFC module 330 may work with RFID tag 124B that may be part of either the check-in system 90A or the check-out system 90B.

The O/S module 312 may comprise any one of conventional mobile phone operating systems known as of this writing. For example, the O/S module 312 may comprise an android operating system, an iPhone operating system, a Java 2 Platform Micro Edition (“J2ME”) operating system, a Research-In-Motion (“RIM”) operating system, and a Binary Runtime Environment for Wireless (“BREW”) MP operating system as understood by one of ordinary skill in the art.

FIG. 3B is a diagram of several software components for a payment application 113 running on a portable computing device 100. The software components may form the common display module 314, the retail display module 316, and the restaurant display module 318 of FIG. 3A. The software components for the common display module 314 may include, but are not limited to: a splash module 314A, a home screen module 314B, a sign-in module 314C, a password module 314D, a scanning module 314E, a manual scan module 314F, a personal identification number (“PIN”) module 314G, a locations module 314H, an NFC tap module 314I, a search module 314J, a show map module 314K, a store receipts module 314L, a search receipt module 314M, a “my account” module 314N, a preferences module 314O a devices module 314P, a sign-account module 314Q, and a disable account module 314R as understood by one of ordinary skill in the art.

In this example, the splash module 314A performs the user and device authentication check on the display 808, such as a touch screen display, of the PCD 100. The home screen module 314B allows the operator to return to a home screen or default screen for the PCD 100. The sign-in module 314C allows manages any credentials that the operator enters into the PCD 100. The password module 314D reviews any received credentials for a match with the password selected by the operator. The scanning module 314E activates an automatic scanning feature supported by the PCD 100 so that the camera may automatically focus the camera for 848 for reading a tag 124. The manual scan module 314F activates a manual scanning feature in which the operator may control the focus of the camera 848 for reading a tag 124.

The personal identification number (“PIN”) module 314G allows the operator to change his or her PIN as understood by one of ordinary skill in the art. The locations module 314H supports a function in which the PCD 100 may display the closest merchants who support the PCD payment features. The NFC tap module 314I allows an operator to activate NFC functionality of the PCD 100. The search module 314J allows an operator to search for specific transactions that were made using the PCD 100. The show map module 314K may support functions such as a geographical map relative to the location of the PCD 100 as well as maps of building plans for merchants who support payments with the PCD 100.

The store receipts module 314L allows an operator to pull up copies of electronics receipts for any transaction completed by the PCD 100. The search receipt module 314M allows the operator to search for specific electronic receipts that were generated by the PCD 100. The “my account” module 314N allows an operator to review the current balances and pending payments supported by the PCD 100 for transactions completed with the PCD 100. The preferences module 314O allows an operator to display preferences for the account associated with the PCD 100, such as allowing the operator to select a preferred sequence of payment accounts to use with the PCD 100 for a transaction.

The devices module 314P allows an operator to review the multiple PCDs 100 that may be used by the operator to complete transactions. For example, if the operator had a plurality of mobile phones, then the devices module 314P may display a listing of the mobile phones associated with use of the mobile payment account. The sign-account module 314Q may allow operator to enter his or her electronic signature for completing transactions such as ACH transactions which may require an electronic signature. The disable account module 314R may support a function in which an operator may turn off his or her mobile payment account so that unauthorized use may not occur with other PCDs 100 that may be associated with the account.

The software components for the retail display module 316 may include, but are not limited to: a scan tag module 316A, a PIN module 316B, a first waiting module 316C, pay module 316D, a paid module 316E, and in-store module 316F, a list items module 316G, a second waiting module 316H, a paying module 316I, a paid module 316J, a receipt module 316K, and a check-in module 316L as understood by one of ordinary skill in the art.

The scan tag module 316A may automatically activate the camera 848 for focusing on a tag 124. The PIN module 316B may allow operator to change his or her PIN that may be associated only with retail transactions. The first waiting module 316C may activate a timer that an operator may select when he or she is waiting for the ECR 412 to communicate with the central mobile payment controller 50. The pay module 316D may allow the operator to automatically pay a balance when the balance is displayed by the PCD 100. The paid module 316E notifies the operator of the authorization or decline of each form of payment previously selected as well as the overall success or decline of the full transaction. The in-store module 316F may allow the operator to indicate that he or she is present within the store of a merchant prior to checking-in or checking-out using a tag 124. The list items module 316G may allow operator to redisplay any items being checked out for a payment transaction associated with the PCD 100. A second waiting module 316H may be activated by an operator of the PCD 100 when he or she is waiting for their payment options after a total bill for the transaction has been displayed. The paying module 316I displays the amount due along with the selection of applicable tender methods previously loaded to the central mobile payment controller 50. The operator of the PCD is given the opportunity to select one or more methods of payment to satisfy the amount due. The receipt module 316K allows an operator display the electronic receipt associated with the last transaction or the current transaction being processed by the PCD 100. The check-in module 316L may be activated by the operator when she or he is about to use the check-in system 90A of FIG. 3A.

The software components for the restaurant display module 318 may include, but are not limited to: an in-store module 318A, an items full module 318B, an items check module 318C, a partial pay module 318D, a partial paid module 318E, a split check module 318F, an items partial module 318G, and an items remaining module 318H as understood by one of ordinary skill in art.

The in-store module 318A may allow operator to alert the central mobile payment controller 50 that the PCD 100 is present within a restaurant. The items full module 318B displays the full list of items scanned in or otherwise entered by the “sales associate”. The items check module 318C allows an operator of the PCD 100 start a payment process associated with a restaurant transaction so that the operator does not need to wait for a waiter or waitress. The partial pay module 318D allows the operator of the PCD 100 to pay with the PCD 100 in addition to another form of payment not supported by the PCD 100 such as by a physical token like a credit card carried by the operator of the PCD 100. In the case where multiple parties each identify themselves as payors of the full amount due, the partial paid module 318E notifies the each operator of the approval or decline of their portion of the entire amount due. The split check module 318F allows an operator to split a check with another person who may be dining with the operator of the PCD 100. The items partial module 318G displays only the items that have been identified by the operator of the PCD as his/her portion of the full bill. The items remaining module 318H displays all items and remaining amount due that has not yet been satisfied during a split check.

The skinning capability module 332 provides a function for enabling a third party to utilize the full functionality of the system but with the look-n-feel of their choosing.

FIG. 4 is a diagram illustrating details for the merchant point-of-sale (“POS”) system 12 and the merchant enterprise system 16 of FIG. 1 for completing a sales transaction with a portable computing device 100. It should be appreciated that one or more aspects of the POS system 12 and the merchant enterprise system 16 described below may be performed by the store controller 96 located at the gas station 91. The merchant POS system 12 may comprise a store controller 410 and an electronic cash register (“ECR”) 412. Store controller 96 may be configured in a manner similar to store controller 410. The ECR 412 may comprise a drawer for storing cash currency. The ECR 412 may also print a receipt 127 for a customer with a printing device, like a printer (not illustrated).

The ECR 412 may be coupled to a handheld (or fixed) scanner 132 which may be used to scan other machine-readable labels attached to one or more products/services 44. The scanner 132 may comprise a bar code reader or any type of similar device used to collect information from machine-readable labels attached to products/services 44.

The ECR 412 may also be coupled to a reader (or terminal) 128, such as a magstripe reader or other such device for reading any one of a number of tokens 123 such as credit cards, debit cards, loyalty cards, stored value cards such as gift cards, and the like. For example, the reader 128 may comprise a device that reads magnetic stripes on cards, integrated circuit cards, and near-field-communication (NFC) cards as understood by one of ordinary skill in the art. The reader 128 may be coupled with a keypad 129 so that a consumer may enter appropriate information relative to any token that may be scanned or read by the reader 128.

The ECR 412 is also coupled to the store controller 410. The store controller 410 may support one or more electronic cash registers (ECRs) 126 for a particular location of a merchant. The store controller 410, as understood by one of ordinary skill in the art, may comprise a computer server for tracking and matching scanned product codes with a product inventory database (not illustrated separately) which is maintained by the store controller 410.

The store controller 410 may receive product data that is produced by the product scanner 132 and which is relayed by the ECR 412. The store controller 410 may be responsible for securing authorization for payment from a consumer after a token is read by the POS terminal 128B. The store controller 410 may support one or more product specific languages as understood by one of ordinary skill in the art such as, but not limited to, unified POS and JAVA™ POS.

To secure authorization for payment, such as for a credit or debit card, the store controller 410 communicates the merchant enterprise system 16 via the communications network 142. The merchant enterprise system 16 may comprise an Ewallet system 402, a credit switch 404, a data update module 406, and an enterprise router 408.

As illustrated in FIG. 4, the store controller 410 communicates with the enterprise router 408 of the merchant enterprise system 16. The router 408 may comprise a device that interconnects two or more computer networks, and selectively interchanges packets of data between them, as is understood by one of ordinary skill in the art.

The router 408 of FIG. 4 couples the store controller 410 to credit card system 20A and merchant acquirer 10 for traditional payment processing. The router 408 of FIG. 4 also couples the store controller 410 to alternative payment systems 18. Traditional payment processing may include, but is not limited to, processing payments from accounts associated with traditional credit cards and debit cards. The credit card system 20A may comprise exemplary networks such as the VISA™ credit card network, the MASTERCARD™ card network, the DISCOVER™ credit card network, the AMERICAN EXPRESS™ credit card network, and other similar charge or debit card proprietary networks.

Meanwhile, the alternative payment systems 18 may be responsible for handling and managing non-traditional or alternative payment processing. For example, alternative payment processing may include, but is not limited to, processing payments from accounts associated with certain online financial institutions or other service providers, like PAYPAL™, BILL ME LATER™, Wii™, APPLE™, GREEN DOT™, and mobile phone carriers like SPRINT™ and VERIZON™.

The eWallet system 402 may provide information and support functions for one or more stored value accounts as well as other types of accounts, such as, but not limited to, credit card accounts and bank accounts, as understood by one of ordinary skill in the art. The data update module 406 may allow the merchant enterprise system 162 update its records for any new mobile payment accounts that were used by consumers to pay for transactions.

The electronic cash register (“ECR”) 412 may comprise a plurality of components. These components may include hardware and software modules. Exemplary components include, but are not limited to, a loyalty module 414, a credit module 416, a private-label module 418, a coupons/discounts module 420, a PIN/debit module 422, a check module 424, an item entry module 426, a gift card module 428, a cash module 430, and a mobile payment module 432. The aforementioned components may be selected by an operator of the ECR 412 in order to complete payment for a transaction.

The ECR 412 may be coupled to a product scanner 132 for scanning one-dimensional and two-dimensional barcode labels. The ECR for 12 may also be coupled to a reader 128 that may comprise a magstripe and/or an NFC reader. The ECR 412 may also be coupled to a PIN pad 129 as well as a receipt printer 134 for printing a receipt 127, a sale total monitor 133, and a graphical customer display 131 that may list one items purchased during a transaction.

FIG. 5 is a diagram illustrating details of a merchant acquirer/processor 10, bank card systems 20B, and credit card systems 20A of FIG. 1 for completing a sales transaction. The merchant acquirer/processor 10 may comprise a pass-through module 502 and an authorization/settlement module 504. The pass-through module 502 may pass request for payment authorization information directly to a selected bank card system 20B. Meanwhile, the authorization/settlement module 504 may perform some authentication prior to sending request for payment authorization onto a bank card system 20B.

The merchant acquirer/processor 10 usually supports credit card systems that are provided by financial institutions such as banks. For example, credit card 20B1 may comprise a first bank card like a CHASE™ card from CHASE™ bank while credit card 20B2 may comprise a second bank card like a NATIONS BANK™ card from the NATIONS BANK™ lender. These institutions usually offer their brand of VISA™ and MASTERCARD™ type cards.

Other credit card systems 20A may comprise private-label cards 20A1 as well as traditional travel and entertainment cards 20A2. Private-label cards may include, but are not limited to, merchant based cards 20A1 a such as those for specific retail establishments like, THE HOME DEPOT™, WALMART™, NORDSTROM™, SAX™, etc. Traditional travel and entertainment cards 20A2 may include, but are not limited to, DINERS CLUB CARD™, AMERICAN EXPRESS™, and DISCOVER™.

While a direct connection is illustrated between the merchant enterprise system 16 and the credit card systems 20A as well as the merchant acquirer 10, one of ordinary skill in the art recognizes that such a connection may be a virtual one which is supported by the communications network 142. Similarly, a direct connection is illustrated between the merchant enterprise system 16 and the central mobile payment controller 50. This direct connection may also comprise a virtual one supported by the communications network 142 as illustrated in FIG. 1.

FIG. 6 is a diagram illustrating details of a gateway 14 and alternative payment systems 18 illustrated in FIG. 1. The gateway 14 may comprise a traditional gateway module 14A, a gateway vault 14B, and a high-security firewall 633. The high-security firewall 63 provides a secure communication channel between the central mobile payment controller 50 in the gateway 14. A traditional gateway module 14A may comprise a credit switch 602 and a transaction transport module 604.

The traditional gateway module 14A may comprise a payment server as understood by one of ordinary skill in the art. Communications between the central mobile payment controller 50 and the gateway 14 may comprise a secured socket layer (SSL) encrypted connection and may pass through the high-security firewall 633 as understood by one of ordinary skill in the art. Usually, the central mobile payment controller 50 issue commands to the gateway vault 14B to relay account information to the gateway module 14A. The payment gateway module 14A may forward the transaction information to one of the alternative payment systems 18 via the credit switch 602.

Specifically, the credit switch 602 may be responsible for exchanging data with each of the different alternative payment systems 18 illustrated in FIG. 6. The transaction transport module 604 may be responsible for exchanging data with a secure data transport module 618 of the gateway vault 14B.

The gateway vault 14B may comprise track 1/track two data 606, card not present (“CNP”) data 608, merchant gift card data 610, automated clearinghouse (“ACH”) data 612, loyalty data 614, and credentials 616. The gateway vault 14B may also comprise a tokenizer 620. The tokenizer 620 may receive a payment authorization request from the central mobile payment controller 50 in format according to specific industry rules based on the payment accounts stored with or associated with the gateway vault 14B.

The alternative payment systems 18 may comprise various different methods of payment available to the operator of the portable computing device 100 for completing a transaction. The alternative payment systems 18 may comprise internal systems 18A, mobile phone carrier billing 18B, e-commerce vendors 18C, alternate deposit systems 18D, demand deposit schemes 18E, and stored value systems 18F. For example, an internal system 18A may comprise accounts from an Ewallet system for the portable computing device 100, such as SWAGG™ brand of mobile payments offered by Outlier (a subsidiary of QUALCOMM, Incorporated). Mobile phone carrier billing systems 18B may include, but are not limited to, accounts from wireless carriers as of this writing such as, SPRINT™ accounts, AT&T™ accounts, VERIZON™ accounts, etc. e-commerce vendors 18C may include, but are not limited to, accounts from e-commerce vendors like iTUNES™ accounts, GOOGLE™ check out accounts, AMAZON™ payments, BILLMELATER™ accounts, and PAYPAL™ accounts. Alternate deposit systems 18D may include be coupled debit systems 18D1 and the like. Demand deposit systems 188 may include ACH transfers 18E1 and checks 18E2. And stored value systems 18F may include gift cards 18F1 offered by a merchant.

FIG. 7A is diagram illustrating details for the central mobile payment controller 50 illustrated in FIG. 1. The central mobile payment controller 50 manages data between the PCD 100 and the merchant enterprise system 16. As described below with reference to FIGS. 13-29, in the gas station example, the central mobile payment controller 50 may also manage data between the PCD 100 and the store controller 96 or the pump controller 95 located at the gas station 91. The central mobile payment controller 50 may support industry standard compliance measures. For example, the central mobile payment controller may be compliant with Payment Card Industry (“PCI”) standards. In this way, the merchant enterprise system 16 and the PCD 100 do not store any sensitive data such as credit card information and personal information like social security numbers, home addresses, etc. Such sensitive data may be stored in the central mobile payment controller 50.

The central mobile payment controller 50 is also responsible for communicating with a gateway 14 for establishing a connection with alternative payment systems 18. The central mobile payment controller 50 may also relay product scan data sent from the merchant enterprise system 16 over the communications network 142 to the PCD 100. In this way, the PCD 100 may display products individually (merchandise SKU's) on the display of the PCD 100 as they are scanned in by the product scanner 132 of the merchant POS system 12. The central mobile payment controller 50 may also relay identification (loyalty), promotions (offers/discounts), and payment information between the PCD 100 and merchant POS system 12 as described in further detail below.

The central mobile payment controller 50 may comprise a payment communication module 730, a user data store module 732, a system datastore module 734, a merchant data store module 736, a rules engine 737, an advertising API 720B, an advertising transport module 728, a loyalty API 720C, a loyalty transport module 746, a portal API 720D, a portal communications module 748, a client API 720E, a client device communications module 750, a merchant API 720F, and a merchant enterprise communications module 752.

The payment communications module 730 may support the communications between the central mobile payment controller 50 and the gateway 14 that is coupled to the alternative payment systems 18. While a direct connection between the central mobile payment controller 50 and the gateway 14 is illustrated, one of ordinary skill in the art recognizes that this direct connection may be a virtual one using the communications network 142 of FIG. 1. The user data store module 732 may comprise a plurality of submodules that include, but are not limited to, a demographics submodule 732A, a device management module 732B, a line item and purchase data module 732C, a preferences module 732D, a vault mappings module 732E, and an Ewallet module 732F.

The demographics submodule 732A may track preferences of the operator of the PCD 100 as well as characterizations made by the PCD 100 about the possible race, age, and gender of the operator. The device management module 732B may support functions for associating multiple pcds 100 with the mobile payment accounts of a single operator. The line item and purchase data module 732C may track all purchases made with the portable computing device 100. The preferences module 732D may store and support any new preferences requested by the operator using a PCD 100. The vault mappings module 732E may support request for payments from payment accounts associated with the gateway vault 14B of FIG. 1. An Ewallet module 732F supports request for managing in a walled account associated with a particular PCD 100.

The system datastore module 734 may comprise a plurality of submodules that include, but are not limited to, a transaction log module 734A, a merchant management module 734B, a user management module 734C, a device management module 734D, and a vault mappings module 734E.

The transaction log module 734A may automatically record and store the line items associated with each transaction paid with the portable computing device 100. The merchant management module 734B may automatically record and store the various merchants which received payment from the portable computing device 100.

The user management module 734C may allow the operator of the PCD 100 to manage various functions and options that are selectable for a given mobile count. The device management module 734D may support functions for associating multiple pcds 100 with the mobile payment accounts of a single operator. The vault mappings module 734E may support request for payments from payment accounts associated with the gateway vault 14B of FIG. 1.

Similarly, the merchant data store module 736 may comprise a plurality of submodules that include, but are not limited to, a location demographics module 736A, a graphic assets module 736B, tag mappings module 736C, and accepted payment options module 736D, a preferences module 736E, and MID mappings module 736F.

The location demographics module 736A may track the various merchant locations that are receiving payments with the PCD 100 for completing transactions. The graphic assets module 736B may support the various graphical elements such as artwork and icons associated with the credit cards. The tag mappings module 736C may store the various specific tags 124 that may be scanned with the PCD 100. The accepted payment options module 736D may control the listing of payment options that are displayed on the PCD 100 when a final amount is listed as due for a transaction. The preferences module 736E may store various preferences from merchants such as payment types and costs associated with each payment type that may be selected by an operator of a PCD 100. The merchant ID (“MID”) mappings module 736F associates the system's single “enterprise” relationship to each of the merchant's individual store locations.

The rules engine 737 may also comprise a plurality of modules. Exemplary modules include, but are not limited to, a loyalty sign-in module 738, a balance display module 740, targeted offers module 742, and a tender steering module 744. The loyalty sign-in module 738 may be responsible for automatically retrieving loyalty data associated with the portable computing device 100. The balance display module 740 may be responsible for sending the data to the display 808 of the portable computing device 100. Such data may include product scan data received from the merchant enterprise system 16 as well as the final total do for products/services 44 that are to be purchased using the portable computing device 100.

The targeted offers module 742 may be responsible for automatically retrieving offers and coupons from the offer/coupon system 22 based on the current location of the portable computing device as well as any products/services 44 that have been scanned in for purchase by the merchant POS system 12. The tender steering module 744 may be responsible for automatically displaying the options for paying for a particular transaction. The options would include those associated with the alternative payment systems 18 as well as the traditional payment systems 20 that are associated with the operator of the portable computing device 100.

The advertising transport module 728 may support communications between the central mobile payment controller 50 and the offer/coupon system 22. While a direct connection between the central mobile payment controller 50 and the offer/coupon system 22 is illustrated, one of ordinary skill in the art recognizes that this direct connection may be a virtual one using the communications network 142 of FIG. 1. The advertising transport module 728 establishes communications with the offer/coupon system 22 through an advertising API 720B.

The offer/coupon system 22 may comprise a plurality of modules. Exemplary modules include, but are not limited to, third-party offer generators 702A-D as well as a system account manager 704. The offer/coupon system 22 that produces targeted coupons based upon specific products purchased by a consumer. The third-party offer generator 702 may comprise modules supported by Catalina Marketing, Inc., SWAGG™ from Outlier (a subsidiary of Qualcomm, Incorporated), YOWZA!™, Mobilecoupon.com, and GROUPON™ brand of offers/coupons. Other types of offer/coupon system 22 are within the scope of the disclosure is understood by one or a skill in the art.

The offer/coupon system 22 may further comprise a merchant's module 712, a consumer packaged goods (“CPG”) module 714, a manufacturers module 716, and a GOOGLE™ module 718.

The loyalty transport module 746 may be responsible for supporting the communications between the central mobile payment controller 50 and the loyalty system 24. While a direct connection between the central mobile payment controller 50 and the loyalty system 24 is illustrated, one of ordinary skill in the art recognizes that this direct connection may be a virtual one using the communications network 142 of FIG. 1. The loyalty transport module 746 exchanges communications through the loyalty API 720C.

The portal communications module 748 may be responsible for supporting communications between the central mobile payment controller 50 and the online portals 26-32. While a direct connection between the central mobile payment controller 50 and the online portals 26-32 is illustrated, one of ordinary skill in the art recognizes that this direct connection may be a virtual one using the communications network 142 of FIG. 1. The online portals 26-32 will be described in further detail below in connection with FIG. 7B.

The client device communications module 750 may support communications between the central mobile payment controller 50 and the portable computing device 100. While a direct connection between the central mobile payment controller 50 and the portable computing device 100 is illustrated, one of ordinary skill in the art recognizes that this direct connection may be a virtual one using the communications network 142 of FIG. 1. The client device communications module 750 may establish communications with the portable computing device 100 through a client API 720E. Specifically, the client device communications module 750 may establish a persistent communication with the portable computing device 100 that may be characterized as a form of secure chat messaging.

The merchant enterprise communications module 752 may support communications between the central mobile payment controller 50 and the merchant enterprise system 16. While a direct connection between the central mobile payment controller 50 and the merchant enterprise system 16 is illustrated, one of ordinary skill in the art recognizes that this direct connection may be a virtual one using the communications network 142 of FIG. 1. The merchant enterprise communications module 752 may establish communications with the merchant enterprise system 16 by using a merchant API 720F. A secure communication channel may be established over the communications network 142 between the merchant enterprise communications module 752 and the merchant enterprise system 16 as understood by one of ordinary skill in the art.

All of the inbound and outbound communications for the central mobile payment controller 50 may pass through firewall/security layers 722A-F as understood by one of ordinary skill in the art. Each firewall/security layer 722 may comprise a device or set of devices designed to permit or deny network transmissions based upon a set of rules.

FIG. 7B is a diagram illustrating several online portals 26-32 for managing the transaction management system 101 according to one exemplary embodiment of the invention. The transaction management system 101 may comprise a mobile payment enrollment portal 26, a consumer mobile payment portal 28, a merchant store-specific mobile payment portal 30, and a merchant store-wide mobile payment management portal 32. Each of these portals 26, 28, 30, 32 may be coupled to the central mobile payment controller 50. While a direct connection as illustrated between the portals 26, 28, 30, 32 and the central mobile payment controller 50, one of ordinary skill in the art recognizes that this direct connection may be a virtual one that is established over the communications network 142. The communications between the central mobile payment controller 50 and each of the respective portals 26, 28, 30, 32 may be shielded with an appropriate firewall/security layer 722A as understood by one of ordinary skill in the art.

The mobile payment enrollment portal 26 may allow a consumer to open an account with their portable computing device 100. The mobile payment enrollment portal 26 may also allow a merchant to open account so that particular store locations may be managed by the transaction management system 101. The mobile payment enrollment portal 26 may comprise a teaser site module 26A, a public website module 26B, a merchant request module 26C, and a user registration module 26D. The merchant request module 26C may support the enrollment for a merchant who wishes to access the services provided by the transaction management system 101. The user registration module 26D may support the enrollment of individual consumers or operators of the pcds 100.

The consumer mobile payment portal 28 may comprise an enrollment module 28A, a cards module 28B, a devices module 28C, a favorites module 28D, in account preferences module 28E, and a reporting module 28F.

The merchant store-specific mobile payment portal 30 may comprise a location demographics module 30A, a graphics assets module 30B, an account preferences module 30C, a tender preferences module 30D, a reporting module 30E, and an advertising distribution rules module 30F.

The merchant store-wide mobile payment management portal 32 may comprise a merchant management module 32A, a user management module 32B, a payment management module 32C, a system preferences module 32D, and a reporting module 32E.

Referring to FIG. 8, an exemplary, non-limiting aspect of a portable computing device (“PCD”) is shown and is generally designated 100. As shown, the PCD 100 includes an on-chip system 822 that includes a multicore CPU 802. The multicore CPU 802 may include a zeroth core 810, a first core 812, and an Nth core 814.

As illustrated in FIG. 8, a display controller 828 and a touch screen controller 830 are coupled to the multicore CPU 802. In turn, a display 808 external to the on-chip system 822 is coupled to the display controller 828 and the touch screen controller 830. An NFC antenna 879 may be coupled to the CPU 802 and may support functions that work in combination with a secure element module 877. The secure element module 877 may comprise software and/or hardware and/or firmware as understood by one of ordinary skill in the art.

FIG. 8 further shows that a video encoder 834, e.g., a phase alternating line (“PAL”) encoder, a sequential color a memoire (“SECAM”) encoder, or a national television system(s) committee “(NTSC”) encoder, is coupled to the multicore CPU 802. Further, a video amplifier 836 is coupled to the video encoder 834 and the touch screen display 108. Also, a video port 838 is coupled to the video amplifier 836. As shown in FIG. 8, a universal serial bus (“USB”) controller 840 is coupled to the multicore CPU 802. Also, a USB port 842 is coupled to the USB controller 840. Memory 404A and a subscriber identity module (“SIM”) card 846 may also be coupled to the multicore CPU 802.

Further, as shown in FIG. 8, a camera 848 may be coupled to the multicore CPU 802. In an exemplary aspect, the camera 848 is a charge-coupled device (“CCD”) camera or a complementary metal-oxide semiconductor (“CMOS”) camera.

As further illustrated in FIG. 8, a stereo audio coder-decoder (“CODEC”) 850 may be coupled to the multicore CPU 802. Moreover, an audio amplifier 852 may coupled to the stereo audio CODEC 850. In an exemplary aspect, a first stereo speaker 854 and a second stereo speaker 856 are coupled to the audio amplifier 852. FIG. 8 shows that a microphone amplifier 858 may be also coupled to the stereo audio CODEC 850. Additionally, a microphone 860 may be coupled to the microphone amplifier 858. In a particular aspect, a frequency modulation (“FM”) radio tuner 862 may be coupled to the stereo audio CODEC 850. Also, an FM antenna 864 is coupled to the FM radio tuner 862. Further, stereo headphones 866 may be coupled to the stereo audio CODEC 850.

FIG. 8 further illustrates that a radio frequency (RF) transceiver 868 may be coupled to the multicore CPU 802. An RF switch 870 may be coupled to the RF transceiver 868 and an RF antenna 872. As shown in FIG. 4C, a keypad 874 may be coupled to the multicore CPU 802. Also, a mono headset with a microphone 876 may be coupled to the multicore CPU 802. Further, a vibrator device 878 may be coupled to the multicore CPU 802. FIG. 8 also shows that a power supply 880 may be coupled to the on-chip system 822. In a particular aspect, the power supply 880 is a direct current (DC) power supply that provides power to the various components of the PCD 100 that require power. Further, in a particular aspect, the power supply is a rechargeable DC battery or a DC power supply that is derived from an alternating current (AC) to DC transformer that is connected to an AC power source.

FIG. 8 further shows that the PCD 100 may also include a network card 888 that may be used to access a data network, e.g., a local area network, a personal area network, or any other network. The network card 888 may be a Bluetooth network card, a WiFi network card, a personal area network (PAN) card, a personal area network ultra-low-power technology (PeANUT) network card, or any other network card well known in the art. Further, the network card 888 may be incorporated into a chip, i.e., the network card 888 may be a full solution in a chip, and may not be a separate network card 888.

As depicted in FIG. 8, the display 808, the video port 838, the USB port 842, the camera 848, the first stereo speaker 854, the second stereo speaker 856, the microphone 860, the FM antenna 864, the stereo headphones 866, the RF switch 870, the RF antenna 872, the keypad 874, the mono headset 876, the vibrator device 878, and the power supply 880 are external to the on-chip system 822.

In a particular aspect, one or more of the method steps described herein may be stored in the memory 803 as well as in the central mobile payment controller 50, merchant enterprise system 16, merchant POS system 12, and other storage devices as computer program instructions. These instructions may be executed by the multicore CPU 802, central mobile payment controller 50, merchant enterprise system 16, and merchant POS system 12 in order to perform the methods described herein. Further, the multicore CPU 802, merchant enterprise system 16, merchant POS system 12, other storage devices, and memory 803 of the PCD 100, or a combination thereof may serve as a means for executing one or more of the method steps described herein.

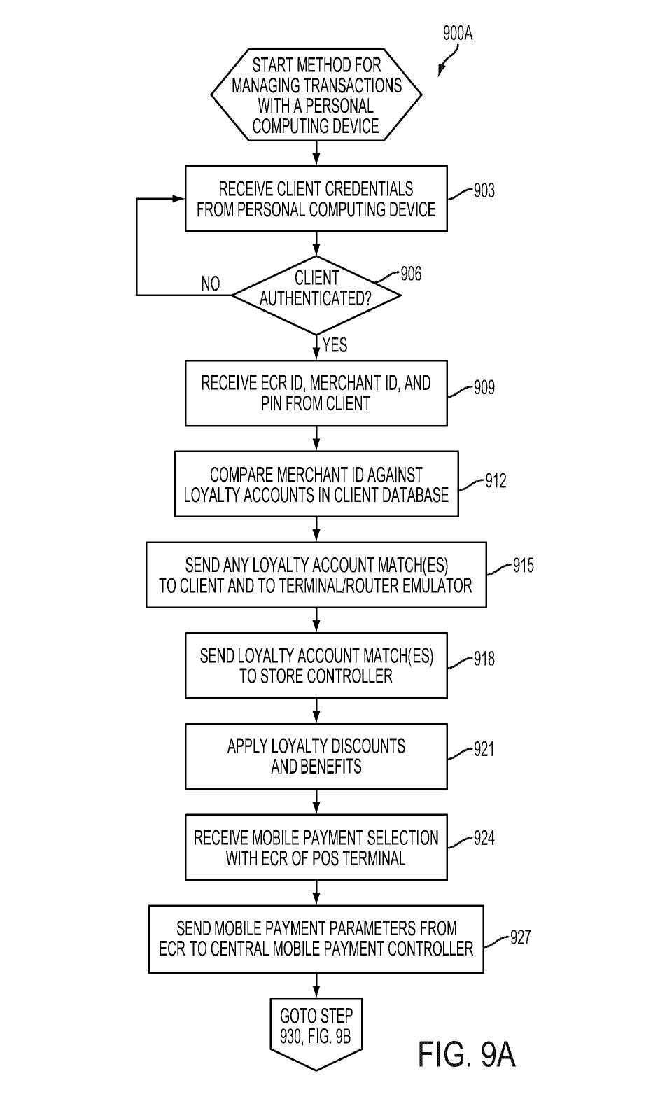

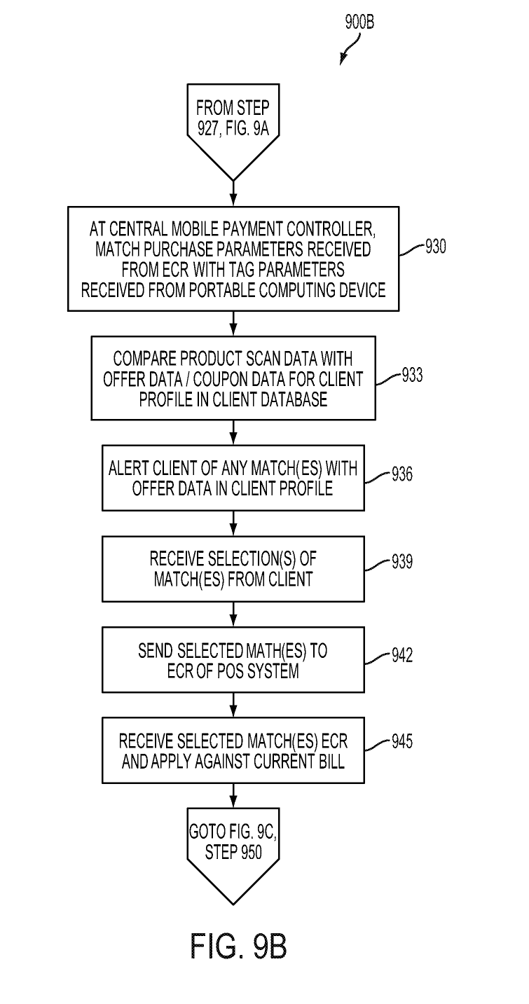

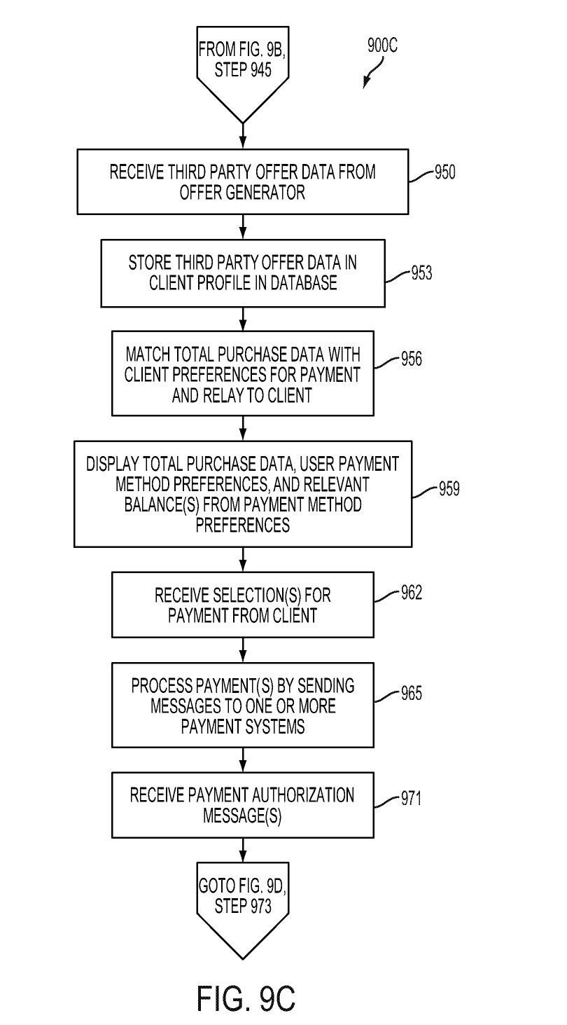

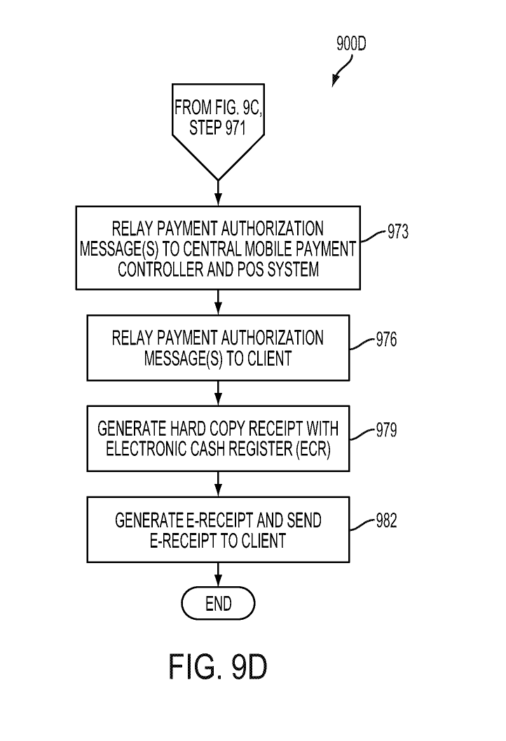

FIG. 9A is a flowchart illustrating a method 900A for managing transactions with a PCD 100. Block 903 is the first step in the process 900 for managing transactions with the PCD 100. In block 903, the client credentials entered in screens 202A and 202B of FIGS. 2A-2B are received by the central mobile payment controller 50 from the portable computing device (PCD) 100. As noted previously, the client credentials may comprise a user name 204, a password or personal identification number (“PIN”) 206, and a unique identifier assigned to the PCD 100.

Next, in decision block 906, the central mobile payment controller 50 determines if the client is authenticated based on the credentials that it received in block 903. In this decision block 906, the central mobile payment controller 50 may verify that the user name 204 of screen 202A matches the unique client identifier assigned to the PCD 100 which is maintained in the system datastore module 734 of FIG. 7A. The system datastore module 734 may comprise a client database containing client profiles associated with PCDs 100. If the central mobile payment controller 50 verifies that the user name 204 matches the client unique identifier assigned to the PCD 100, then the central mobile payment controller 50 checks to see if the password or PIN 206 of screen 202B matches the user name 204 of screen 202A based on a review of the client profile stored in the system datastore module 734.

If the inquiry to decision block 906 is negative, then the “No” branch is followed back to block 903 for receiving the client's credentials for a predetermined number of times. If the inquiry to decision block 906 is positive, then the “Yes” branch is followed to block 909 in which the ECR 412 or terminal identifier, merchant identifier, and PIN are received from the PCD 100. In this block, the PCD 100 may conduct a scan of the tag 124 that comprises the machine-readable code 222 which contains the ECR 412 or terminal identifier as well as the merchant identifier.

Subsequently, in block 912, the central mobile payment controller 50 may compare the merchant identifier received against the loyalty data stored in the loyalty system 24. In this block 912, the payment controller may issue a request for data to the loyalty system 24 using the client identifier.

If the central mobile payment controller 50 determines that there is one or more matches between any loyalty account data received from the loyalty system 24 and the merchant identifier, then in block 915 the central mobile payment controller 50 sends the loyalty account data over the communications network 142 to the portable computing device 100. The portable computing device 100 may display the amount of loyalty points earned and/or used for a particular transaction. If the operator of the PCD 100 has not been enrolled in the loyalty system 24 for a particular merchant, the central mobile payment controller 50 may facilitate the enrollment of the operator at this stage.

In block 918, the central mobile payment controller 50 sends the loyalty account data to the ECR 412 of the merchant POS system 12 by using the terminal identifier. Next in block 921, when the ECR 412 receives the loyalty account data, the ECR 412 may apply appropriate discounts and/or benefits. The application of the discounts and/or benefits may be based on the products/services 44 purchased by the operator of the PCD 100 or they may be based on other factors or a combination of factors such as the number of re-occurrences of purchasing products from the merchant.

Next, in block 924, the central mobile payment controller 50 may receive a signal from the ECR 412 of the merchant POS system 12 that a mobile payment option has been selected. This signal is usually generated by an employee of the merchant who is operating the ECR 412.

Next, in block 927, one or more mobile payment parameters and the product scan data may be sent from the ECR 412 to the central mobile payment controller 50. The one or more mobile payment parameters may comprise a total due, a transaction identifier, a terminal identifier, a merchant identifier, and the sequence number. The process then continue continues to block 930 of FIG. 9B.

FIG. 9B is a continuation flowchart corresponding to the flowchart of FIG. 9A which illustrates a method 900B for managing transactions with a PCD 100. Block 930 is the first block of this continuation flowchart for managing transactions with the PCD 100. In block 930, the central mobile payment controller 50 matches the purchase parameters received from the ECR 412 with the parameters from the tag 124 received from the portable computing device. As noted previously, the purchase parameters received from the ECR 412 may comprise the total amount due for the transaction, a transaction identifier, a terminal identifier, a merchant identifier, and a sequence number. The parameters from the tag 124 relayed by the portable computing device 100 may comprise a terminal identifier, the merchant identifier, and the PIN for the portable computing device 100. If these two sets of parameters do not match, the central mobile payment controller 50 would stop the transaction from being completed and would not display any options for payment on the portable computing device 100.

Next, in block 933, the central mobile payment controller 50 may compare the received product scan data with offer data as well as with the coupon data received from the loyalty system 24 and already stored in a client profile. In block 936, the central mobile payment controller 50 may alert the PCD 100 of any matches with the offer data and coupon data. Specifically, the central mobile payment controller 50 may generate a message that is formatted and received by the PCD 100 and displayed as a selectable option as illustrated in screen 202F as illustrated in FIG. 2F.

However, according to one exemplary embodiment and similar to the selectable option for displaying product scan data described above, a user or operator of PCD 100 may select an option for turning “off” the display of offer data and coupon data matches. According to another exemplary embodiment or the same exemplary embodiment in which the display of offer data and coupon data matches is turned “off”, the user or operator of PCD 100 may elect for the central mobile payment controller 50 to automatically apply matches between coupon data and products/services 44 purchased as well as for matches between the offer data and products/services 44 purchased. These options or preferences for handling and displaying data may part of a client profile which may be stored in the user datastore 732 of FIG. 7A, and particularly, the preferences module 732D. The redeemed coupons may also be sent back through the central mobile payment controller 50 to the appropriate electronic redemption used by the merchant. Alternatively, the redeemed coupons may be sent over the communications network 142 to the appropriate electronic redemption used by the merchant as understood by one of ordinary skill in the art.

In block 939, the central mobile payment controller 50 may receive one or more selection(s) of match(es) from the PCD 100 in response to the operator of PCD 100 selecting one or more options displayed in screen 202F of FIG. 2F. In block 942, the central mobile payment controller 50 sends any user selected match(es) over the communications network 142 and the communication links 103 to the ECR 412 of the merchant POS system 12. The process then proceeds to block 950 of FIG. 9C.

FIG. 9C is a continuation flowchart corresponding to the flowchart of FIG. 9B which illustrates a method 900C for managing transactions with a PCD 100. Block 950 is the first block of this continuation flowchart for managing transactions with the PCD 100. In block 950, the central mobile payment controller 50 may receive third-party offer data produced by a third-party offer generator 702 of the offer/coupon system 22. As described previously, a third-party offer generator 702 may comprise off-the-shelf units, such as, but not limited to, units/modules sold as of this writing by Catalina Marketing, Inc. The offers produced by the third-party offer generator 702 may comprise coupons targeted for a particular operator of PCD 100 based upon the products/services 44 that are purchased and recorded by the product scanner 132 and the ECR 412. The offer/coupon system 22 may also generate private label offers for new credit cards such as a credit card bearing the name of the merchant, such as a WALMART™ or TARGET™ credit card. The

In block 953, the central mobile payment controller 50 may take the received third-party offer data and store it in a storage device corresponding to a particular profile of the operator of the PCD 100. Next, in block 956, the central mobile payment controller 50 may match the total due with the client preferences for payment stored in the user preference data of the preferences module 732D of FIG. 7A. The central mobile payment controller 50 may then relay this client preference for payment methods to the PCD 100.

In block 959, the total purchase data, user payment method references, and relevant balances from the payment method preferences may be displayed on the screen 202G as illustrated in FIG. 2G and generally designated by reference numeral 218A. Next, in block 962, the central mobile payment controller 50 may receive one or more selection(s) for the payment methods over the communications network 142 from the PCD 100 based on selections made by the operator of PCD 100.

Next, in block 965, the central mobile payment controller 50 may process the selected payment methods by sending messages to one or more payment systems 18 and 20 via the gateway 14 and/or the merchant enterprise system 16. Specifically, the central mobile payment controller 50 may send messages to the gateway 14 if one or more alternative payment systems 18, such as, but not limited to, PAYPAL™ brand of online financial payment solutions and SPRINT™ brand of mobile telephone networks, have been selected by the operator of the PCD 100 for paying the final amount due for a purchase. The central mobile payment controller 50 may also send information related to traditional payment systems 20, such as, but not limited to conventional credit card accounts via the communications network 142.

Next in block 971, the central mobile payment controller 50 may receive payment authorizations from any of the payment systems 18 and 20. The process then continues to block 973 of FIG. 9D.

FIG. 9D is a continuation flowchart corresponding to the flowchart of FIG. 9C which illustrates a method 900D for managing transactions with a PCD 100. Block 973 is the first block of this continuation flowchart for managing transactions with the PCD 100. In block 973, the central mobile payment controller 50 may relay the payment authorization messages from the alternative payment systems 18 and traditional payment systems 20 to the ECR 412 of the merchant POS system 12 via the merchant enterprise system 16. In block 976, the central mobile payment controller 50 may also relay the payment authorization messages from the alternative payment systems 18 as well as the payment authorization messages from the traditional payment systems 20 over the communications network 142 to the PCD 100.

Next, in block 979, the electronic cash register (“ECR”) 412 of the merchant POS system 12 may generate a hard copy receipt 127. Similarly, in block 982, the central mobile payment controller 50 may generate an electronic receipt and send it over the communications network 142 to the PCD 100 for display on the display 808 of the PCD 100 as illustrated in screen 202H of FIG. 2H. The process then ends.

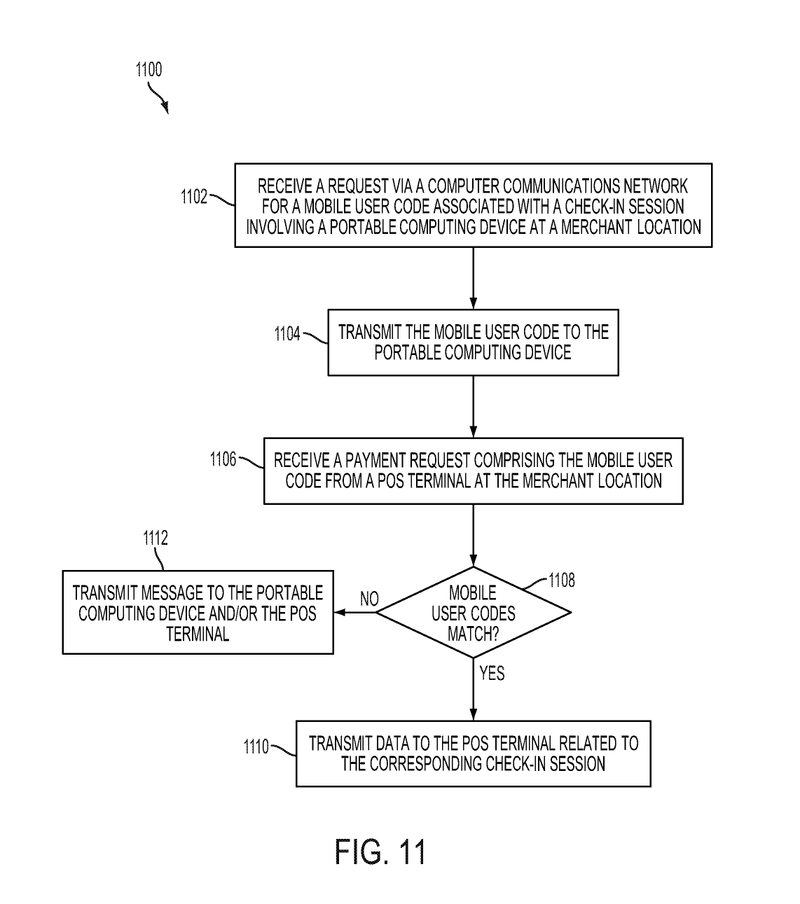

As mentioned above, the check-in, check-out, and/or payment processes implemented by the transaction management system 101 may not necessarily involve tags 124. In the embodiment illustrated in FIG. 11, the transaction management system 101 manages transactions at a merchant location 1102 between a PCD 100 and a point-of-sale (POS) terminal 1101 using, for example, mobile user code(s) 1107 assigned to a check-in session 1109 and transmitted to a PCD 100 rather than unique tags 124 assigned to the POS terminals 1101. As described in more detail below, the central mobile payment controller 50 may transmit a mobile user code 1107 to a PCD 100. The mobile user code 1107 is not associated with any payment type or specific form of payment. Rather, the mobile user code 1107 may be associated with a merchant identifier and the merchant location 1102, as described above.

During the check-in session at the merchant location, the user of the PCD 100 may select one or more goods and/or services to purchase from the merchant. The user may also receive, collect, and/or redeem offers, coupons, loyalty rewards, or promotions associated with the goods and/or services associated with the check-in session 1109 (referred to as “non-payment assets”). The central mobile payment controller may store the non-payment assets and link them to the mobile user code 1107 or the check-in session 1109.

During the check-out process, the mobile user code 1107 may be automatically provided to the POS terminal 1101 by the payment application 113 or manually entered at the POS terminal 1101 by the user of the PCD 100 or the merchant. The POS terminal 1101 may send a request to the mobile payment controller 50 for a transaction associated with the PCD 100. The central mobile payment controller receives the request from the POS terminal 1101, which may comprise the mobile user code 1107 previously transmitted to the PCD 100. The central mobile payment controller 50 compares the mobile user code 1107 received from the POS terminal 1101 with the mobile user code 1107 previously transmitted to the PCD 100. If the mobile user code 1107 received from the POS terminal 1101 matches the mobile user code 1107 previously transmitted to the PCD 100, the central mobile payment controller 50 may provide certain data to the POS terminal 1101 related to the corresponding check-in session 1109. The check-in session data may comprise, for example, coupon, offer, and/or loyalty data related to the non-payment assets associated with the mobile user code 1107 or other data related to corresponding user accounts. In other embodiments, the data may comprise an authorization for the transaction, a payment authorization, payment instruments or tokenized versions of payment instruments, or any other data related to the non-payment assets or the check-in session data.

While implementations involving unique tags 124 to identify the POS terminals 1101 may be desirable in certain situations and may provide a convenient solution for initiating the check-out/payment process at the POS terminal 1101, the approach involving mobile user codes 1107 and check-in sessions 1109 may provide additional benefits. For example, the use of mobile user codes 1107 eliminates the need for unique tags 124 to identify each POS terminal 1101, which may reduce implementation costs and provide a more scalable platform suitable for various types of merchant models (e.g., retail stores, quick-service restaurants, etc.). Instead of the POS terminal 1101 having to perform a passive polling of the central mobile payment controller 50 to determine whether a PCD 100 has captured and provided the unique tag 124 to the central mobile payment controller 50, the POS terminal 1101 may actively initiate, control, and/or manage the check-out/payment process and apply the non-payment assets to the transaction by receiving the mobile user code 1107 directly from the PCD 100 and then providing it to the central mobile payment controller 50. Furthermore, the use of mobile payment codes 1107 provided to the POS terminal 1101 (rather than the PCD 100 submitting the tag 124 to the central mobile payment controller 50) may eliminate the need to manage potential pairing collision scenarios caused by multiple PCDs 100 checking out at the same POS terminal 1101.

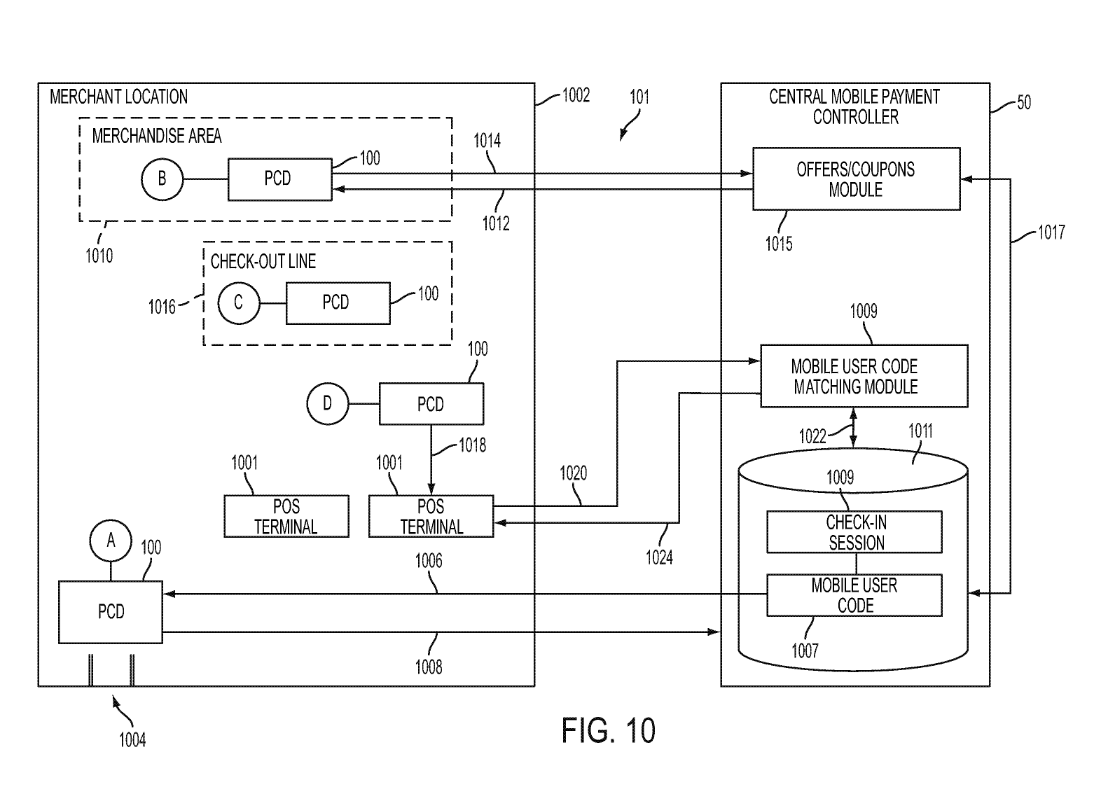

FIG. 10 illustrates an exemplary implementation at a merchant location 1002, which may comprise a retail store that sells goods and/or services, a quick-service or other type of restaurant, or any other merchant. An embodiment of a method will be generally described with reference to four phases or steps (identifiers A, B, C, and D in FIG. 10). At phase A, a user of a PCD 100 may enter the merchant location 1002 via entrance 1004 and check-in with the central mobile payment controller 50. Various check-in methods may be implemented.

The PCD 100 may check-in via the payment application 113 or other software applications residing on the PCD 100. As described above, the PCD 100 may scan a tag 124 at a merchant location 1102 or otherwise obtain a merchant identifier associated with the merchant location 1102, and provide the merchant identifier to the central mobile payment controller 50. The PCD 100 may also check-in via location-based services residing on the PCD 100 (e.g., GPS 322, geo-positioning/triangulation 324, or near field communication components 877 and 330—FIG. 3A).

In other embodiments, the PCD 100 may check-in via a remote location-based service provided by a third party provider, such as, a location-based social networking provider, with which the central mobile payment controller 50 may communicate. For instance, the user may check-in to a location-based social networking profile, which obtains the merchant location 1002, and makes it available to central mobile payment controller 50.

Regardless the check-in method, the PCD 100 may provide a request 1008, either separately or integrated with the check-in method, to the central mobile payment controller 50. In response to the request 1008, the central mobile payment controller 50 may generate and assign a unique or temporary mobile user code 1007 to a check-in session 1009 with the PCD 100. The mobile user code 1007 and check-in session 1009 may be stored in a database 1011 and linked to the PCD 100 or the user. The central mobile payment controller 50 may transmit the mobile user code 1007, via a message 1006, to the PCD 100. The PCD 100 may store the mobile user code 1007 in memory 803 (FIG. 8).

At phase B, the user may enter a merchandise area 1010 and select one or more goods and/or services to purchase from the merchant. The user may receive, collect, and/or redeem offers, coupons, loyalty rewards, or promotions (referred to as “non-payment assets”), which may be delivered and/or managed via, for example, offer/coupon system 22 or loyalty system 24.

As described above, the non-payment assets may be presented to the user via the PCD 100 (interface 1012) or other computing device and redeemed (interface 1014) by the user during or prior to the check-in session 1009. The central mobile payment controller 50 may obtain or access data associated with the user's non-payment assets (offers/coupons module 1015) and store the data in database 1011 or other remote or local databases, as described above, and link the non-payment asset data to the mobile user code 1007 and/or check-in session 1009.

At phase C, the user of the PCD 100 may approach a POS terminal 1001 to pay for the goods and/or services or wait in a check-out line 1016 until the next POS terminal 1001 is available. At phase D, the user of the PCD 100 initiates a payment transaction by providing the mobile user code 1007 to the POS terminal 1001. It should be appreciated that the POS terminal 1001 may obtain the mobile user code 1007 in any suitable manner. The payment application 113 may electronically transmit the mobile user code 1007 (interface 1018) via, for example, NFC antenna 879 (FIG. 8) or other wireless transceivers. In other embodiments, the mobile user code 1007 may be displayed on display/touchscreen 808 (FIG. 8) and manually entered on a keypad or other input device associated with the POS terminal 1001 either by the user of the PCD 100 or a merchant.

The POS terminal 1001 may transmit a request 1020 to the central mobile payment controller 50 via communications network 142. The request 1020 may comprise the mobile user code 1007 provided by the user, the merchant, or the PCD 100. The central mobile payment controller 50 receives the mobile user code 1007 provided by the POS terminal 1001, accesses the database 1011 (interface 1022), and compares it to the mobile user code 1007 associated with the check-in session 1009, which was previously provided to the PCD 100.

If there is a match (mobile user code matching module 1009), the central mobile payment controller 50 may perform a look-up in database 1011 and provide certain corresponding data related to the check-in session 1009 to the POS sale terminal 1001. The check-in session data may comprise, for example, coupon or offer data or other data related to the non-payment assets associated with the mobile user code 1007. It should be appreciated, however, that the central mobile payment controller may also verify the check-out session according to the mobile user code 1007 and, in other embodiments, may authorize the transaction or and/or authorize payment for the transaction. Regardless the type of check-in session data, the central mobile payment controller 50 may send a message 1024 to the POS terminal 1001, which may comprise the non-payment assets, transaction authorization, and/or payment authorization. The check-in session data provided to the POS terminal 1001 may involve an interactive process with the POS terminal. For example, the central mobile payment controller 50 may compare scanned products or selected goods and/or services received from the POS terminal 1001 (or similar or other data from the PCD 100) against the offer or coupon data related to the non-payment assets associated with the check-in session 1009.

FIG. 11 illustrates an embodiment of a method 1100 implemented by the central mobile payment controller 50, although it should be appreciated that one or more aspects of the method may be implemented by other components in the transaction management system 101. Block 1102 is the first block of method 1100.

At block 1102, the central mobile payment controller 50 receives a request, via computer communications network 142, for a mobile user code 1007 associated with a check-in session 1009 involving the PCD 100 at a merchant location 1002. As mentioned above, the request for the mobile user code 1007 may be received as part of the check-in process or after verifying a check-in. At block 1104, the central mobile payment controller 50 transmits the mobile user code 1007 over the communications network 142 to the PCD 100. The mobile user code 1007 may be linked to a check-in session 1009 associated with the PCD 100. At block 1106, the central mobile payment controller 50 receives a request from a POS terminal 1001.

The request may comprise the mobile user code 1007 previously transmitted to the PCD 100 and provided to the POS terminal 1001 by the PCD 100 or entered by the user or merchant. At decision block 1108, the central mobile payment controller 50 compares the mobile user code 1007 received from the POS terminal 1001 with the mobile user code 1007 transmitted to the PCD 100 and stored in database 1011. If there is a match, the central mobile payment controller 50 may provide to the POS terminal 1001 data related to the corresponding check-in session 1009. As mentioned above, the check-in session data may comprise coupon, offer, and/or loyalty data related to non-payment assets associated with the check-in session 1009 or data related to payment instruments or tokenized versions of payment instruments. In other embodiments, the data returned to the POS terminal 1001 may comprise a transaction authorization or a payment authorization.

For embodiments in which the central mobile payment controller 50 handles the payment processing, payment instruments may not be transmitted to the POS terminal 1001, and the central mobile payment controller 50 may process the payment. After attempting to process the payment, the central mobile payment controller 50 may transmit to the POS terminal 1001 data involving the results of the payment processing, such as, status, auto-codes, etc. It should be appreciated that the general flow of payment processing by the central mobile payment controller 50, in this embodiment, may operate as follows. The central mobile payment controller 50 may transmit the check-in session data (e.g., the non-payment assets) to the POS terminal 1001. The POS terminal 1001 may adjust the pricing based on the non-payment assets. The POS terminal 1001 may send a request to the central mobile payment controller 50 to perform payment processing. The central mobile payment controller 50 may return the status and/or results of the payment processing to the POS terminal 1001.

Referring again to the flowchart of FIG. 11, if there is not a match, at block 1112, a suitable message may be transmitted to the POS terminal 1001 and/or the PCD 100. As an example, the message may request that the mobile user code 1007 be resubmitted or re-entered in the POS terminal 1001 or request that the user perform another check-in.

### Transactions at Gas Station 91

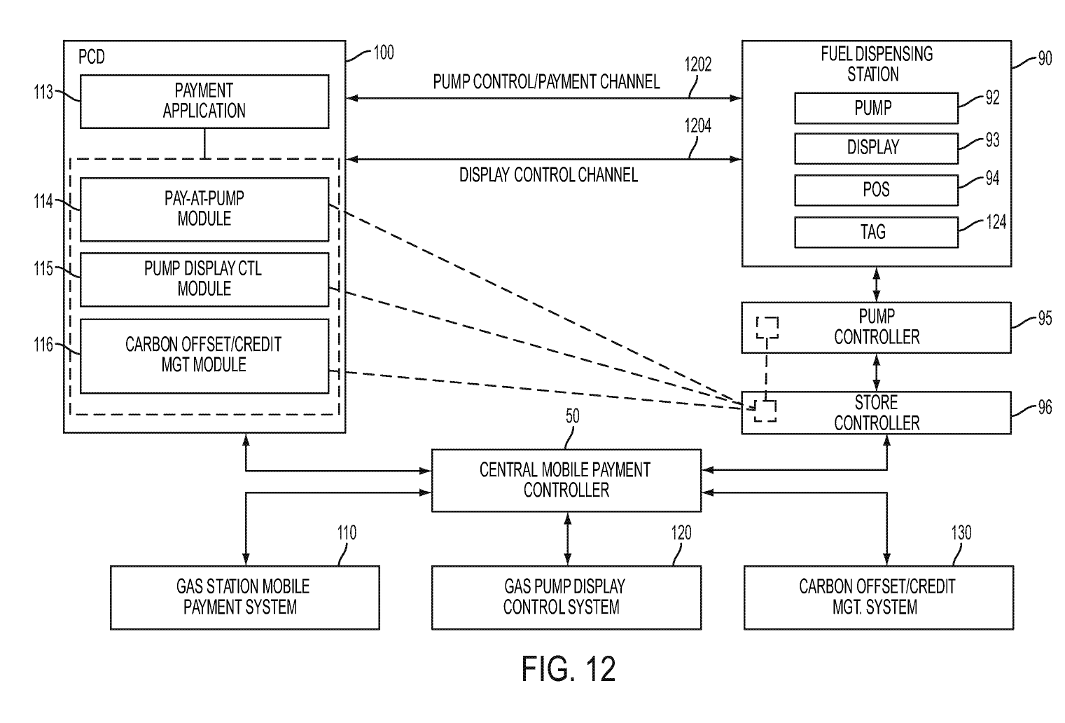

As mentioned above, the system 101 may provide a transactional and/or payment platform for enabling desirable transactions at the fuel dispensing stations 90 via a PCD 100. Referring to FIG. 12, various software components may be integrated into the system 101. For example, the PCD 100 may be configured with a pay-at-pump module 114, a pump display control module 115, and a carbon offset/credit management module 116. The pay-at-pump module 114, the pump display control module 115, and the carbon offset/credit management module 116 communicate with the central mobile payment controller 50, which in turn communicates with the store controller 96 and/or the pump controller 95 located at the gas station 90. In this regard, the central mobile payment controller 50 may establish and control bi-directional virtual communication channels between the PCD 100 and the store controller 96 and/or the pump controller 95 via the software applications executing on the PCD 100 and associated software components executing on the store controller 96 and/or the pump controller 95. The pay-at-pump module 114 may communicate with the central mobile payment controller 50 via a pump control/payment channel 1202, which enables a user of the PCD 100 to control the pump 92 by, for example, selecting a fuel grade, paying for gas, and selecting and purchasing a car wash via the PCD 100. The pump display control module 115 may communicate with the central mobile payment controller 50 via a display control channel 1204, which enables a user of the PCD to control, via the PCD 100, the content displayed on the integrated display 93 at the fuel dispensing station 90 while the user is pumping gas. The carbon offset/credit management module 116 enables a user of the PCD 100 to purchase carbon emission credits (referred to as credits or offsets) when purchasing fuel at the gas station 91.

It should be appreciated that the gas station mobile payment system 110, the gas pump display control system 120, and the carbon offset/credit management system 130 represent the logic or functionality executed within the system 101 for implementing the corresponding features. The logic may reside at one or more components within the system 101 (or at remote devices in communication with the system 101) even though FIG. 12 illustrates systems 110, 120, and 130 as separate components that interface with the central mobile payment controller 50.

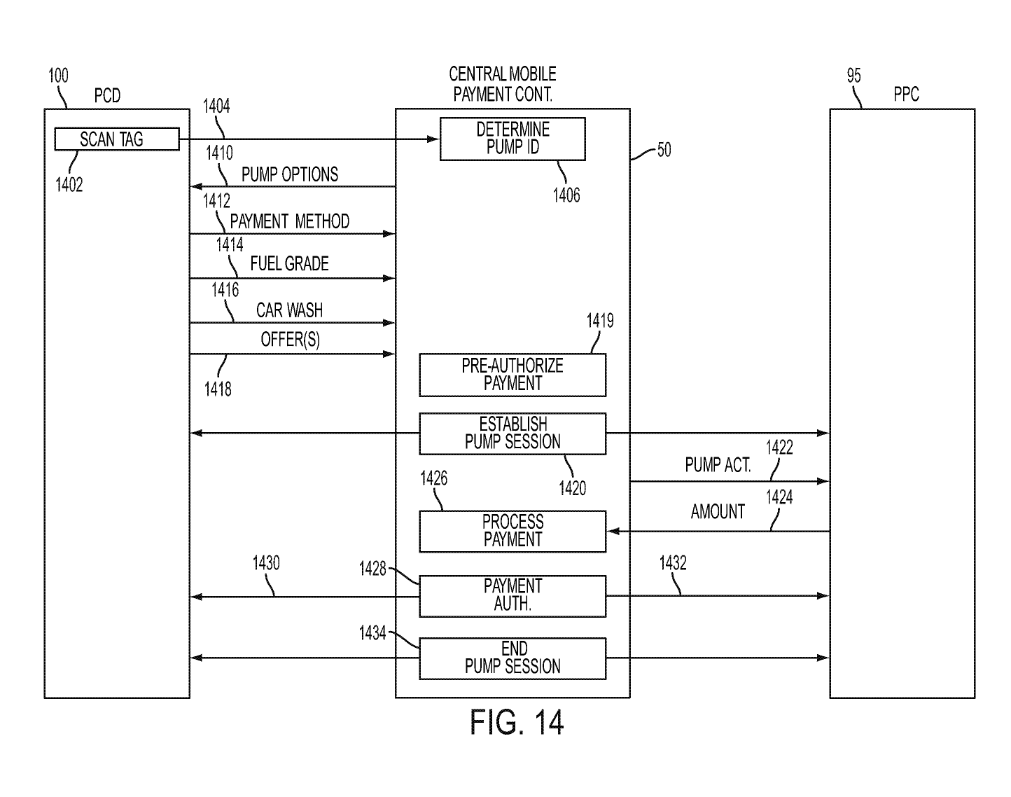

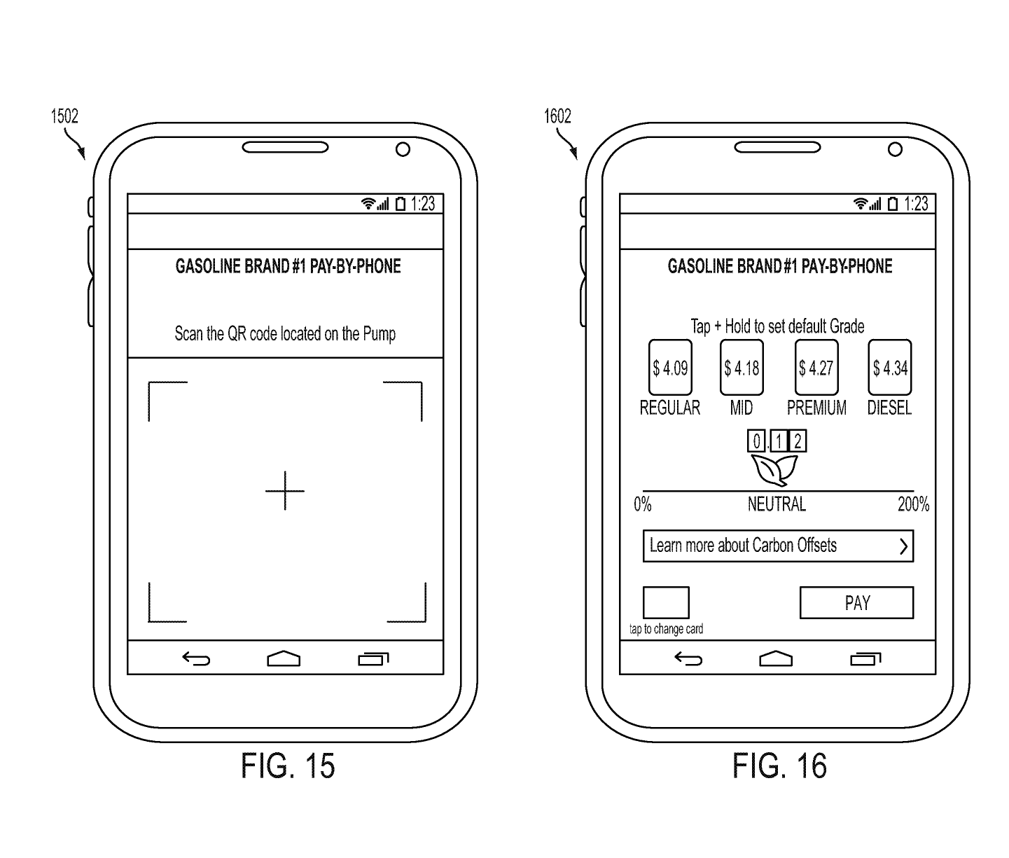

FIG. 14 illustrates the data processing and flow of communications between the PCD 100, the system 101 (e.g., central mobile payment controller 50), the store controller 96, and the pump controller 95 for enabling a user to control the pump 92 via the PCD 100. As illustrated in FIG. 13, the pay-at-pump module 114 may comprise a screen 1302 that displays a map of nearby gas stations 91 that support the pay-at-pump or other features. The user may enter a participating gas station 91 and select one of the fuel dispensing stations 90 for fueling a vehicle. At block 1402, a tag 124 affixed to the fuel dispensing statin 90 may be scanned by the pay-at-pump module 114 and transmitted to the central mobile payment controller 50 via a message 1404. FIG. 15 illustrates an example of a screen 1502 for scanning a QR code, such as illustrated in FIG. 2I. It should be appreciated, however, that the tag 124 may be configured and transmitted to the central mobile payment controller 50 using any of the methods described above. The central mobile payment control 50 receives the tag 124 and, at block 1406, determines a pump identifier associated with the tag 124. The central mobile payment controller 50 may also determine a store controller identifier and/or a merchant identifier associated with the gas station 91.

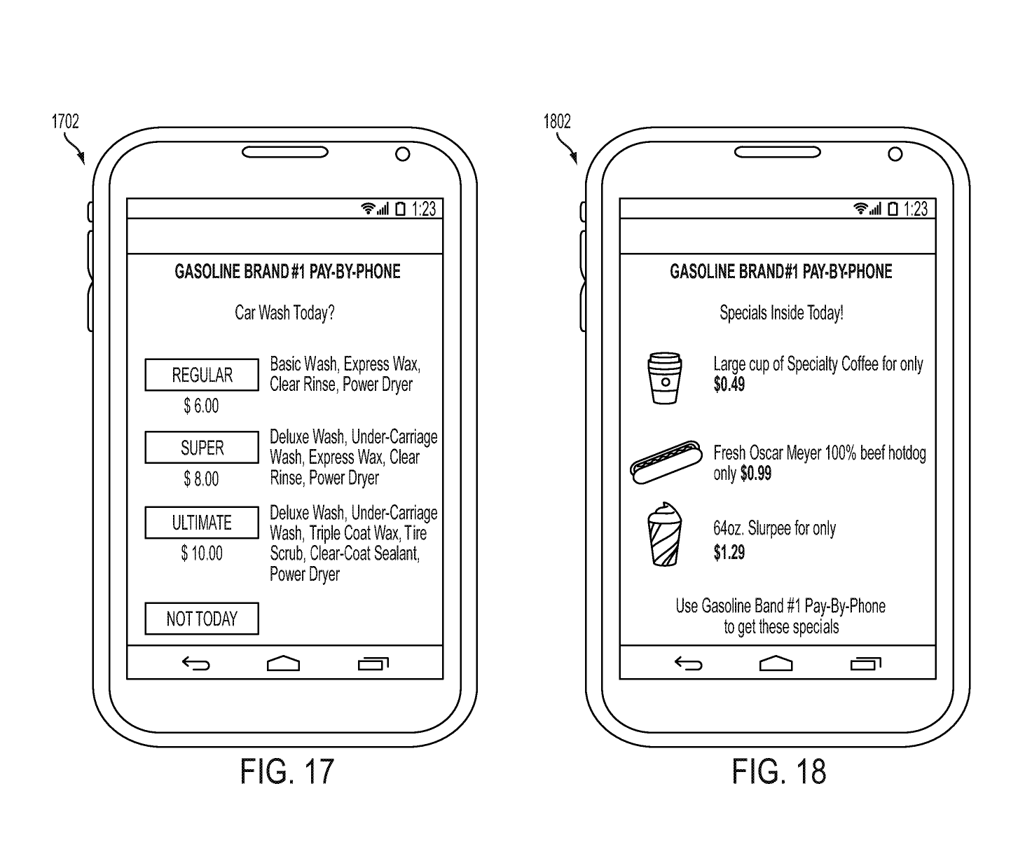

Based on the pump identifier, the central mobile payment controller 50 may determine the available services and/or features at the fuel dispensing station 90 and present a menu of pump and other options to be displayed on the PCD 100 (message 1410). FIG. 16 illustrates an exemplary screen 1602 with various pump options. The screen 1602 includes icons identifying the available fuel grades for the pump 92 with accompanying per gallon prices. The screen 1602 also includes a “tap to change card” icon for selecting a method of payment and a pay button for initiating payment after the vehicle is fueled. FIG. 17 illustrates a screen 1702 for selecting a car wash to be included with the fuel purchase. Various promotional offers for in-store items may be also be provided to and displayed on the PCD 100. FIG. 18 illustrates a screen 1802 for displaying daily specials. The user may select and redeem the specials via other screens not shown with the purchases being added to the transaction. The pay-at-pump module 114 may send to the central mobile payment controller 50 the selected or default payment method via a message 1412, the selected or default fuel grade via a message 1414, a car wash selection via a message 1416, and any redeemed offer(s) via a message 1418.

At block 1419, the central mobile payment controller 50 may perform a pre-authorization for the payment method, as described above. In an embodiment, the central mobile payment controller 50 may send a request to the merchant acquirer/processor 10 (FIG. 1). It should be appreciated that pre-authorization of the payment method may be performed prior to, after, or at the same time as receiving messages 1414, 1416, and/or 1418. In an embodiment, the payment method 1412 may be received first and after pre-authorization the messages 1414, 1416, and/or 1418 may be received. If the payment method is pre-authorized (e.g., by receiving a message from the merchant acquirer/processor 10), at block 1420, the central mobile payment controller 50 establishes a pump session for the pump control/payment channel 1202 between the PCD 100 and the pump controller 95 (which is identified by the pump identifier, the store controller identifier, and/or the merchant identifier). The central mobile payment controller 50 may send a pump activation message 1422 to the pump controller 95. When the fueling is completed, the pump controller 95 disables the pump 92 and may then transmit a message 1424 to the central mobile payment controller 50 containing an amount for the fueling. The amount may comprise the dollar amount or an amount of fuel. In the latter case, the central mobile payment controller 50 may be configured to determine the amount based on the amount of fuel. It should be appreciated that the pump controller 95 may send the message 1424 directly to the central mobile payment controller 50 or, in some embodiments, may send the message 1424 through the store controller 95. The store controller 96 may determine a pay amount for the total amount of pumped fuel and transmit the payment amount to the central mobile payment controller 50 in a separate message.

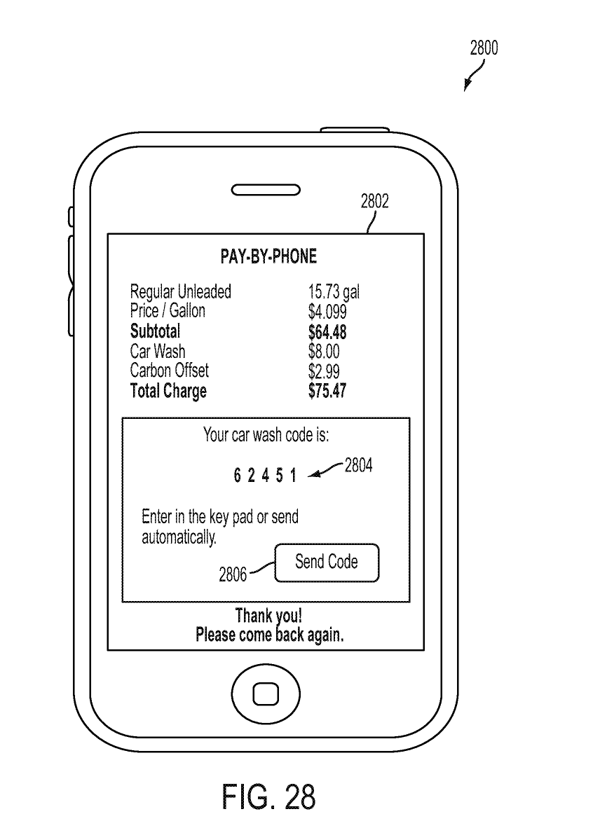

At block 1426, the central mobile payment controller 50 may initiate or perform processing of the payment amount according to the selected payment method in the manner described above. Regardless of how payment processing is performed, at block 1428, the central mobile payment controller 50 may receive a payment confirmation (e.g., from merchant acquirer/processor 10) and forward appropriate messages 1430 and 1432 to the PCD 100 and the pump controller 95, respectively. FIG. 28 illustrates an exemplary screen 2800 for displaying a receipt 2802 for the transaction. If a car wash has been purchased, the receipt 2802 may include a code 2804 that may either be entered in a key pad at the car wash controller 98 (FIG. 1) or automatically transmitted to the car wash controller 98, the pump controller 95, or the store controller 96 (e.g., send code button 2806). In another embodiment, the pay-at-pump module 114 may prompt the user to scan a tag 124 (e.g., a QR code) affixed to the car wash controller 98 for purposes of authenticating the PCD 100.

After completion of the car wash and/or any in-store purchases (including any redeemed offers) or alternatively after the user has finished fueling the vehicle, the central mobile payment controller 50 may terminate the pump session between the PCD 100 and the pump controller 95.

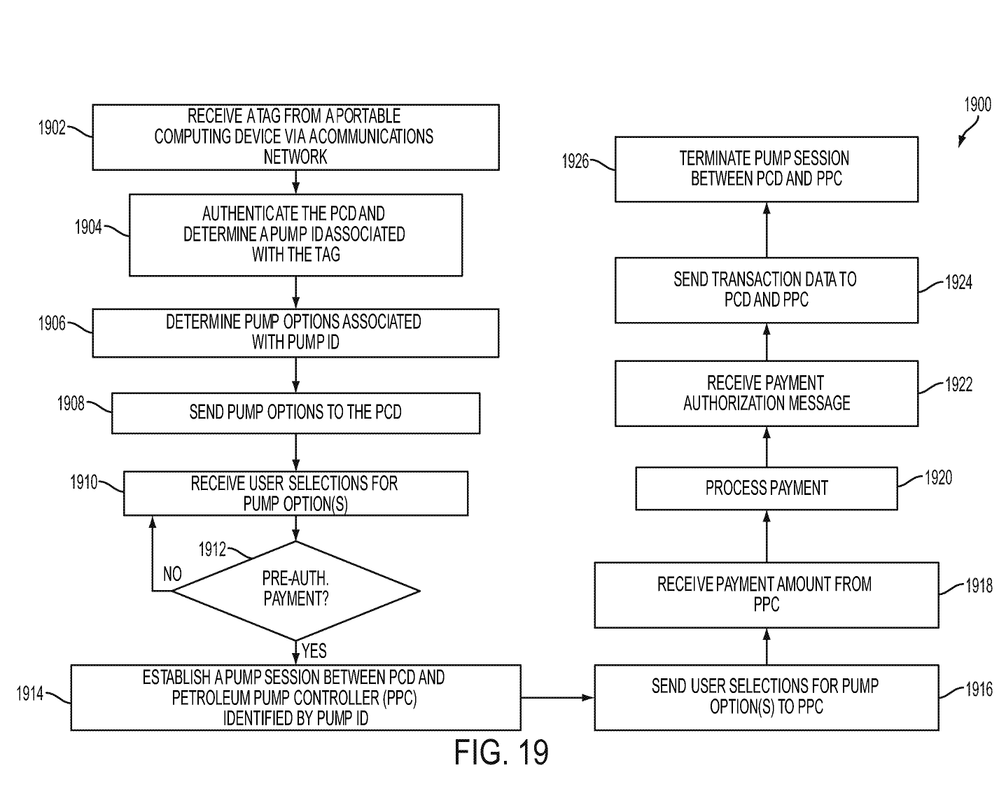

FIG. 19 illustrates a method 1900 executed by the system 101 (i.e., the gas station mobile payment system 110) for managing transactions at the fuel dispensing station 90 and enabling a PCD 100 to control the pump 92. At block 1902, the gas station mobile payment system 110 receives the tag 124 affixed to the fuel dispensing station 90 or otherwise receives a pump identifier for the fuel dispensing station 90. At block 1904, the PCD 100 may be authenticated by the system 101, as described above, and the pump identifier may be determined and verified. At block 1906, the gas station mobile payment system 110 determines options available at the fuel dispensing station 90. A database may be provided that links pump identifiers with corresponding store controller identifiers and/or merchant identifier. The database may maintain a list of pump options available for each pump identifier (e.g., fuel grade options, payment methods, car wash options, promotions, etc.). At block 1908, the gas station mobile payment system 110 may send one or more pump options to the PCD, which may be displayed via pay-at-pump module 114. At block 1910, the gas station mobile payment system 110 receives user selection(s) for one or more of the pump options. At block 1912, gas station mobile payment system 110 may pre-authorize a payment method, as described above. If pre-authorized, the gas station mobile payment system 110 establishes the pump control/payment channel 1202 as a pump session between the PCD 100 and the pump controller 95 identified by the pump identifier. If the selected payment method is not pre-authorized, the user may be prompted to select another payment method.

After the pump session is established, at block 1916, the gas station mobile payment system 110 sends the user selection(s) of the pump options to the pump controller 95/The pump options may include, for example, the fuel grade selection and whether a car wash has been selected or any offer(s) have been redeemed. At block 1918, after the fueling process has been completed, the gas station mobile payment system 110 receives the payment amount from the pump controller 95. The gas station mobile payment system 110 may be configured to initiate or perform payment processing (block 1920). At block 1922, the gas station mobile payment system 110 receives a payment confirmation message and then sends transaction data to the PCD 100 and the pump controller 95 (block 1924). At block 1926, the pump session may be terminated.

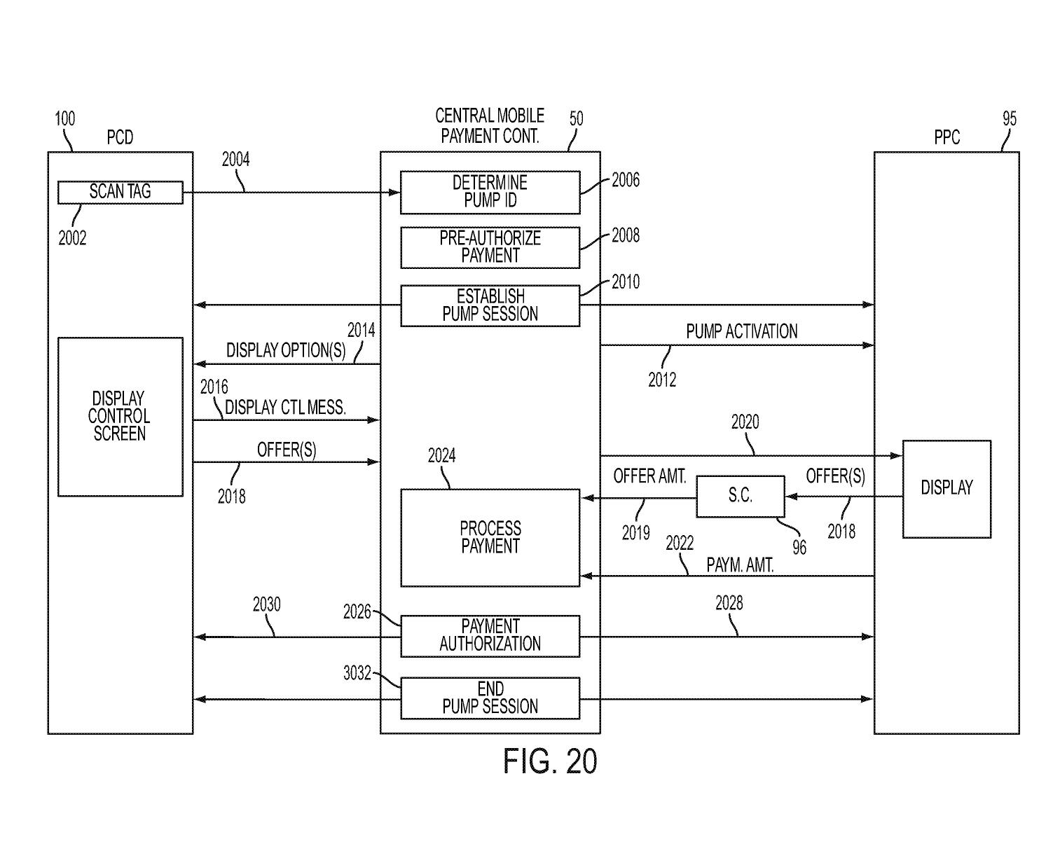

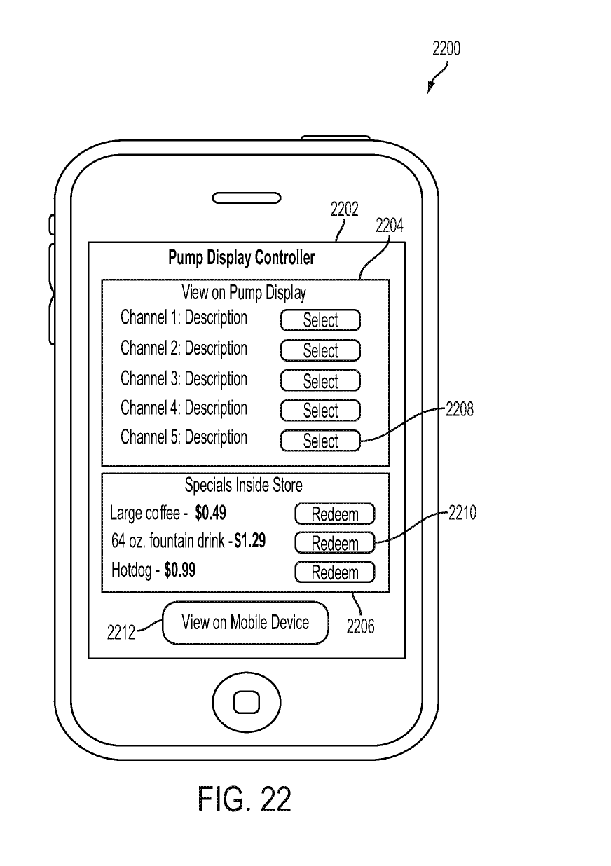

FIG. 20 illustrates the data processing and flow of communications between the PCD 100, the system 101 (e.g., central mobile payment controller 50), the store controller 96, and the pump controller 95 for enabling a user to control the display 93 located at the fuel dispensing station 90 via the PCD 100. As described above in connection with FIG. 14, the central mobile payment controller 50 may determine the pump identifier, perform pre-authorization of a payment method, and establish a pump session between the PCD 100 and the pump controller 95 (e.g., blocks 2002, 2004, 2006, and 2008). If pre-authorized, the central mobile payment controller 50 may send a pump activation 2012 to the pump controller 95. The pump session may include establishing the display control channel 1204 (FIG. 12). Based on the pump identifier, the central mobile payment controller 50 may determine the display services and/or features available at the fuel dispensing station 90. The display option(s) may be presented in a menu that is displayed on the PCD 100 (message 2014). FIG. 22 illustrates examples of available display option(s). The screen 2200 may include a pump display controller 2202 that lists a plurality of video channels 2204 that may be selected. A user of the PCD 100 may select a video channel 2204 via a button 2208. If a video channel 2204 is selected, an appropriate display control command or message 2016 may be provided to the central mobile payment controller 50. The user may also view the selected video channel 2204 on the PCD 100 by selecting the “view on mobile device” button 2212. The screen 2200 may also comprise a list of in-store offer or specials 2206, which may be redeemed by selecting corresponding buttons 2210. If an offer is selected, a message 2018 may be provided to the central mobile payment controller 50.

Display control commands 2016 may be forwarded to the pump controller 95 (message 2020), while offers 2018 may be forwarded to the store controller 96. It should be appreciated that a display control command 2016 or message 2020 may comprise a channel identifier or other means for identifying a video file or video data. The pump controller 95 may determine the video data identified by the display control command (e.g., by performing a database lookup) and then send a command to the display 93, which causes the display of the appropriate video. The user may also redeem offer(s) 2018 directly from the display 93. Any redeemed offers 2018 may be sent directly to the central mobile payment controller 50 or through the store controller 96, or added to the gas payment amount (message 2022), which the pump controller 95 sends to the central mobile payment controller 50, as described above. Payment processing (blocks 2024 and 2026) and session termination (block 2032) may be performed in the manner described above.

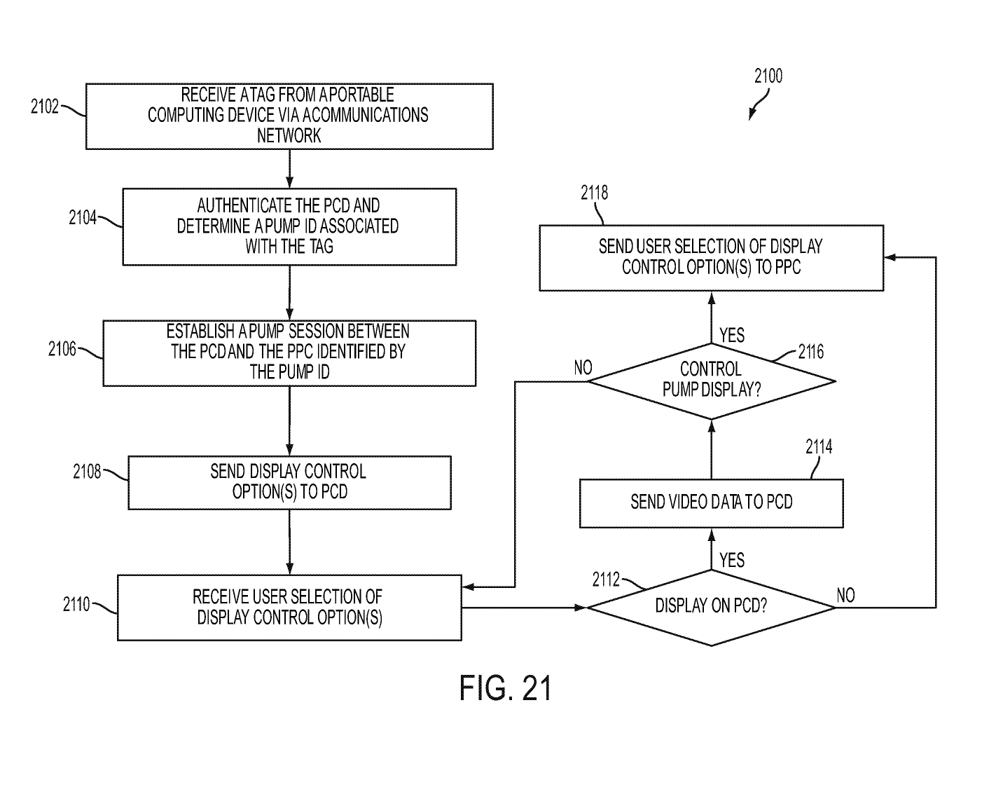

FIG. 21 illustrates a method 2100 executed by the system 101 (i.e., the gas pump display control system 120) for enabling a PCD 100 to control the display 93 integrated with the fuel dispensing station 90. At block 2102, the gas pump display control system 120 receives the tag 124 affixed to the fuel dispensing station 90. At block 2104, the PCD 100 may be authenticated by the system 101, as described above, and the pump identifier may be determined and verified. At block 2106, the gas pump display control system 120 establishes the pump session between the PCD 100 and the pump controller 95, as described above. The gas pump display control system 120 may determine display options available at the fuel dispensing station 90. A database may be provided that links pump identifiers with corresponding store controller identifiers and/or merchant identifiers. The database may maintain a list of display options, video channels, video files, promotions, advertising messages, etc. available for each pump identifier. At block 2108, the gas pump display control system 120 sends the display options to the PCD 100 for display via the pump display controller module 115. At block 2110, the gas pump display control system 120 receives user selection(s) for one or more of the display options. Based on the received display control messages 2016 (FIG. 20), the gas pump display control system 120 may be configured to determine whether the content is to be displayed on the PCD 100 (decision block 2112) and/or the integrated display 93 (decision block 2116). If the content is to be displayed on the PCD 100, the gas pump display control system 120 sends the video data to the PCD 100 (block 2114). If the display control message 2016 involves controlling the display 93, the gas pump display control system 120 instructs the pump controller 95 to update the displayed content.

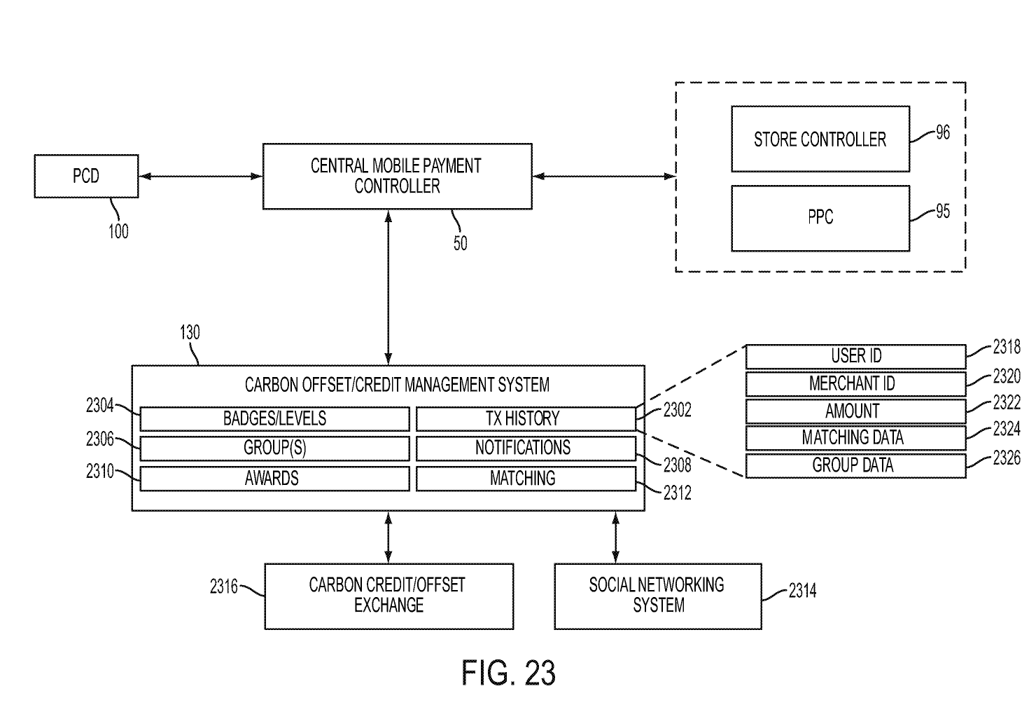

FIGS. 23-26 illustrate the structure and operation of the carbon offset/credit management system 130 of FIG. 1. The carbon offset/credit management system 130 comprises a platform for providing and managing a carbon offset program. The carbon offset program may include a government-mandated industrial program and a voluntary consumer program. In an embodiment, the carbon offset/credit management system 130 may comprise a third party administrative entity that creates, verifies, tracks, reports, shares, manages, and exchanges carbon credits or offsets (referred to as credits, offsets, or collectively as offsets/credits) according to environmental regulations in a particular jurisdiction. In the government-mandated context, the carbon credit may comprise a tradable certificate or permit representing the right to emit an amount of carbon dioxide or the mass of a greenhouse gas with a carbon dioxide equivalent (CO2e).

Carbon credits and carbon markets may be a component of local, state, national, or international attempts to mitigate the growth in concentrations of greenhouse gases. One carbon credit is typically equal to one metric ton of carbon dioxide or, in some markets, carbon dioxide equivalent gases. The goal of carbon credit/offset systems is to allow market mechanisms to encourage industrial and commercial processes with lower emissions or less carbon intensive approaches than those used when there is no cost to emitting carbon dioxide and other greenhouse gases into the atmosphere. Because greenhouse mitigation projects generate credits, this approach can be used to finance carbon reduction schemes between trading partners in any jurisdiction. The voluntary consumer program may use the same or different metrics or standards as the government-mandated programs for determining a carbon offset.

It should be appreciated that the terms carbon offset, carbon credit, and carbon offset/credit refer to any environmentally relevant standard, including, for example, a carbon emission reduction credit, a carbon offset, a verified emissions reduction (VER), a carbon emission reduction (CER), an emission reduction unit (ERU) or a voluntary carbon unit (VCU), an emissions allowance, an energy conservation certificate, a carbon avoidance certificate, a residential emission reduction credit, a tradable residential emission reduction credit, a residential renewable energy certificate, a tradable residential renewable energy certificate, a carbon credit or offset or emission allocation, a renewables obligation certificate, or any other type of credit, certificate, or allocation relating to one or more of any form of pollution, pollution reduction, environmental measure or benefit and the like.

It should be appreciated that the carbon offset/credit management system 130 may encourage participation in the voluntary consumer program by enabling consumers to conveniently purchase, via the PCD 100, carbon offsets or credits at the time of fueling their vehicle. As illustrated in FIG. 23, the voluntary consumer program may be implemented via software applications operating on the PCD 100. The logic and functionality of the carbon offset/credit management module 116 may be integrated with the payment application 113 or the pay-at-pump module 114 described above or provided as a separate application or module. In either implementation, the carbon offset/credit management module 116 may manage communications between the PCD 100 and the system 101 (e.g., the central mobile payment controller 50) during the pump session established between the PCD 100 and the pump controller 95 and/or the store controller 96. In this manner, as illustrated in FIG. 23, the carbon offset/credit management system 130 may be viewed as an additional software application layer that may be integrated with the gas station mobile payment system 110, the central mobile payment controller 50, or any other software components of the system 101 for managing the transactions at the fuel dispensing station 90.

The carbon offset/credit management system 130 may control and manage various consumer-interfacing components of the carbon offset program while outsourcing the trading and exchange of the carbon credits to a carbon offset/credit exchange 2416 operated by the third party administrative entity. The consumer-interfacing components may comprise specifying, via the PCD 100, an amount for a carbon offset during the transaction at the fuel dispensing station 90, managing group(s) 2306, tracking and granting incentives or awards 2310, tracking badge(s)/level(s) 2304, viewing a transaction history 2302, managing notifications 2308, managing a carbon offset matching program 2312, and sharing participant/activity in the carbon offset program via a social networking system 2314. The carbon offset/credit management system 130 may store and manage any of this, or other, types of data via user accounts. The user accounts may be integrated with the payment accounts described above or provided as a separate managed user account.

The matching program 2312 may enable consumers to affiliate with a corporate or other sponsor that matches carbon credit contributions made by the consumer. In an embodiment, the corporate sponsor may comprise a gas company operating the gas station 91, the gas station merchant, or any other corporation or individual offering matching contributions. The carbon offset/credit management system 130 may also enable consumers to create group(s) 2306 of participating users for pooling carbon credit contributions or sharing activity within the group members. To further incentivize participation in the voluntary carbon offset program, the carbon offset/credit management system 130 may support various gamification mechanisms, such as, badge(s)/level(s) 2304 that may be achieved based on a user's ongoing carbon credits. A user may also obtain various awards 2310, which may comprise discounts on in-store or other items, monetary rewards, or free products or services.

The carbon offset/credit management system 130 may also support a social media component for enabling users to post, for example, daily or running CO2e contributions to their friends. These and other notifications 2308 may be provided via an application program interface (API) to the social networking system 2314. The notifications 2308 to non-participating friends may include an invitation to join the voluntary consumer program, thereby increasing adoption and providing a competitive environment.

As illustrated in FIG. 23, the user accounts may include a transaction history 2302 for each gas station transaction in which a carbon offset contribution has been made. Each transaction may comprise a user identifier 2318, a merchant identifier 2320, an amount 2322 for the carbon offset contribution, matching data 2324 of a sponsor, and any applicable group data 2326 for the group(s) 2306 involving the user.

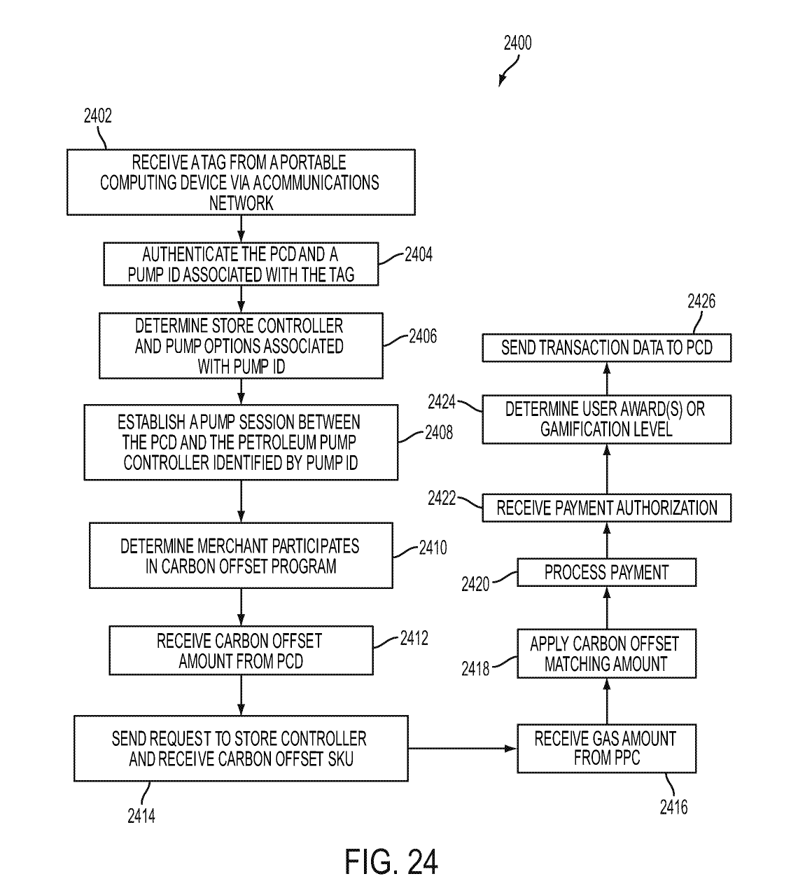

FIG. 24 illustrates a method 2400 executed by the carbon offset/credit management system 130 for managing carbon credits at a fuel dispensing station 90. At block 2402, the carbon offset/credit management system 130 receives the tag 124 affixed to the pump station 90 or otherwise receives a pump identifier for the fuel dispensing station 90. At block 2404, the PCD 100 may be authenticated by the system 101, as described above, and the pump identifier may be determined and verified. At block 2406, the carbon offset/credit management system 130 may determine the store controller 96 associated with the pump identifier, as well as the pump options or display options available at the fuel dispensing station 90. At block 2408, the carbon offset/credit management system 130 establishes the pump session between the PCD 100, the store controller 96, and/or the pump controller 95.

At block 2410, the carbon offset/credit management system 130 determines whether the merchant participates in the carbon offset program. A database may be provided that links pump identifiers with corresponding store controller identifiers and/or merchant identifiers with a data flag indicating participants in the carbon offset program. At block 2412, the carbon offset/credit management system 130 receives a user selection of a carbon offset for the transaction. The screen 1602 in FIG. 16 illustrates an exemplary method for specifying the carbon offset. A slider mechanism (or other user interface control) may be provided for enabling the user to specify a level of carbon neutrality that they would like to contribute. For example, the level may be variable from a zero contribution to fully neutral (e.g., approximately $0.12/gallon) to any multiple or percentage greater than carbon neutrality. The screen 1602 may be configured with a default contribution. The user may also specify a fixed amount for the contribution (e.g., $10).

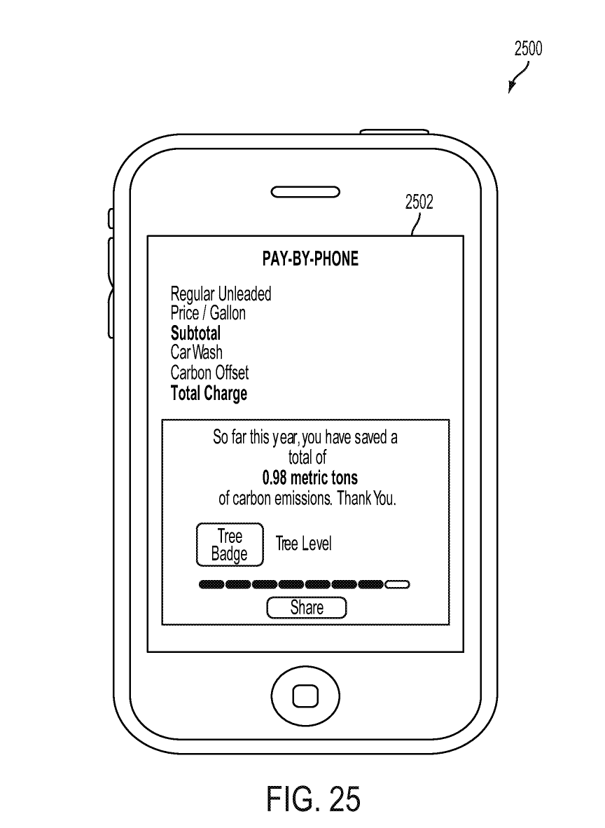

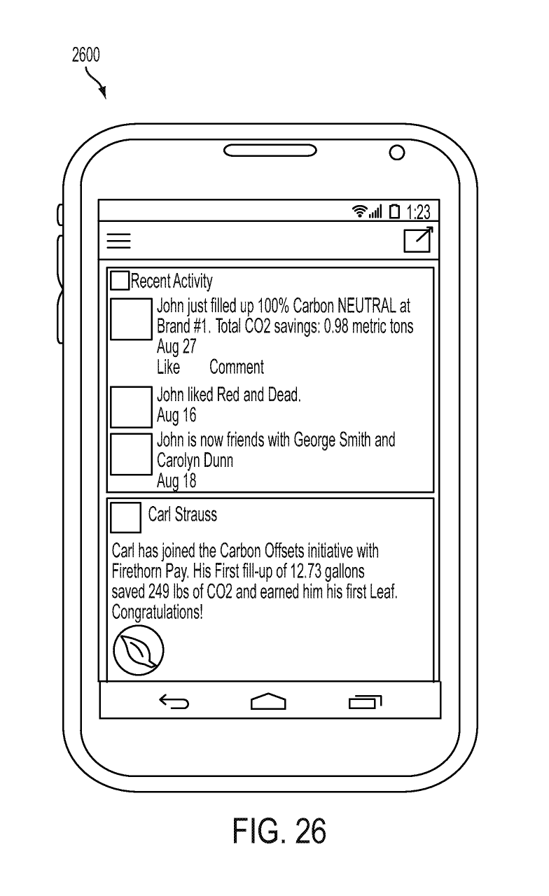

If the contribution is specified as a function of the volume of the fuel being purchased, the carbon offset/credit management system 130 may send a request to the store controller 96 for a carbon offset SKU or the final contribution amount based on the amount of the purchased fuel (block 2414). This step may be removed if the contribution is specified as a fixed dollar amount. After the fuel is pumped, at block 2416, the carbon offset/credit management system 130 may receive the gas payment amount and the final contribution amount from the pump controller 95 or the store controller 96. At block 2418, the carbon offset/credit management system 130 may apply any matching amounts to the user's contribution. At block 2420, the carbon offset/credit management system 130 may be configured to initiate or perform payment processing. At block 2422, the carbon offset/credit management system 130 receives a payment confirmation message and then determines any applicable award(s) 2310 or badge(s)/level(s) 2304 and updates the user account (block 2424). At block 2526, the carbon offset/credit management system 130 sends transaction data to the PCD 100, the store controller 96, and the pump controller 95. FIG. 25 illustrates a screen 2500 for displaying a receipt 2502 for the transaction. The receipt 2502 may display an itemized account of the gas purchase, a car wash purchase, any redeemed offers, and the carbon offset contribution. The receipt 2502 may include a notification 2308 listing the total annual contribution, as well as any applicable award(s) 2310 or badge(s)/level(s) 2304. The screen 2500 may include a share button for enabling the user to share the transaction activity with their social networking friends. FIG. 26 illustrates an exemplary notification 2308 posted via social networking system 2314, which displays the transaction activity. The user's friends may “like” or comment on the notification 2308.

One of ordinary skill in the art will appreciate that the carbon offset/credit management system 130 may implement various alternative or additional gamification mechanisms to encourage participation in the consumer program. For example, in an embodiment, the carbon offset/credit management system 130 may be configured to customize incentive mechanisms based on the user accounts, social networking profile data, or other available user data (e.g., on-board diagnostic data from the user's vehicle).

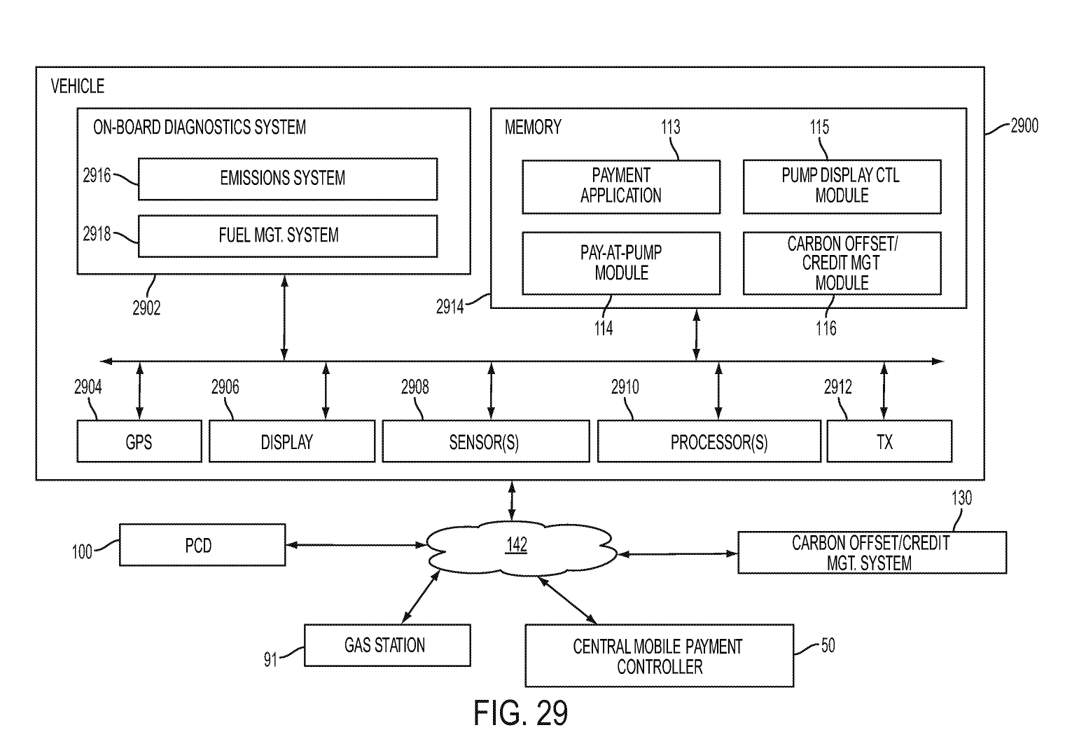

FIG. 29 illustrates another embodiment of the carbon offset/credit management system 130 (FIGS. 1, 12 & 23) for automating gasoline and/or carbon offset purchases and enabling desirable transactions at the fuel dispensing station 90 involving a vehicle 2900. In general, the vehicle 2900 may be coupled to the communications network 142 for communicating and exchanging data with, for example, the PCD 100, the central mobile payment controller 50, the carbon offset/credit management system 130, and the store controller 96 and the pump controller 95 associated with the fuel dispensing station(s) 90 located at a gas station 91. In this manner, the vehicle 2900 may be viewed as another example of a PCD 100 and, therefore, may be configured to receive and/or provide one or more of the features identified above in connection with the operation of the PCD 100 in the system 100. Alternatively, the vehicle 2900 and the PCD 100 may communicate with each other to receive and/or provide any of these features.

As illustrated in FIG. 29, the vehicle 2900 may comprise processor(s) 2910 for executing the payment application 113, the pay-at-pump module 114, the pump display control module 115, or the carbon offset/credit management module 116 stored in a memory 2914. Whether performed by the vehicle 2900, the PCD 100, or a combination thereof, the payment application 113, the pay-at-pump module 114, the pump display control module 115, and the carbon offset/credit management module 116 may be configured in the manner described above. Accordingly, the vehicle 2900 may be configured with one or more additional components of the PCD 100, including a GPS device 2904, an in-dash or other display device 2906, and a wireless transceiver 2912 for communicating via the communications network 142 or directly with the PCD 100.

It should be further appreciated that the integration of the vehicle 2900 with the system 101 may enhance the performance, accuracy, and desirability of the carbon offset/credit management system 130 by enabling the incorporation of data from the vehicle 2900 to more accurately estimate carbon emissions.

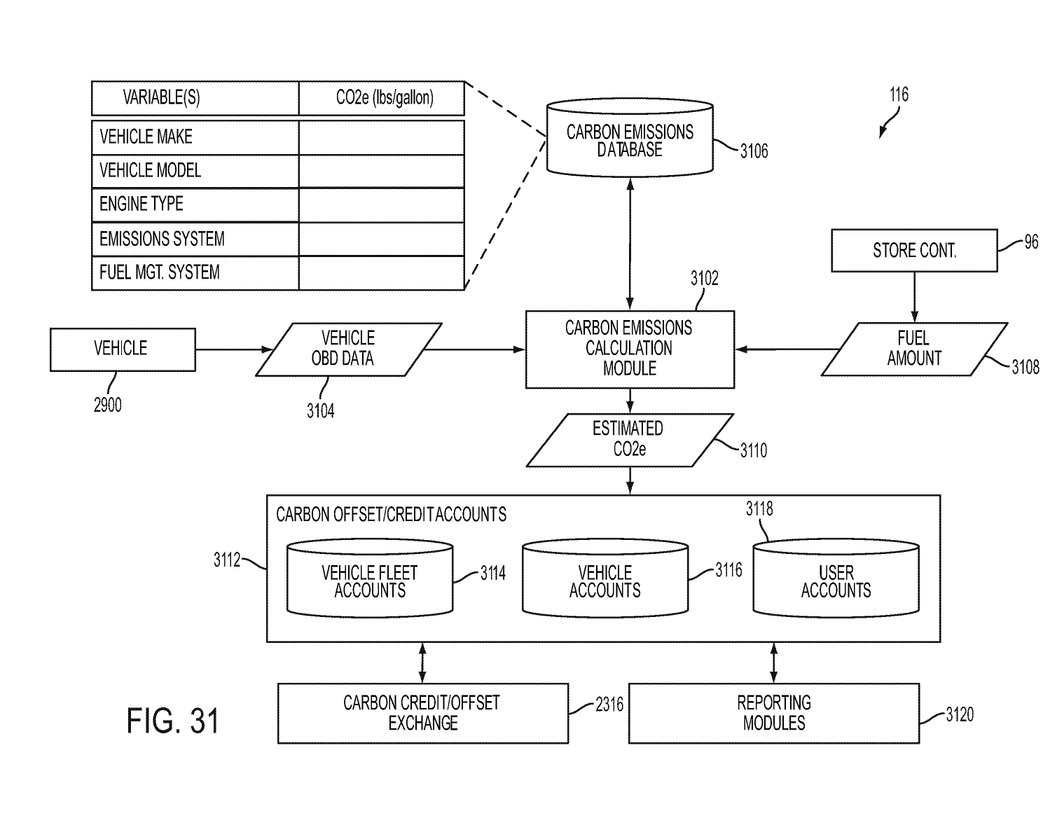

As illustrated in FIG. 31, the vehicle 2900 may provide to the carbon offset/credit management system 130 various types of data captured by an on-board diagnostics system 2902 (i.e., on-board diagnostics (OBD) data 3104). The on-board diagnostics system 2902 generally comprises the vehicle's self-diagnostic and reporting capability. The OBD on-board diagnostics system 2902 captures and provides data access to various operational and performance data associated with various vehicle sub-systems, such as, for example, an emissions system 2916, a fuel management system 2918, or any other vehicle systems. The on-board diagnostics system 2902 may include a standardized digital communications port or wireless interface (e.g., transceiver 2912) to provide real-time data in addition to a standardized series of diagnostic trouble codes (i.e., DTCs), which allow the identification and remedy of malfunctions within the vehicle. The on-board diagnostics system 2902 may receive the real-time data from one or more sensors 2908 associated with the respective subsystems.

For example, the emissions system 2916 as illustrated in FIG. 29 may include sensors 2908 for receiving information associated with the operation and performance of the vehicle engine, fuel injection system, catalytic converters, etc. The emissions data may include information about various types of, and levels of, air pollutants, such as hydrocarbons, non-methane hydrocarbons, total hydrocarbons, methane, carbon monoxide, nitrogen oxide, particulate matter, sulfur oxides, volatile organic compounds (VOCs), or other greenhouse gases that may have a variety of negative effects on public health and the natural environment and may be subject to regulation or eco-friendly initiatives. The emissions data may not necessarily include pollutant levels. It should be appreciated that the emissions data may comprise operational and/or performance data that can be used to calculate or estimate the types and levels of air pollutants produced by the vehicle. The calculation or estimation processing may be performed by the on-board diagnostics system 2902 or provided to another device or system for processing.

The fuel management system 2918 generally comprises hardware, software, and associated sensors 2908 for maintaining, controlling, monitoring, and reporting fuel consumption of the vehicle 2900.

Referring again to FIG. 31, the vehicle OBD data 3104 may be provided to a carbon emissions calculation module 3102 associated with the carbon offset/credit management system 130. The OBD data 3104 may be provided in various ways. The OBD data 3104 may be provided to the central mobile payment controller 50 in real-time, prior to, or during a transaction at a fuel dispensing station 90. In an embodiment, the OBD data 3104 may be provided via the pump control/payment channel 1202 (FIG. 12) either by the vehicle 2900 or the PCD 100.

The carbon emissions calculation module 3102 receives the OBD data 3104 from the vehicle 2900, which may be parsed either at the vehicle 2900 or remotely according to the last fueling transaction, other transactions, system events, or as configured by the user. The carbon emissions calculation module 3102 may also receive a fuel amount 3108 (i.e., the amount of fuel pumped by the pump 92), as well as the fuel grade type, from the store controller 96, the pump controller 95, or the central mobile payment controller 50. Based on one or more of the OBD data 3104, the fuel amount 3108, and predetermined data in a carbon emissions database 3106, the carbon emissions calculation module 3102 determines a carbon emissions estimate 3110 for the fueling transaction.

It should be appreciated that the carbon emissions estimate 3110 may incorporate various available data, including the fuel type or grade. Certain types of fuel and higher grade fuel may require more energy to produce. The design of the emissions system 2916 may be included as input. For example, even within a specific vehicle make or model, different states may require emission control systems with more or less stringent emissions standards. The efficiency of the emissions system during the last tank of gas may be incorporated. As known in the art, a hot catalytic converter may scrub emissions more efficiently than a cold one. A driver with a relatively shorter commute may release more CO and unburned hydrocarbons but less CO2. The carbon emissions calculation module 3102 may also incorporate the efficiency of the engine during the last tank of gas. A cold engine may not fully combust all fuel and, therefore, release more unburned hydrocarbons, thereby creating less CO2 (but perhaps requiring more fuel to reach a destination). Furthermore, the carbon emission amount may be estimated based on an amount of fuel actually consumed since the last fueling or the amount to be consumed based on the fuel amount 3108.

In an embodiment, the carbon emissions estimate may be calculated as an adjustment to or a deviation from a predetermined amount of carbon emissions per volume of fuel. The system may assume, based on industry standards, research, etc., that a specific amount of fuel produces a certain amount of carbon emissions (CO2e). As an example, it may be assumed that every gallon of regular grade fuel produces approximately 15 lbs of CO2e. The OBD data 3104 may be used to calculate an adjustment relative to the predetermined amount of carbon emissions. The OBD data 3106 may be used to calculate or estimate that the vehicle 2900 produces more or less than the predetermined carbon emissions amount. The carbon offset adjustment may be determined according to data contained in the carbon emissions database 3106 (e.g., according to vehicle make, vehicle model, engine type, emissions system configuration, fuel management system configuration, etc.). Each variable may specify the adjustment in the form of a percentage deviation from the industry average. It should be appreciated that the carbon offset adjustment may also be calculated by weighting one or more of the variables and may further comprise algorithms for deriving the carbon emissions estimate from the OBD data 3104.

The carbon emissions calculation module 3102 outputs the estimated carbon emissions amount 3110 and updates applicable carbon offset/credit accounts 3112 stored in vehicle fleet accounts database 3114, vehicle accounts database 3116, and user accounts database 3118. A user account may be configured in the manner described above and illustrated in FIG. 23. With the integration of vehicles 2900 and the OBD data 3104, the carbon offset/credit management system 130 may also support account management, reporting (module(s) 3120), and regulatory compliance features on a vehicle-by-vehicle basis (i.e., vehicle accounts) or by aggregating vehicle accounts for a fleet of vehicles (i.e., fleet account). A vehicle account may be configured to separately manage multiple users of the same vehicle. A user account may be configured to manage a specific user's carbon emissions even when driving different vehicles. The fleet accounts may be particularly useful for managing a fleet of company vehicles, taxi drivers, truck drivers, utility companies (e.g., electric, gas, cable, etc.), or even for managing a household account with multiple cars.

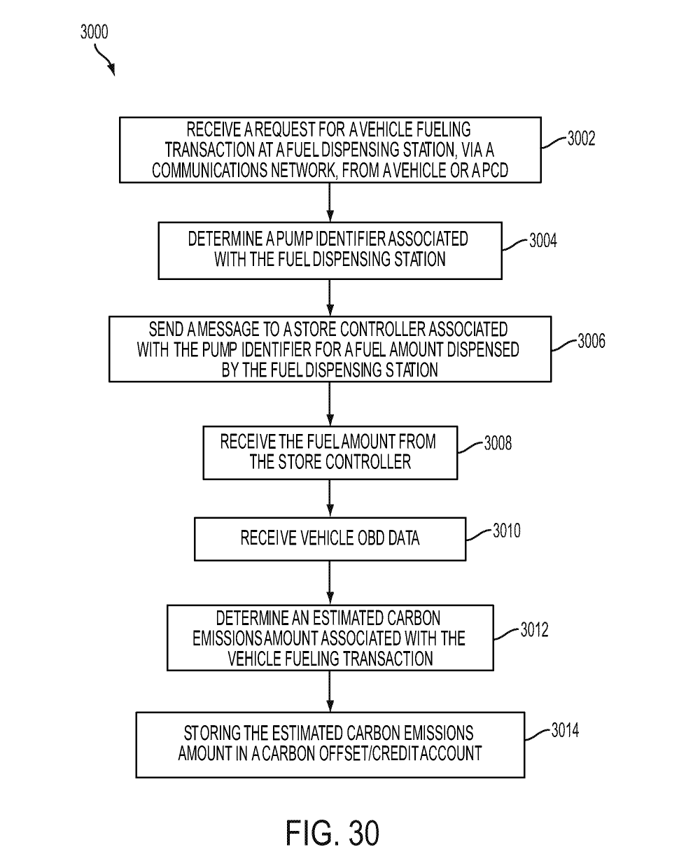

FIG. 30 illustrates a method 3000 for managing carbon emission credits associated with a vehicle 2900 fueling at a fuel dispensing station 90. The method 3000 may be performed by the carbon offset/credit management system 130 in association with one or more other components illustrated in FIG. 29. At block 3002, the carbon offset/credit management system 130 receives a request for a vehicle fueling transaction at a fuel dispensing station 90. The request may be initiated by the vehicle 2900 or the PCD 100 in the manner described above in connection with FIGS. 1-27. It should be further appreciated that the blocks 3004, 3006, and 3008 may also be performed as described above in connection with FIGS. 1-27.

At block 3004, the carbon offset/credit management system 130 may determine a pump identifier associated with the fuel dispensing station 90. At block 3006, a message is sent to the store controller 96 associated with the pump identifier. The message may comprise a request for the fuel amount 3108 (FIG. 31) dispensed by the fuel dispensing station 90. At block 3008, the carbon offset/credit management system 130 receives the fuel amount 3108. At block 3010, the carbon offset/credit management system 130 receives the OBD data 3104 from the vehicle 2900 refueling at the fuel dispensing station 90. At block 3012, the carbon offset/credit management system 130 determines, based at least in part on the OBD data 3104, an estimated carbon emissions amount 3110 associated with the vehicle fueling transaction. At block 3014, the carbon offset/credit management system 130 stores the estimated carbon emissions amount 3110 in the applicable carbon offset/credit accounts 3112.

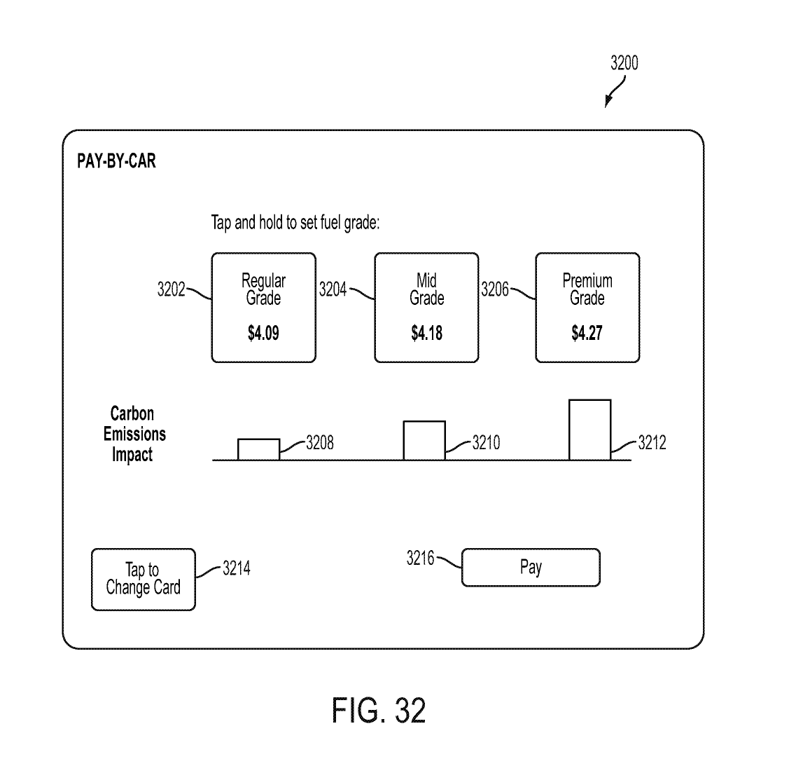

FIG. 32 illustrates of an embodiment of a pay-by-car screen 3200 for selecting a fuel grade option during a vehicle fueling transaction at a fuel dispensing station 90. Pay-by-car screen 3200 may be displayed on the display 2906 located in the vehicle 2900. Pay-by-car screen 3200 comprises one or more user interface components 3203, 3204, and 3206 for specifying the fuel grade type for the fueling transaction. The relative carbon emissions impact of each fuel grade type may be displayed next to each component. In the example of FIG. 32, the relative impact is conveyed in the form of a bar graph illustrating that the regular grade fuel has the least carbon emissions impact (block 3208), the premium grade fuel has the most carbon emissions impact (block 3212), and the mid grade fuel in between the two (block 3210). A user may configure a payment method via UI component 3214 and initiate payment via UI component 3216.

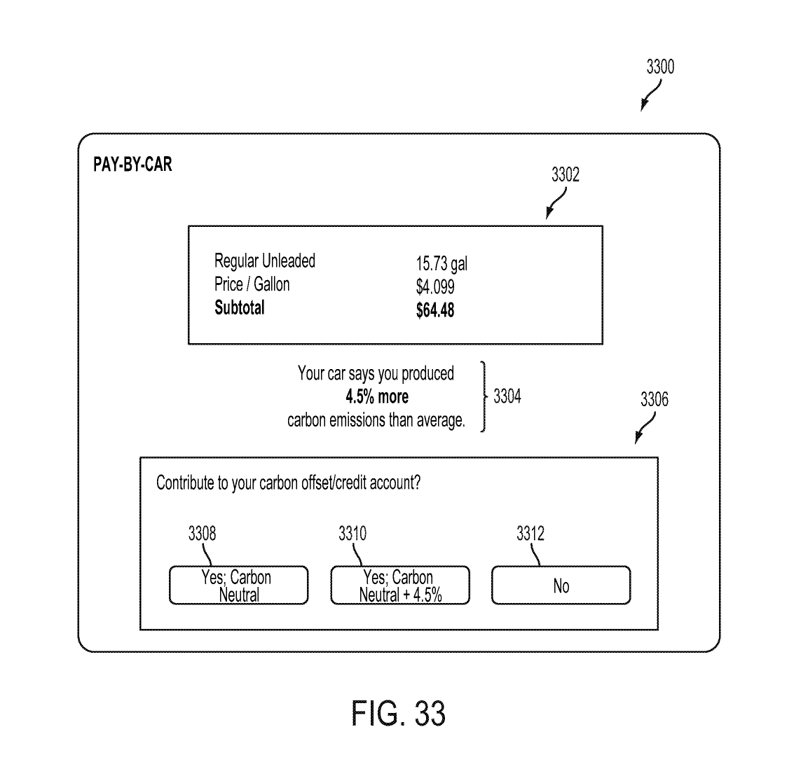

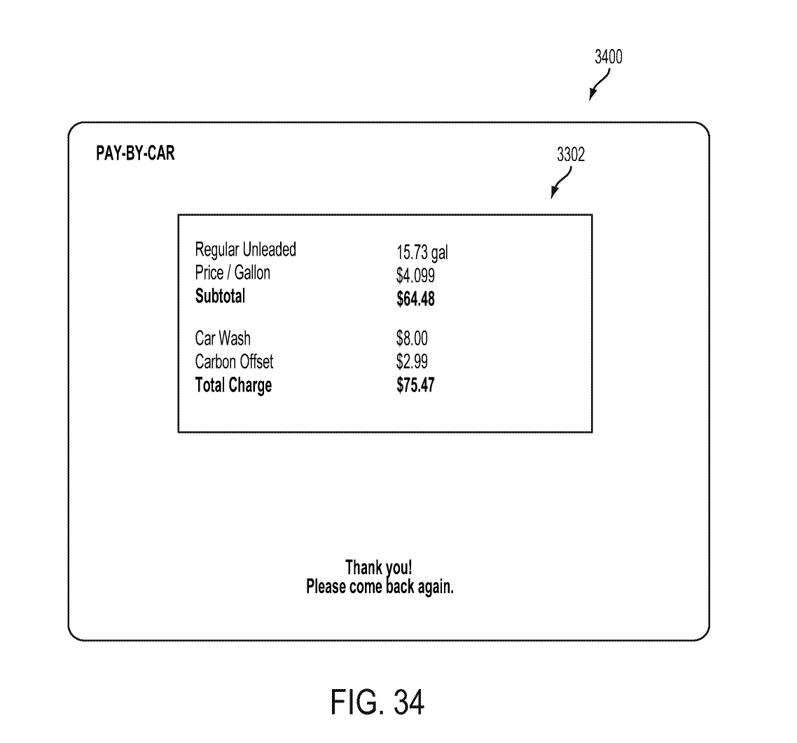

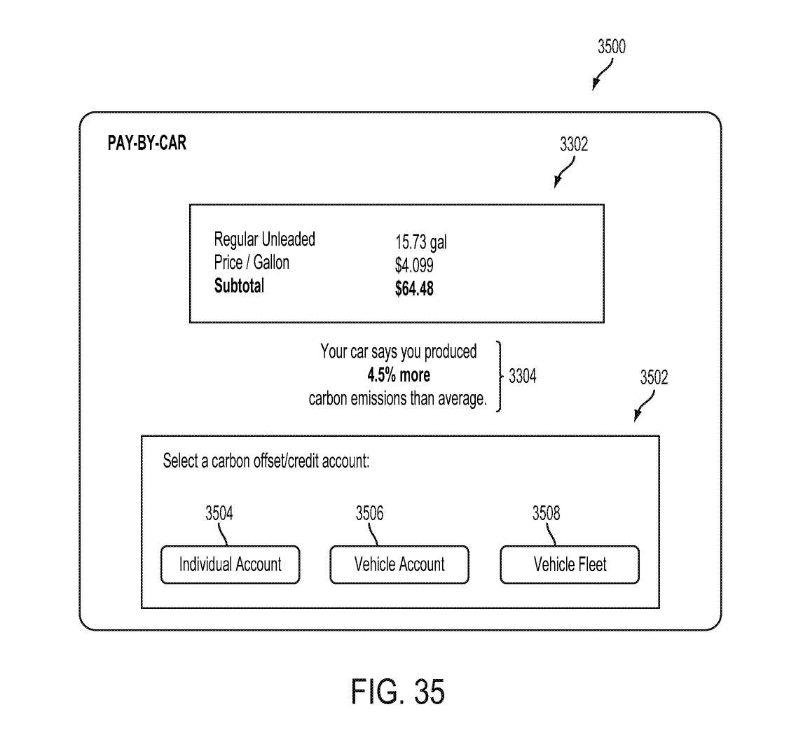

FIG. 33 illustrates an embodiment of a pay-by-car screen 3300 for displaying the results of the carbon emission estimate based on the OBD data 3104. Pay-by-car screen 3300 includes a portion 3302 for displaying transaction details, such as the fuel amount 3108, price/gallon, and subtotal charge for the fuel. As illustrated by reference numeral 3304, information related to the carbon emission estimate may be displayed. In this example, a message indicates that that the carbon emissions calculation module 3102 has determined that, based on the OBD data 3104, the vehicle 2900 produced 4.5% more than the average carbon emissions for the fuel amount 3108. The user may be prompted to select whether to purchase a carbon neutral contribution (UI component 3308), purchase the estimated carbon emissions amount of 4.5% more than carbon neutral (UI component 3310), or decline to purchase a carbon offset for this transaction (UI component 3312). If the user selects either UI component 3308 or UI component 3310, a further screen 3500 (FIG. 35) may be displayed with a screen portion 3502 that prompts the user to select a carbon offset/credit account 3112 to which the purchase should be applied: an individual account (UI component 3504), a vehicle account (UI component 3506), or a fleet account (UI component 3508). After the fueling transaction is complete, a pay-by-car screen 3400 (FIG. 34) ma display a transaction receipt.

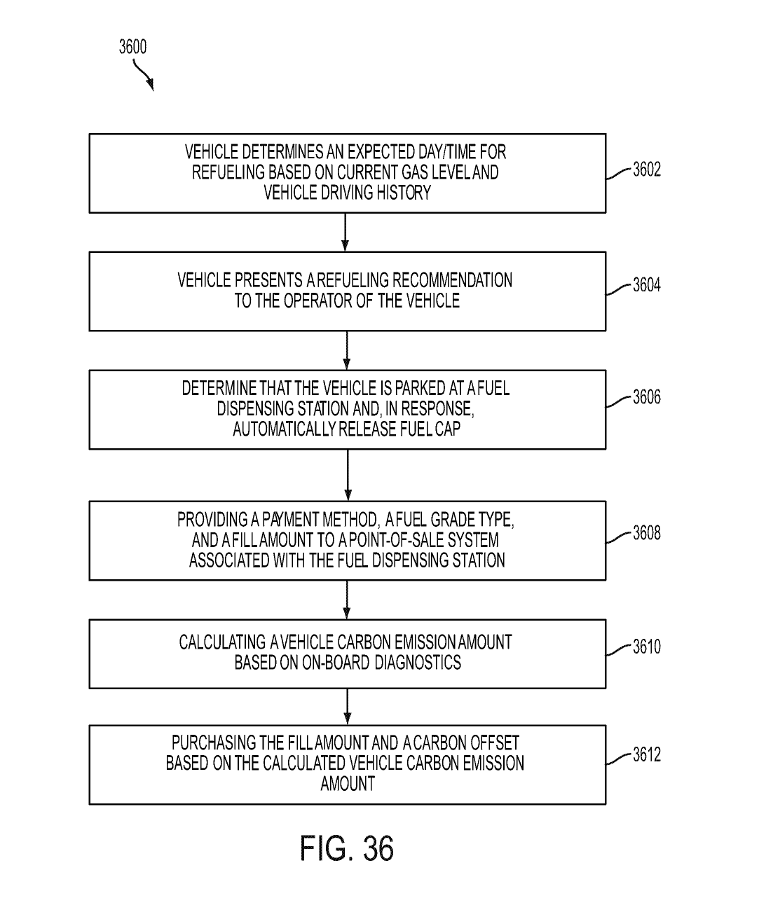

Vehicle 2900 may be further configured with software to automate various additional aspects of the process for finding a gas station 91, refueling at a fuel dispensing station 90, and conducting related transactions, such as, purchasing the gasoline, purchasing carbon offsets/credits, and receiving or redeeming offers. FIG. 36 illustrates an exemplary method 3600. The steps of method 3600 may be executed by one or more components of the system 100, including the vehicle 2900, the fuel dispensing station 90, the PCD 100, the central mobile payment controller 50, the pump controller 95, the store controller 96, the carbon offset/credit management system 130, and the gas station mobile payment system 110.

At block 3602, the fuel management system 2918 may determine an expected day/time for refueling based on a current gas level and/or vehicle driving history obtained from GPS 2904. The vehicle 2900 may notify a user via display 2906 what day and time it expects the gas tank to be empty based on regular travel (e.g., commuting patterns) so that the user is less likely to need gas mid-commute. At block 3604, the vehicle 2900 presents a refueling recommendation. The refueling recommendation may be based on the expected day/time for refueling as determined in step 3602. The refueling recommendation may also include a recommendation to refuel at a specific gas station 91. The vehicle 2900 may determine a current GPS location from GPS device 2904 and calculate a cost of fuel to reach one or more gas stations 91 and then continue, for example, to a planned destination along with current gasoline prices at the gas stations 91 to come to total cost of fuel trip. In other words, the vehicle 2900 may determine whether it is worth going out of your way to go to a gas station 91. The display 2906 may also incorporate any offers or prepaid card value when selecting a gas station 91.

At block 3606, it may be determined that the vehicle 2900 is parked at a fuel dispensing station 90. In response, the vehicle 2900 may automatically release a fuel cap door. At block 3608, a transaction may be initiated in which various data is provided to the pump POS 94, a store POS, the PCD 100, or the central mobile payment controller 50. For instance, a payment method, a fuel grade type, and a fill amount may be provided by the vehicle 2900 (e.g., via communications network 142) or to the PCD 100.

At block 3610, a vehicle carbon emission estimate may be calculated, as described above, based on, for example, vehicle OBD data 3104 (FIG. 31). The carbon emission amount may be estimated based on an amount of fuel actually consumed since the last fueling, the amount to be consumed based on the fuel amount 3108, or any other available data, as described above. At block 3612, the user purchases the fuel amount 3108, a selected carbon offset/credit, and any other offers or goods.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments for the process 900 and system 101 for managing transactions with the PCD 100 will become apparent to one of ordinary skill in the art to which the invention pertains without departing from its spirit and scope. For example, the PCD 100 may be used for making purchases in an on-line transaction environment. In such environments, the on-line merchant may provide the merchant identifier and/or terminal identifier on the merchant's website/webpages which may be scanned-in by the PCD 100 or keyed-in by the operator of the PCD 100. The contents of the merchant's on-line shopping cart may then be displayed on the PCD 100 similar to the brick and mortar POS transactions described above. The operator of the PCD 100 may also select preferred payment methods also like the brick and mortar POS transactions described above.

According to another exemplary embodiment, instead of the central mobile payment sending data to the PCD 100 to form payment screens of FIGS. 2F-2H and FIGS. 10B-10D, this data may be sent to the ECR 412 or POS terminal (PIN PAD/Card Swiper) for display. In this way, the PCD 100 is only used to authenticate a user so that all payment screens are display and rendered on the Merchant side of the system 101.

Therefore, although selected aspects have been illustrated and described in detail, it will be understood that various substitutions and alterations may be made therein without departing from the spirit and scope of the present invention, as defined by the following claims.

What is claimed is:

1. A method for managing carbon emission credits associated with a vehicle fueling at a fuel dispensing station, the method comprising:
receiving a request via a communications network for a vehicle fueling transaction at a fuel dispensing station;
determining a pump identifier associated with the fuel dispensing station;
sending a message to a store controller associated with the pump identifier for a fuel amount dispensed by the fuel dispensing station;
receiving the fuel amount from the store controller;
receiving on-board diagnostics (OBD) data associated with the vehicle;
calculating a carbon emission adjustment based on the OBD data; and
determining an estimated carbon emissions amount associated with the vehicle fueling transaction by applying the carbon emission adjustment to a predetermined carbon emissions amount for the fuel amount.

2. The method of claim 1, wherein the OBD data comprises emissions data obtained from an emissions system.

3. The method of claim 1, wherein the OBD data comprises fuel management data obtained from a fuel management system.

4. The method of claim 1, wherein the OBD data comprises one or more of a vehicle type, a vehicle model, an engine type, a vehicle emissions system type, and a fuel management system type.

5. The method of claim 1, wherein the calculating the carbon emission adjustment based on the OBD data further comprises determining one or more of a vehicle type, a vehicle model, an engine type, a vehicle emissions system type, and a fuel management system type.

6. The method of claim 1, further comprising:
receiving a user selection of a carbon offset amount corresponding to the estimated carbon emissions amount;
receiving a gas payment amount for the fuel amount from the store controller; and
initiating processing of a payment comprising the gas payment amount and the carbon offset amount.

7. The method of claim 1, further comprising: storing the estimated carbon emissions amount in an account.

8. The method of claim 7, wherein the account comprises one or more of an individual user account, a vehicle account, and a fleet account.

9. The method of claim 7, wherein the account is associated with one or more of a government-mandated industrial program and a voluntary consumer program.

10. A computer system for managing carbon emission credits associated with a vehicle fueling at a fuel dispensing station, the system comprising:
a processor operable for:
receiving a request via a communications network for a vehicle fueling transaction at a fuel dispensing station;
determining a pump identifier associated with the fuel dispensing station;
sending a message to a store controller associated with the pump identifier for a fuel amount dispensed by the fuel dispensing station;
receiving the fuel amount from the store controller;
receiving on-board diagnostics (OBD) data associated with the vehicle;
calculating a carbon emission adjustment based on the OBD data; and
determining an estimated carbon emissions amount associated with the vehicle fueling transaction by applying the carbon emission adjustment to a predetermined carbon emissions amount for the fuel amount.

11. The computer system of claim 10, wherein the OBD data comprises emissions data obtained from an emissions system.

12. The computer system of claim 10, wherein the OBD data comprises fuel management data obtained from a fuel management system.

13. The computer system of claim 10, wherein the OBD data comprises one or more of a vehicle type, a vehicle model, an engine type, a vehicle emissions system type, and a fuel management system type.

14. The computer system of claim 10, wherein the calculating the carbon emission adjustment based on the OBD data further comprises determining one or more of a vehicle type, a vehicle model, an engine type, a vehicle emissions system type, and a fuel management system type.

15. The computer system of claim 10, wherein the processor is further operable to:
receive a user selection of a carbon offset amount corresponding to the estimated carbon emissions amount;
receive a gas payment amount for the fuel amount from the store controller; and
initiate processing of a payment comprising the gas payment amount and the carbon offset amount.

16. The computer system of claim 10, wherein the processor is further operable to:
store the estimated carbon emissions amount in an account.

17. The computer system of claim 16, wherein the account comprises one or more of an individual user account, a vehicle account, and a fleet account.

18. The computer system of claim 16, wherein the account is associated with one or more of a government-mandated industrial program and a voluntary consumer program.

19. A computer system for managing carbon emission credits associated with a vehicle fueling at a fuel dispensing station, the system comprising:
means for receiving a request via a communications network for a vehicle fueling transaction at a fuel dispensing station;
means for determining a pump identifier associated with the fuel dispensing station;
means for sending a message to a store controller associated with the pump identifier for a fuel amount dispensed by the fuel dispensing station;
means for receiving the fuel amount from the store controller;
means for receiving on-board diagnostics (OBD) data associated with the vehicle;
means for calculating a carbon emission adjustment based on the OBD data; and
means for determining an estimated carbon emissions amount associated with the vehicle fueling transaction by applying the carbon emission adjustment to a predetermined carbon emissions amount for the fuel amount.

20. The computer system of claim 19, wherein the OBD data comprises emissions data obtained from an emissions system.

21. The computer system of claim 19, wherein the OBD data comprises fuel management data obtained from a fuel management system.

22. The computer system of claim 19, wherein the OBD data comprises one or more of a vehicle type, a vehicle model, an engine type, a vehicle emissions system type, and a fuel management system type.

23. The computer system of claim 19, wherein the calculating the carbon emission adjustment based on the OBD data further comprises determining one or more of a vehicle type, a vehicle model, an engine type, a vehicle emissions system type, and a fuel management system type.

24. The computer system of claim 19, further comprising:
means for receiving a user selection of a carbon offset amount corresponding to the estimated carbon emissions amount;
means for receiving a gas payment amount for the fuel amount from the store controller; and
means for initiating processing of a payment comprising the gas payment amount and the carbon offset amount.

25. The computer system of claim 19, further comprising: means for storing the estimated carbon emissions amount in an account.

26. The computer system of claim 25, wherein the account comprises one or more of an individual user account, a vehicle account, and a fleet account.

27. The computer system of claim 25, wherein the account is associated with one or more of a government-mandated industrial program and a voluntary consumer program.

28. A computer program product comprising a computer usable medium having a computer readable program code embodied therein, the computer readable program code adapted to be executed to implement a method for managing carbon emission credits associated with a vehicle fueling at a fuel dispensing station, the method comprising:
receiving a request via a communications network for a vehicle fueling transaction at a fuel dispensing station;
determining a pump identifier associated with the fuel dispensing station;
sending a message to a store controller associated with the pump identifier for a fuel amount dispensed by the fuel dispensing station;
receiving the fuel amount from the store controller;
receiving on-board diagnostics (OBD) data associated with the vehicle;
calculating a carbon emission adjustment based on the OBD data; and
determining an estimated carbon emissions amount associated with the vehicle fueling transaction by applying the carbon emission adjustment to a predetermined carbon emissions amount for the fuel amount.

29. The computer program product of claim 28, wherein the OBD data comprises emissions data obtained from an emissions system.

30. The computer program product of claim 28, wherein the OBD data comprises fuel management data obtained from a fuel management system.

31. The computer program product of claim 28, wherein the OBD data comprises one or more of a vehicle type, a vehicle model, an engine type, a vehicle emissions system type, and a fuel management system type.

32. The computer program product of claim 28, wherein the calculating the carbon emission adjustment based on the OBD data further comprises determining one or more of a vehicle type, a vehicle model, an engine type, a vehicle emissions system type, and a fuel management system type.

33. The computer program product of claim 28, wherein the method further comprises:
receiving a user selection of a carbon offset amount corresponding to the estimated carbon emissions amount;
receiving a gas payment amount for the fuel amount from the store controller; and
initiating processing of a payment comprising the gas payment amount and the carbon offset amount.

34. The computer program product of claim 28, wherein the method further comprises: storing the estimated carbon emissions amount in an account.

35. The computer program product of claim 34, wherein the account comprises one or more of an individual user account, a vehicle account, and a fleet account.

36. The computer program product of claim 34, wherein the account is associated with one or more of a government-mandated industrial program and a voluntary consumer program.
